(19) United States
(12) Patent Application Publication
(10) Pub. No.: US 2003/0138739 A1
(43) Pub. Date: Jul. 24, 2003

(54) Photothermographic material and image forming method

(75) Inventors: Senzo Sasaoka, Kanagawa (JP); Yutaka Tamura, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/237,715

(22) Filed: Sep. 10, 2002

(30) Foreign Application Priority Data
Sep. 10, 2001 (JP) P.2001-273889
Sep. 12, 2001 (JP) P.2001-276696
Sep. 13, 2001 (JP) P.2001-278260
Sep. 26, 2001 (JP) P.2001-294162

(51) Int. Cl. G03C 1/498; G03C 5/16; G03C 1/825; G03C 1/20

(52) U.S. Cl. 430/350; 430/620; 430/512; 430/944; 430/584

(57) ABSTRACT

A photothermographic material comprises: a support; a binder; an organic silver salt; a reducing agent for silver ion; and a photosensitive silver halide grain, wherein said photothermographic material contains a solvent in an amount of from 5 to 1,000 mg/m² and the intensity of an odor generated from said photothermographic material is from −3 to 1 at 120° C.

### FIELD OF THE INVENTION

The present invention relates to photothermographic material (a heat-developable photosensitive material) excellent in photographic performance and image preservability and suitable particularly for use in medical diagnosis.

### BACKGROUND OF THE INVENTION

In recent years, reduction of amount of waste processing solutions is strongly desired in the medical field from the standpoint of environmental protection and space savings. To satisfy this requirement, techniques relating to heat-developable photosensitive materials for use in medical diagnosis and photomechanical processes are required, which enable efficient exposure by a laser image setter or laser imager and formation of a clear black image having high resolution and sharpness. These heat-developable photographic materials can provide users with a simple and non-polluting heat development processing system that eliminates the use of solution-type processing chemicals.

The development of these heat-developable photo-sensitive materials is initiated utilizing the difference in temperature between development time and storage and therefore, development is liable to slightly proceed even during storage. This causes a problem that the fog density increases during storage of the photosensitive material after development, namely, deterioration of so-called image preservability. Use of a thermal fogging inhibitor is effective as means for improving this image preservability. However, although the image preservability may be improved, the use of a thermal fogging inhibitor incurs a problem that the sensitivity decreases during storage before development. Thus, means for solving these two problems at the same time is being demanded.

On the other hand, for producing these heat-developable photosensitive materials, a method of coating and drying a coating solution containing a solvent such as organic solvent is generally employed. However, depending on the amount of solvent remaining in the produced heat-developable photosensitive material, not only a problem arises in the photographic performance such as sensitivity and fog or in the image preservability but also an odor is generated from the heat-developable photosensitive material. This is not preferred in view of working environment.

### SUMMARY OF THE INVENTION

By taking account of these problems in conventional techniques, one object of the present invention is to provide a heat-developable photosensitive material having excellent photographic performance and image preservability.

Another object of the present invention is to provide a heat-developable photosensitive material which does not adversely affect the working environment.

As a result of extensive investigations, the present inventors have found that the above-described objects can be attained by the following means.

1. A photothermographic material comprising:

a support;

a binder;

an organic silver salt;

a reducing agent for silver ion; and

a photosensitive silver halide grain,

wherein said photothermographic material contains a solvent in an amount of from 5 to 1,000 mg/m² and the intensity of an odor generated from said photothermographic material is from −3 to 1 at 120° C. (a first embodiment).

2. The photothermographic material as described in the item 1, which comprises a photosensitive layer containing the photosensitive silver halide grain, wherein at least one of the constituent layers on the support surface having the photosensitive layer contains at least one polymer binder selected from the group consisting of polyvinyl butyral, cellulose acetate, cellulose butyrate and derivatives thereof.

3. The photothermographic material as described in the item 1, wherein at least one of the constituent layers of the photothermographic material contains at least one compound selected from the group consisting of an aziridine compound, an epoxy compound and a carbodiimide compound.

4. The photothermographic material as described in the item 1, wherein at least one of constituent layers of the photothermographic material contains a matting agent having an average particle size of 3 to 10 μm and a coefficient of variation of 50% or less.

5. The photothermographic material as described in the item 1, wherein at least one of the constituent layers of the photothermographic material contains a fluorine-containing ionic surfactant.

6. An image forming method comprising exposing the photothermographic material described in the item 1 by a scanning laser beam to form an image, wherein the scanning laser beam creates substantially no vertical angle with the exposure surface of said photothermographic material.

7. An image forming method comprising exposing the photothermographic material described in the item 1 by a scanning laser beam to form an image, wherein said scanning laser beam is in a longitudinal multiple mode.

8. A photothermographic material comprising:

a support;

a binder;

an organic silver salt;

a reducing agent for silver ion; and

a photosensitive silver halide grain,

wherein said photothermographic material contains a solvent in an amount of 5 to 1,000 mg/m², and at least one of a constituent layer and the support in said photothermographic material contains at least one dye represented by the following formula (1), and the intensity of an odor generated from said photothermographic material is from −3 to 1 at 120° C.:

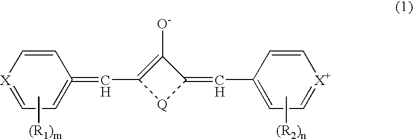

wherein Q represents

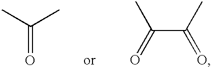

X represents a sulfur atom or an oxygen atom, R₁ and R₂ each represents a monovalent substituent, and m and n each represents 0, 1, 2, 3 or 4 (a second embodiment).

9. The photothermographic material as described in the item 8, wherein said photosensitive silver halide is sensitized by at least one selected from spectral sensitizing dyes represented by the following formulae (2a) to (2d):

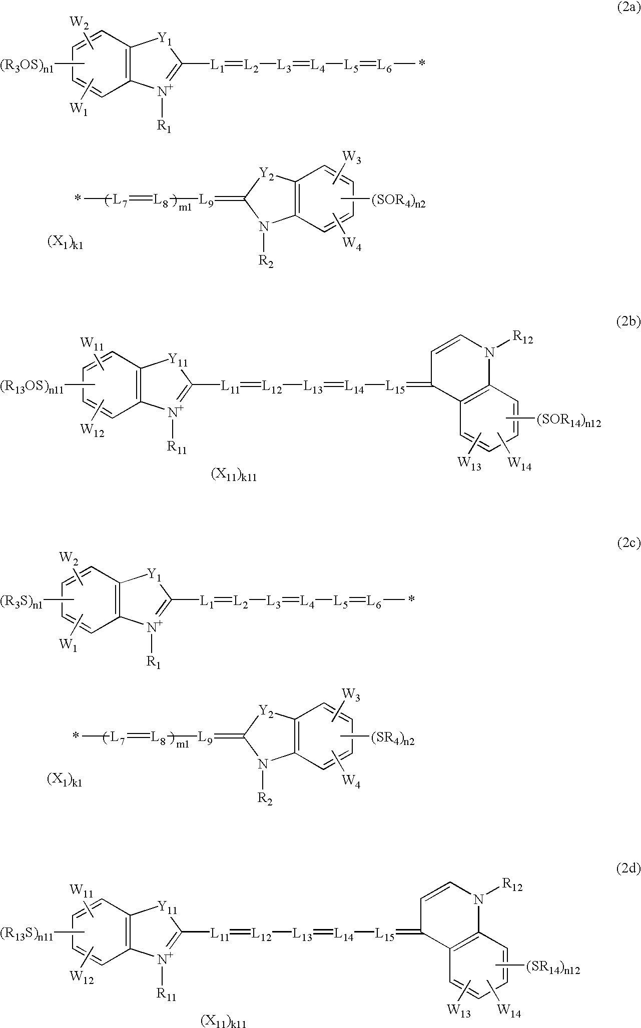

wherein Y₁, Y₂ and Y₁₁ each represents an oxygen atom, a sulfur atom, a selenium atom or a —CH═CH— group, L₁ to L₉ and L₁₁ to L₁₅ each represents a methine group, R₁, R₂, R₁₁ and R₁₂ each represents an aliphatic group, R₃, R₄, R₁₃ and R₁₄ each represents a lower alkyl group, a cycloalkyl group, an alkenyl group, an aralkyl group, an aryl group or a heterocyclic group, W₁, W₂, W₃, W₄, W₁₁, W₁₂, W₁₃ and W₁₄ each represents a hydrogen atom, a substituent, a nonmetallic atom group necessary for forming a condensed ring when W₁ and W₂, W₃ and W₄, W₁₁ and W₁₂, or W₁₃ and W₁₄ are combined, R₃, R₄, R₁₃, R₁₄ W₁, W₂, W₃, W₄, W₁₁, W₁₂, W₁₃ and W₁₄ represent a nonmetallic atom group necessary for forming a 5- or 6-membered condensed ring when R₃ and W₁, R₃ and W₂, R₁₃ and W₁₁, R₁₃ and W₁₂, R₄ and W₃, R₄ and W₄, R₁₄ and W₁₃, or R₁₄ and W₁₄ are combined, X₁ and X₁₁ each represents an ion necessary for canceling the electric charge within the molecule, k₁ and k₁₁ each represents a number of ions necessary for canceling the electric charge within the molecule, m₁ represents 0 or 1, and n₁, n₂, n₁₁ and n₁₂ each represents 0, 1 or 2, provided that each of the pairs n₁ and n₂, and n₁₁ and n₁₂ are not 0 at the same time.

10. The photothermographic material as described in the item 8, which comprises an antihalation layer on the surface having no photosensitivity of said photothermographic material, wherein the antihalation layer has a maximum absorption of 0.3 to 2.0 in the range from 750 to 1,400 nm and an optical density of 0.001 to 0.5 in the range from 400 to 700 nm.

11. The photothermographic material as described in the item 8, wherein the organic solvent used in a coating solution for forming a layer constituting said photothermographic material contains at least one compound selected from the group consisting of a hydrofluoroether compound and a dialkyl carbonate compound.

12. The photothermographic material as described in the item 8, wherein a surface having no photosensitivity of said photothermographic material has a Bekk smoothness of 10 to 500 seconds.

13. An image forming method comprising exposing the photothermographic material described in the item 8 by an infrared laser having a wavelength of 700 to 1,400 nm.

14. An image forming method comprising exposing the photothermographic material described in the item 8 by a laser exposure machine of emitting a scanning laser beam to record an image, in which the scanning laser beam creates substantially no vertical angle with the exposure surface of the photothermographic material.

15. An image forming method comprising exposing the photothermographic material described in the item 8 by a laser scanning exposure machine of emitting a scanning laser beam in a longitudinal multiple mode to record an image.

16. A photothermographic material comprising a photosensitive material and a support, wherein the photosensitive material includes:

a binder;

an organic silver salt;

a reducing agent for silver ion;

a photosensitive silver halide; and

a halide represented by the following formula (X),

wherein

(i) the photothermopraphic material contains a solvent in an amount of 5 to 1,000 mg/m², and

(ii) the intensity of an odor generated from the photothermographic material is from −3 to 1 at 120° C.:

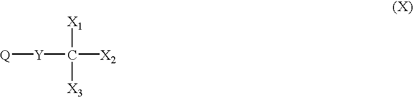

wherein Q represents an aryl group or a heterocyclic group, X₁, X₂ and X₃ each independently represents a hydrogen atom, a halogen atom, a haloalkyl group, an acyl group, an alkoxycarbonyl group, an aryloxycarbonyl group, a carbamoyl group, a sulfamoyl group, a sulfonyl group, a heterocyclic group or an aryl group, provided that at least one of X₁, X₂ and X₃ is a halogen atom, and Y represents —C(═O)—, —SO— or —SO₂— (a third embodiment).

17. The photothermographic material as described in the item 16, wherein the photosensitive layer further contains at least one compound represented by the following formula (I):

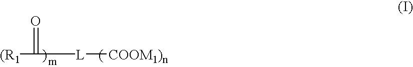

wherein

R₁ represents a hydrogen atom; a group represented by —OM₂; an alkyl group substituted by a group containing at least one heteroatom; an aryl group substituted by at least one group selected from the group consisting of an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, an alkoxycarbonyloxy group, an aryloxycarbonyloxy group, a sulfonylamino group, a sulfamoyl group, a carbamoyl group, an alkylthio group, an arylthio group, an amino group, a sulfonyl group, a sulfinyl group, a sulfonyloxy group, a ureido group, a silyl group, a mercapto group, a hydroxy group, a nitroso group, a sulfo group, a carboxyl group, a phosphoric acid ester group, a heterocyclic group and a halogenoalkyl group; or a heterocyclic group,

L represents a linking group,

M₁ represents a hydrogen atom or a cation,

M₂ represents a hydrogen atom or a cation

m represents an integer of 0 to 5, and n represents an integer of 1 to 3,

provided that when m is 0 or when m is 1 and R₁ is —OH, L represents a linking group substituted by from one to three groups selected from the group consisting of a halogen atom, an acyloxy group, an alkoxycarbonyl group, an aryloxycarbonyl group, a formyl group, an aryloxycarbonylamino group, an alkoxycarbonyloxy group, an aryloxycarbonyloxy group, an amino group, a sulfonyl group, a sulfinyl group, a sulfonyloxy group, a silyl group, a mercapto group, a hydroxy group, a nitroso group, a sulfo group, a phosphoric acid ester group and a heterocyclic group.

18. The photothermographic material as described in the item 17, wherein in formula (I), m is 0, n is 1 and L is a phenyl group substituted by one to three groups selected from the group consisting of an acyloxy group, an aryloxycarbonylamino group, an aryloxycarbonyloxy group and a sulfonyloxy group.

19. The photothermographic material as described in the item 16, wherein the photosensitive layer contains a sulfonium salt.

20. An image forming method comprising exposing the photothermographic material described in the item 16 by a laser exposure machine of emitting a scanning laser beam to record an image, in which the scanning laser beam creates substantially no vertical angle with the exposure surface.

21. An image forming method comprising exposing the photothermographic material described in the item 16 by a laser scanning exposure machine of emitting a scanning laser beam in a longitudinal multiple mode to record an image.

22. A photothermographic material comprising:

a support;

a binder;

an organic silver salt;

a reducing agent for silver ion; and

a photosensitive silver halide grain,

wherein said photothermographic material contains a solvent in an amount of from 5 to 1,000 mg/m², and the intensity of an odor generated from said photothermographic material is from −3 to 1 at 120° C., and said photothermographic material contains at least one of a phthalazine, a phthalazinone and a derivative thereof on the support surface in the side having a photosensitive layer containing the photosensitive silver halide (a fourth embodiment).

23. The photothermographic material as described in the item 22, which comprises at least one hydrazine derivative represented by the following formulae (H-1) to (H-5) and (A) on the support surface in the side having said photosensitive layer:

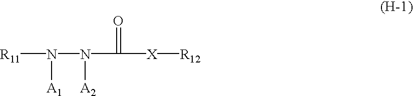

wherein R₁₁ represents an alkyl group, an aryl group or a heterocyclic group, R₁₂ represents a heterocyclic group, an alkenyl group or an amino group, X represents an oxygen atom or a sulfur atom, and A₁ and A₂ both represents a hydrogen atom, or one of A₁ and A₂ represents a hydrogen atom and the other represents an alkylsulfonyl group, an oxalyl group or an acyl group;

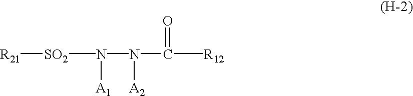

wherein R₂₁ represents alkyl, aryl or heteroaryl group which are substituted or unsubstituted, R₂₂ represents a hydrogen atom, an alkylamino group, an arylamino group or a heterocyclic amino group, and A₁ and A₂ both represents a hydrogen atom, or one of A₁ and A₂ represents a hydrogen atom and the other represents an alkylsulfonyl group, an oxalyl group or an acyl group;

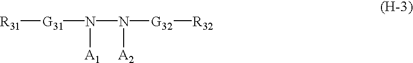

wherein G₃₁ and G₃₂ represents a —(CO)ₚ— group, a —C(═S)— group, a sulfonyl group, a sulfoxy group, a —P(═O)R₃₃— group or an iminomethylene group, p represents an integer of 1 or 2, R₃₃ represents an alkyl group, an alkenyl group, an alkynyl group, an aryl group, an alkoxy group, an alkenyloxy group, an alkynyloxy group, an aryloxy group or an amino group, R₃₁ and R₃₂ each represents an alkyl group, an alkenyl group, an aryl group, a heteroaryl group, an alkoxy group, an alkenyloxy group, an aryloxy group, a heterocyclic oxy group, an alkylthio group, an alkenylthio group, an arylthio group or a heterocyclic thio group, provided that when G₃₁ is a sulfonyl group, G₃₂ is not a carbonyl group, and A₁ and A₂ both represents a hydrogen atom, or one of A₁ and A₂ represents a hydrogen atom and the other represents an alkylsulfonyl group, an oxalyl group or an acyl group;

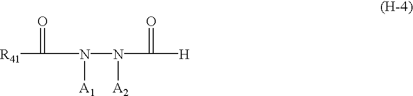

wherein R₄₁ represents a hydrogen atom or a monovalent substituent, and A₁ and A₂ both represents a hydrogen atom, or one of A₁ and A₂ represents a hydrogen atom and the other represents an alkylsulfonyl group, an oxalyl group or an acyl group;

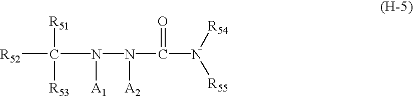

wherein R₅₁, R₅₂ and R₅₃ each independently represents a substituted or unsubstituted aryl or heteroaryl group, R₅₄ and R₅₅ each represents a substituted or unsubstituted alkyl group, and A₁ and A₂ both represents a hydrogen atom, or one of A₁ and A₂ represents a hydrogen atom and the other represents an alkylsulfonyl group, an oxalyl group or an acyl group;

Q¹—NHNHCONH—R¹ (A)

wherein Q¹ represents an aryl group or a heterocyclic group, and R¹ represents an alkyl group, an alkenyl group, a cycloalkyl group, an aryl group or a heterocyclic group.

24. The photothermographic material as described in the item 22, which comprises at least one compound represented by the following formulae (1) to (3) on the support surface in the side having said photosensitive layer:

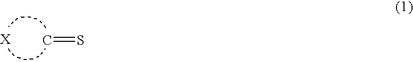

wherein X represents an atomic group capable of forming a heterocyclic ring containing at least one of —SO₃M, —COOM and —OM, and M represents a hydrogen atom, a metal atom, a quaternary ammonium group or a phosphonium group;

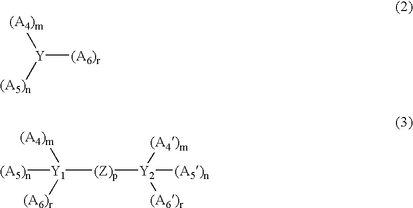

wherein A₄ and A₄′, which may be the same or different, each represents —SO₃M, —COOM or —OM, M represents a hydrogen atom, a metal atom, a quaternary ammonium group or a phosphonium group, m represents an integer of 1 to 10, A₅ and A₅′, which may be the same or different, each represents an electron-withdrawing group, n represents an integer of 1 to 10, A₆ and A₆′, which may be the same or different, each represents a functional group containing a sulfur, selenium or tellurium atom capable of combining with silver ion, r represents 0 or 1, Y, Y₁ and Y₂ each represents an aliphatic group, an aromatic group or a heterocyclic group, Z represents a sulfur atom, a selenium atom or a tellurium atom, and p represents 1 or 2.

25. The photothermographic material as described in the item 22, which comprises at least one hindered phenol compound represented by the following formula (II) on the support surface in the side having said photosensitive layer:

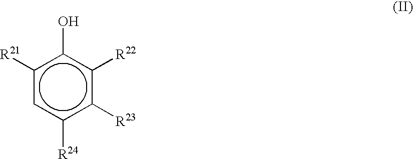

wherein R²¹ and R²² each independently represents a hydrogen atom, an alkyl group or an acylamino group, provided that R²¹ and R²² each is not a 2-hydroxyphenylmethyl group and that R²¹ and R²² are not a hydrogen atom at the same time, R²³ represents a hydrogen atom or an alkyl group, and R²⁴ represents a substituent capable of substituting to the benzene ring.

26. An image forming method comprising exposing the photothermographic material described in the item 22 by a scanning laser beam to form an image, wherein said scanning laser beam creates substantially no vertical angle with the scanning surface of said photothermographic material.

27. An image forming method comprising exposing the photothermographic material described in the item 22 by a scanning laser beam to form an image, wherein said scanning laser beam is in a longitudinal multiple mode.

### DETAILED DESCRIPTION OF THE INVENTION

The practical method and practical embodiment of the present invention are described in detail below. In the present invention, the “to” used to show the range of numerical values denote that the numerical values before and after “to” mean the lower limit and the upper limit, respectively.

The heat-developable photosensitive material of the present invention is obtained by forming the photosensitive layer through a step of coating and then drying a coating solution containing an organic solvent and in the heat-developable photosensitive material comprising a support, an organic silver salt, a reducing agent for silver ion, and a photosensitive silver halide grain, the amount of the solvent of the coating solution remaining in the heat-developable photosensitive material is from 5 to 1,000 mg/m² and the intensity of an order generated from the heat-developable photosensitive material is from −3 to 1 at 120° C.

This heat-developable photosensitive material is excellent in the point of not adversely affecting the working environment and is characterized in that the photographic performance and the image preservability both are good.

The odor intensity at 120° C. is preferably from −3 to 1.0, more preferably from −2.5 to 0.5, still more preferably from −2.5 to 0.

In the present invention, the “intensity of an odor” generated from the heat-developable photosensitive material is a value measured by the following method.

<Preparation of Sample>

A heat-developable photosensitive material enclosed and packaged is taken out from the package at room temperature (25° C.), immediately cut into a size of 4 cm×4 cm and then enclosed in a sample bag (made of polyethylene terephthalate, volume: 2 liter). Thereafter, a nitrogen gas is filled into the bag. In the measurement at 120° C., the sample bag filled with a nitrogen gas is heated on a hot plate at 120° C. for 4 minutes.

<Measurement of Odor Intensity>

The odor in the sample bag is collected by an order discriminator FF-1 (manufactured by Shimadzu Corporation, a temperature rising thermal desorption concentration system by a carbon-type collector tube, an oxide semiconductor sensor, 6 sensors) and the odor intensity SC1 (numerical value of SC1 axis) is measured. The measurement conditions are as follows.

Temperature of constant temperature chamber: 60° C.

Gas flow rate at stationary time: 40 ml/min

Sampling flow rate: 165 ml/min

Sampling time: 18 s (collector tube temperature: 40° C.)

Dry purge flow rate: 500 ml/min

Dry purge time: 90 s (collector tube temperature: 40° C.)

Desorption flow rate: 20 ml/min

Desorption time: 120 s (collector tube temperature: 220° C.)

Cleaning flow rate: 150 ml/min

Cleaning time: 60 s (collector tube temperature: 250° C.)

<Calibration of Odor Intensity>

The odor intensity SC1 obtained under the above-described conditions is calibrated by the following method. By this calibration, comparison can be always made with the same scale.

For the standard data, 5 ppm of toluene is used and the odor intensity is measured at 3 points by varying the degree of concentration while setting the sampling time to 3 seconds, 12 seconds and 48 seconds. These SC1 values are taken as −1.0, 0.0 and 1.8, respectively, and the calibration of FF-1 is performed. For 5 ppm of toluene, a commercially available product can be used. By performing this calibration every each measurement of a film sample, the data obtained can be compensated for the aging deterioration of sensor and exhibit good reproducibility.

In this measurement, the calculation can be automatically performed by selecting a calibration sequence of FF-1 as an automatic measurement mode and starting the software installed into FF-1.

In the present invention, the method for preventing the generation of an odor from the heat-developable photosensitive material is not particularly limited, however, examples of the method which can be used include (1) a method of suppressing the use of an organic solvent and a compound of generating an odor as much as possible, (2) a method of, when an organic solvent is used, using a low boiling point organic solvent, (3) a method of intensifying the drying capacity (for example, elevating the drying temperature or prolonging the drying time) at the coating and drying of the heat-developable photo-sensitive material and (4) a method of additionally heating the heat-developable photosensitive material after the coating and drying. These methods may be used individually or in an appropriate combination.

The source of generating an odor includes not only an organic solvent but also volatile components from additives other than the organic solvent and therefore, the odor intensity is not always corresponding to the amount of organic solvent. The component of increasing the odor intensity is mostly contained in mercapto-base compounds or relatively high molecular compounds. A substance produced by the reaction of several components at a high temperature at the time of heat development also works out to an odor generating source. When these components different from an organic solvent and detected by the sensor of the odor discriminator fall within a certain range and the odor intensity of the heat-developable photosensitive material produced is from −3 to 1, good photographic performance can be unexpectedly attained.

In the present invention, the solvent is a solvent used in a coating solution for forming a photosensitive layer, a protective layer, a backcoat layer or the like constituting the heat-developable photosensitive material of the present invention. When this solvent is contained as a residual solvent within the above-described range, the increase of density in the Dmin part after heat development can be reduced and preferred results can be obtained. If the amount of solvent is too small, the elevation of density in the Dmin part is increased, whereas if it is too large, an odor becomes a problem due to volatilization of the solvent at the heat development.

The amount of the solvent can be adjusted by appropriately setting the drying conditions after the coating of a coating solution for forming each layer constituting the heat-developable photosensitive material.

Examples of the solvent for use in the present invention include those described in Shin Han Yozai Pocketbook (New Edition, Solvent Pocketbook), Ohm Sha (1994), however, the present invention is not limited thereto. The solvent for use in the present invention preferably has a boiling point of 40 to 180° C.

Examples of the solvent for use in the present invention include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N-dimethylformamide, morpholine, propanesultone and perfluorotributylamine.

Among these, hydrofluoroether compounds and dialkyl carbonate compounds are preferred in the formation of the photosensitive material of the present invention.

The hydrofluoroether compound is a compound where at least one or more of carbon atoms in the aliphatic chain having inserted thereinto one or more ethereal oxygen atom is substituted by fluorine, and examples thereof include a compound represented by formula (3):

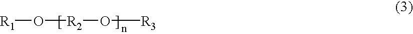

wherein n is an integer of 0 to 7, R₁ and R₃ each independently represents a linear or branched alkyl group having from 1 to 18 carbon atoms, and R₂ represents a linear or branched alkylene group having from 1 to 18 carbon atoms, provided that at least one of R₁ to R₃ are substituted by at least one fluorine atom but all are not substituted at the same time).

The dialkyl carbonate compound which is preferably used in the present invention is a compound represented by formula (4):

R₄—O—(C═O)—O—R₅ (4)

wherein R₄ and R₅ each independently represents a linear, branched or cyclic, substituted or unsubstituted alkyl group having from 1 to 12 carbon atoms.

Specific examples of the compound represented by formula (3) include Compounds 3-1 to 3-10 shown below and specific examples of the compound represented by formula (4) include Compounds 4-1 to 4-5 shown below.

3-1 CF₃(CF₂)₃—O—CH₃

3-2 CF₃(CF₂)₃—O—CH₂CH₃

3-3 CF₃(CF₂)₃—O—CH(CH₃)CH₃

3-4 CF₃CF₂—O—CH₂CH₃

3-5 CF₃(CF₂)₃—O—(CF₂)₂H

3-6 H(CF₂)₂—O—(CF₂)₂H

3-7 H(CF₂)₂—O—(CF₂)₂—O—(CF₂)₂H

3-8 CF₃(CF₂)₃—O—(CF₂)₅H

3-9 H(CF₂)₄—O—(CF₂)₄H

3-10 Cy—C₆F₁₁CF₂—O—(CF₂)₂H (wherein Cy— is a cyclo ring)

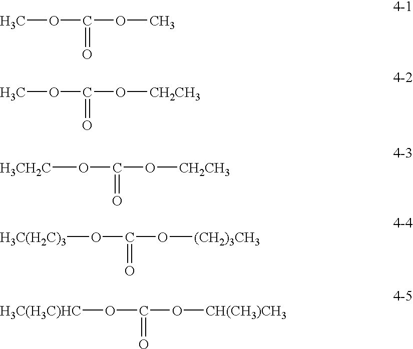

These compounds are not necessarily used individually and two or more thereof may be used in combination. Also, an organic solvent such as toluene, acetone, methyl ethyl ketone, methyl isobutyl ketone, methyl acetate, ethyl acetate, methanol and 2-propanol, which are conventional solvents, may be used by mixing it within a range of not impairing the effect of the present invention. In this case, the amount mixed is preferably less than 10%, more preferably less than 5%. The compound of formula (3) can be produced by referring to, for example, Japanese Unexamined International Publication No. 10-500950 and some compounds are put on the market (HFE, trade name, produced by 3M) and easily available. Some of the compounds represented by formula (4) are also put on the market (for example, DMC, trade name, produced by Daicel Chemical Industries, Ltd.) and easily available.

In the heat-developable photosensitive material of the present invention, the amount of this solvent used is from 5 to 1,000 mg, preferably from 5 to 500 mg, more preferably from 7 to 200 mg.

The compound represented by the following formula (1) for use in the second embodiment of the present invention is described below. In formula (1) of the present invention, R₁ and R₂ each represents a monovalent substituent. The monovalent substituent is not particularly limited but is preferably an alkyl group (e.g., methyl, ethyl, isopropyl, tertiary butyl, methoxyethyl, methoxyethoxyethyl, 2-ethylhexyl, 2-hexyldecyl, benzyl) or an aryl group (e.g., phenyl, 4-chlorophenyl, 2,6-dimethylphenyl), more preferably an alkyl group, still more preferably a tertiary butyl group. R₁ and R₂ may form a ring in cooperation. m and n each represents an integer of 0 to 4, preferably 2 or less.

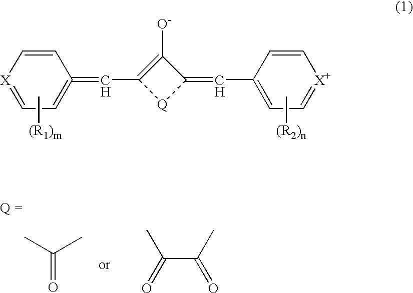

Specific examples of the dye represented by formula (1) for use in the present invention are set forth below, however, the present invention is not limited thereto.

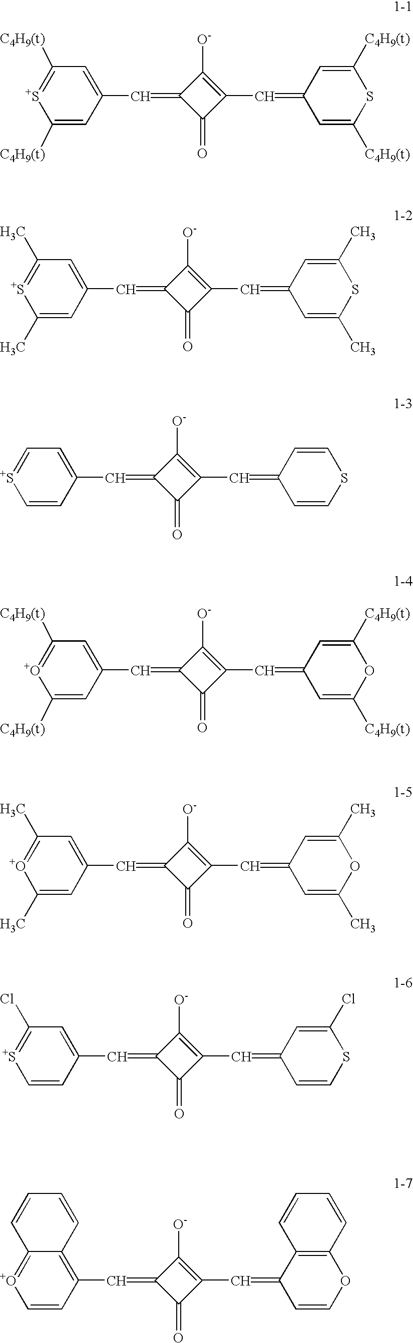

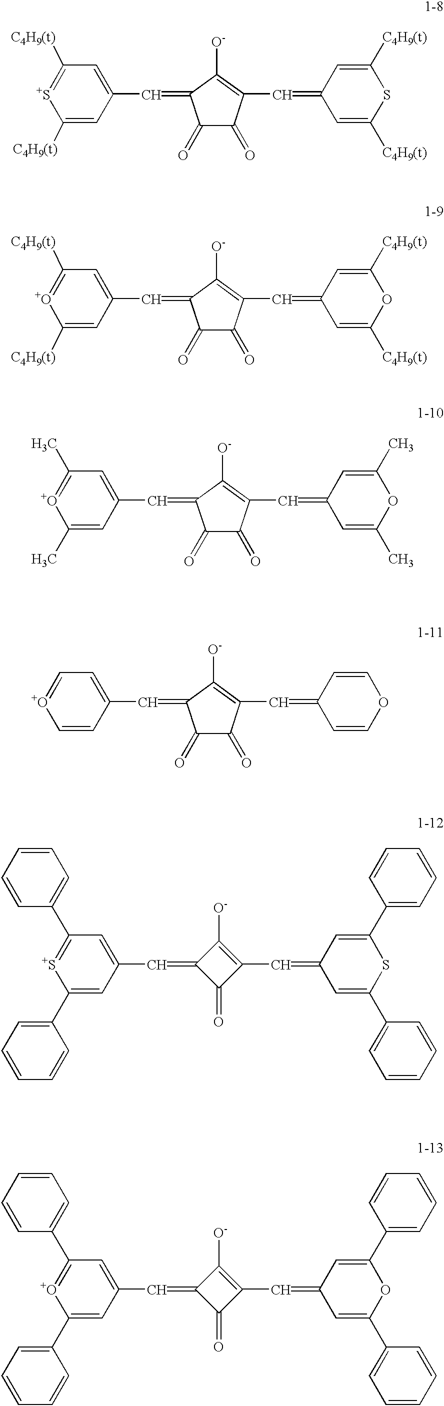

The dyes represented by formula (1) may be used individually or in combination of two or more thereof. The amount used of the dye of the present invention is preferably from 1 to 1×10⁶ μg, more preferably from 10 to 1×10⁵ μg, per m² of the photosensitive material.

The dye represented by formula (1) for use in the present invention can be synthesized by the method, described, for example, in U.S. Pat. No. 4,508,811.

In the case where the dye represented by formula (1) for use in the present invention is added to the heat-developable photosensitive layer, the dye is generally added as a solution by dissolving it in a solvent but may also be added by dispersing it in the form of fine particles using a so-called solid dispersion method. When the dye is added to the heat-developable photosensitive layer, the effect of suppressing the scattering of light is highest, and when the dye is added to the heat-developable photosensitive layer spectrally sensitized to an infrared region of 780 to 830 nm, a great improvement of sharpness can be attained.

In the case of using the dye as a solution in the present invention, the solvent is preferably a high boiling point solvent. The high boiling point solvent is a solvent having a boiling point of 100° C. or more, preferably a solvent having a boiling point of 120° or more, most preferably a solvent having a boiling point of 140° C. or more. The dispersion medium is not particularly limited but examples thereof include water, polymers such as gelatin and polyvinylpyrrolidone, and a mixture thereof.

This dye is preferably applied to a photosensitive material spectrally sensitized to an infrared region, more preferably to a near infrared-sensitive heat-developable photosensitive material having a spectral sensitization maximum wavelength of 780 to 830 nm, because the sharpness in particular can be greatly improved.

In the heat-developable photosensitive material of the present invention, the spectral sensitizing dye which can be used may be any spectral sensitizing dye but is preferably at least one spectral sensitizing dye selected from formulae (2a) to (2d). The spectral sensitizing dyes represented by formulae (2a) to (2d) (hereinafter sometimes referred to as “an infrared-sensitive dye”) are described in detail below.

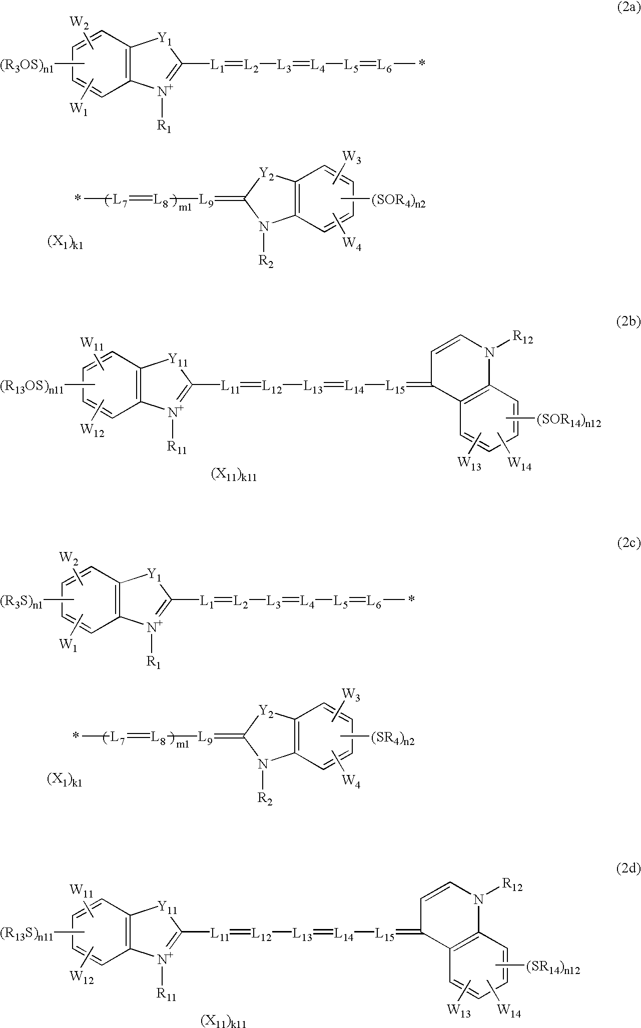

Examples of the aliphatic group represented by R₁, R₂, R₁₁ and R₁₂ in formulae (2a) to (2d) include a branched or linear alkyl group having from 1 to 10 carbon atoms (e.g., methyl, ethyl, propyl, butyl, pentyl, iso-pentyl, 2-ethylhexyl, octyl, decyl), an alkenyl group having from 3 to 10 carbon atoms (e.g., 2-propenyl, 3-butenyl, 1-methyl-3-propenyl, 3-pentenyl, 1-methyl-3-butenyl, 4-hexenyl) and an aralkyl group having from 7 to 10 carbon atoms (e.g., benzyl, phenethyl). These groups each may further be substituted by a group such as a lower alkyl group (e.g., methyl, ethyl, propyl), a halogen atom (e.g., fluorine, chlorine, bromine), a vinyl group, an aryl group (e.g., phenyl, p-tolyl, p-bromophenyl), a trifluoromethyl group, an alkoxy group (e.g., methoxy, ethoxy, methoxyethoxy), an aryloxy group (e.g., phenoxy, p-tolyloxy), a cyano group, a sulfonyl group (e.g., methanesulfonyl, trifluoromethane-sulfonyl, p-toluenesulfonyl), an alkoxycarbonyl group (e.g., ethoxycarbonyl, butoxycarbonyl), an amino group (e.g., amino, biscarboxymethylamino), an aryl group (e.g., phenyl, carboxyphenyl), a heterocyclic group (e.g., tetrahydro-furfuryl, 2-pyrrolidinon-1-yl), an acyl group (e.g., acetyl, benzoyl), a ureido group (e.g., ureido, 3-methylureido, 3-phenylureido), a thioureido group (e.g., thioureido, 3-methylthioureido), an alkylthio group (e.g., methylthio, ethylthio), an arylthio group (e.g., phenylthio), a heterocyclic thio group (e.g., 2-thienylthio, 3-thienylthio, 2-imidazolylthio), a carbonyloxy group (e.g., acetyloxy, propanoyloxy, benzoyloxy), an acylamino group (e.g., acetylamino, benzoylamino) and a thioamido group (e.g., thioacetamido, thiobenzoylamino) or by a hydrophilic group such as a sulfo group, a carboxy group, a phosphono group, a sulfate group, a hydroxy group, a mercapto group, a sulfino group, a carbamoyl group (e.g., carbamoyl, N-methylcarbamoyl, N,N-tetramethylenecarbamoyl), a sulfamoyl group (e.g., sulfamoyl, N,N-3-oxapentamethyleneaminosulfonyl), a sulfonamido group (e.g., methanesulfonamido, butansulfonamido), a sulfonylaminocarbonyl group (e.g., methanesulfonylaminocarbonyl, ethanesulfonylaminocarbonyl), an acylaminosulfonyl group (e.g., acetamidosulfonyl, methoxyacetamidosulfonyl), an acylaminocarbonyl group (e.g., acetamidocarbonyl, methoxyacetamidocarbonyl group) and a sulfinylaminocarbonyl group (e.g., methanesulfinylaminocarbonyl, ethanesulfinylaminocarbonyl). Specific examples of the aliphatic group substituted by such a hydrophilic group include a carboxymethyl group, a carboxyethyl group, a carboxybutyl group, a carboxypentyl group, a 3-sulfatobutyl group, a 3-sulfopropyl group, a 2-hydroxy-3-sulfopropyl group, a 4-sulfobutyl group, a 5-sulfopentyl group, a 3-sulfopentyl group, a 3-sulfinobutyl group, a 3-phosphonopropyl group, a hydroxyethyl group, an N-methanesulfonylcarbamoylmethyl group, a 2-carboxy-2-propenyl group, an o-sulfobenzyl group, a p-sulfophenethyl group and a p-carboxybenzyl group.

Examples of the lower alkyl group represented by R₃, R₄, R₁₃ and R₁₄ include a linear or branched alkyl group having 5 or less carbon atoms and specific examples thereof include a methyl group, an ethyl group, a propyl group, a butyl group, a pentyl group and an isopropyl group. Examples of the cycloalkyl group include a cyclopropyl group, a cyclobutyl group and a cyclopentyl group. Examples of the alkenyl group include a 2-propenyl group, a 3-butenyl group, a 1-methyl-3-propenyl group, a 3-pentenyl group, a 1-methyl-3-butenyl group and a 4-hexenyl group. Examples of the aralkyl group include a benzyl group, a phenethyl group, a p-methoxyphenylmethyl group and an o-acetylaminophenylethyl group. Examples of the aryl group include a substituted or unsubstituted aryl group such as phenyl group, 2-naphthyl group, 1-naphthyl group, o-tolyl group, o-methoxyphenyl group, m-chlorophenyl group, m-bromophenyl group, p-tolyl group and p-ethoxyphenyl group. Examples of the heterocyclic group include a substituted or unsubstituted heterocyclic group such as 2-furyl group, 5-methyl-2-furyl group, a 2-thienyl group, a 3-thienyl group, a 2-imidazolyl group, a 2-methyl-1-imidazolyl group, a 4-phenyl-2-thiazolyl group, 5-hydroxy-2-benzothiazolyl group, 2-pyridyl group and 1-pyrrolyl group. These groups each may be substituted by a group such as a lower alkyl group (e.g., methyl, ethyl), a lower alkoxy group (e.g., methoxy, ethoxy), a hydroxy group, a halogen atom (e.g., fluorine, chlorine, bromine, iodine), an aryl group (e.g., phenyl, tolyl, chlorophenyl), a mercapto group and a lower alkylthio group (e.g., methylthio, ethylthio).

Specific examples of the substituent represented by W₁ to W₄ and W₁₁ to W₁₄ include an alkyl group (e.g., methyl, ethyl, butyl, isobutyl), an aryl group (including a monocyclic aryl group and a polycyclic aryl group, e.g., phenyl, naphthyl), a heterocyclic group (e.g., thienyl, furyl, pyridyl, carbazolyl, pyrrolyl, indolyl), a halogen atom (e.g., fluorine, chlorine, bromine), a vinyl group, an aryl group (e.g., phenyl, p-tolyl, p-bromophenyl), a trifluoromethyl group, an alkoxy group (e.g., methoxy, ethoxy, methoxyethoxy), an aryloxy group (e.g., phenoxy, p-tolyloxy), a sulfonyl group (e.g., methanesulfonyl, p-toluenesulfonyl), an alkoxycarbonyl group (e.g., ethoxycarbonyl, butoxycarbonyl), an amino group (e.g., amino, biscarboxymethylamino), an aryl group (e.g., phenyl, carboxyphenyl), a heterocyclic group (e.g., tetrahydrofurfuryl, 2-pyrrolidinon-1-yl), an acyl group (e.g., acetyl, benzoyl), a ureido group (e.g., ureido, 3-methylureido, 3-phenylureido), a thioureido group (e.g., thioureido, 3-methylthioureido), an alkylthio group (e.g., methylthio, ethylthio), an arylthio group (e.g., phenylthio), a hydroxy group and a styryl group.

These groups each may be substituted by a group describe above for the aliphatic group represented by R₁ and the like and specific examples of the substituted alkyl group include a 2-methoxyethyl group, a 2-hydroxyethyl group, a 3-ethoxycarbonylpropyl group, a 2-carbamoylethyl group, a 2-methanesulfonylethyl group, a 3-methanesulfonylaminopropyl group, a benzyl group, a phenethyl group, a carboxymethyl group, a carboxyethyl group, an allyl group and a 2-furylethyl group. Specific examples of the substituted aryl group include a p-carboxyphenyl group, a p-N,N-dimethylaminophenyl group, a p-morpholinophenyl group, a p-methoxyphenyl group, a 3,4-dimethoxyphenyl group, a 3,4-methylenedioxyphenyl group, a 3-chlorophenyl group and a p-nitrophenyl group. Specific examples of the substituted heterocyclic group include a 5-chloro-2-pyridyl group, a 5-ethoxycarbonyl-2-pyridyl group and a 5-carbamoyl-2-pyridyl group.

Examples of the condensed ring which can be formed when W₁ and W₂, W₃ and W₄, W₁₁ and W₁₂, W₁₃ and W₁₄, R₃ and W₁, R₃ and W₂, R₁₃ and W₁₁, R₁₃ and W₁₂, R₄ and W₃, R₄ and W₄, R₁₄ and W₁₃, or R₁₄ and W₁₄ are combined with each other include a 5- or 6-membered saturated or unsaturated condensed carbon ring. On this condensed ring, a group may be substituted at any position. Examples of the group substituted to the condensed ring include those described above as the group which can be substituted to an aliphatic group.

In formulae (2a) to (2d), the methine groups represented by L₁ to L₉ and L₁₁ to L₁₅ each is independently a substituted or unsubstituted methine group. Specific examples of the group substituted to the methine group include a substituted or unsubstituted lower alkyl group (e.g., methyl, ethyl, iso-propyl, benzyl), a substituted or unsubstituted alkoxy group (e.g., methoxy, ethoxy), a substituted or unsubstituted aryloxy group (e.g., phenoxy, naphthoxy), a substituted or unsubstituted aryl group (e.g., phenyl, naphthyl, p-tolyl, o-carboxyphenyl), —N(V₁,V₂), —SR or a substituted or unsubstituted heterocyclic group (e.g., 2-thienyl, 2-furyl, N,N′-bis(methoxyethyl)barbituric acid group). R represents the above-described lower alkyl, aryl or heterocyclic group, V₁ and V₂ each represents a substituted or unsubstituted lower alkyl group or a substituted or unsubstituted aryl group, and V₁ and V₂ may combine with each other to form a 5- or 6-membered nitrogen-containing heterocyclic ring. In the methine groups, methine groups adjacent to each other, or a methine group and a methine group next to the adjacent methine group may combine with each other to form a 5- or 6-membered ring.

In the compounds represented by formulae (2a) to (2d), when a group having a cationic or anionic electric charge is substituted, an equivalent counter anion or cation is formed for canceling the electric charge within the molecule. As for the ion represented by X₁ and X₁₁ necessary for canceling the electric charge within the molecule, specific examples of the cation include proton, organic ammonium ion (e.g., triethylammonium ion, triethanolammonium ion) and inorganic cation (e.g., lithium ion, sodium ion, potassium ion). Examples of the acid anion include halogen ion (e.g., chloride ion, bromide ion, iodide ion), p-toluenesulfonate ion, perchlorate ion, tetrafluoroborate ion, sulfate ion, methyl sulfate ion, ethyl sulfate ion, methanesulfonate ion and trifluoromethanesulfonate ion.

Specific examples of the photosensitive dyes represented by formulae (2a) to (2d) are set forth below, however, the present invention is not limited to these compounds.

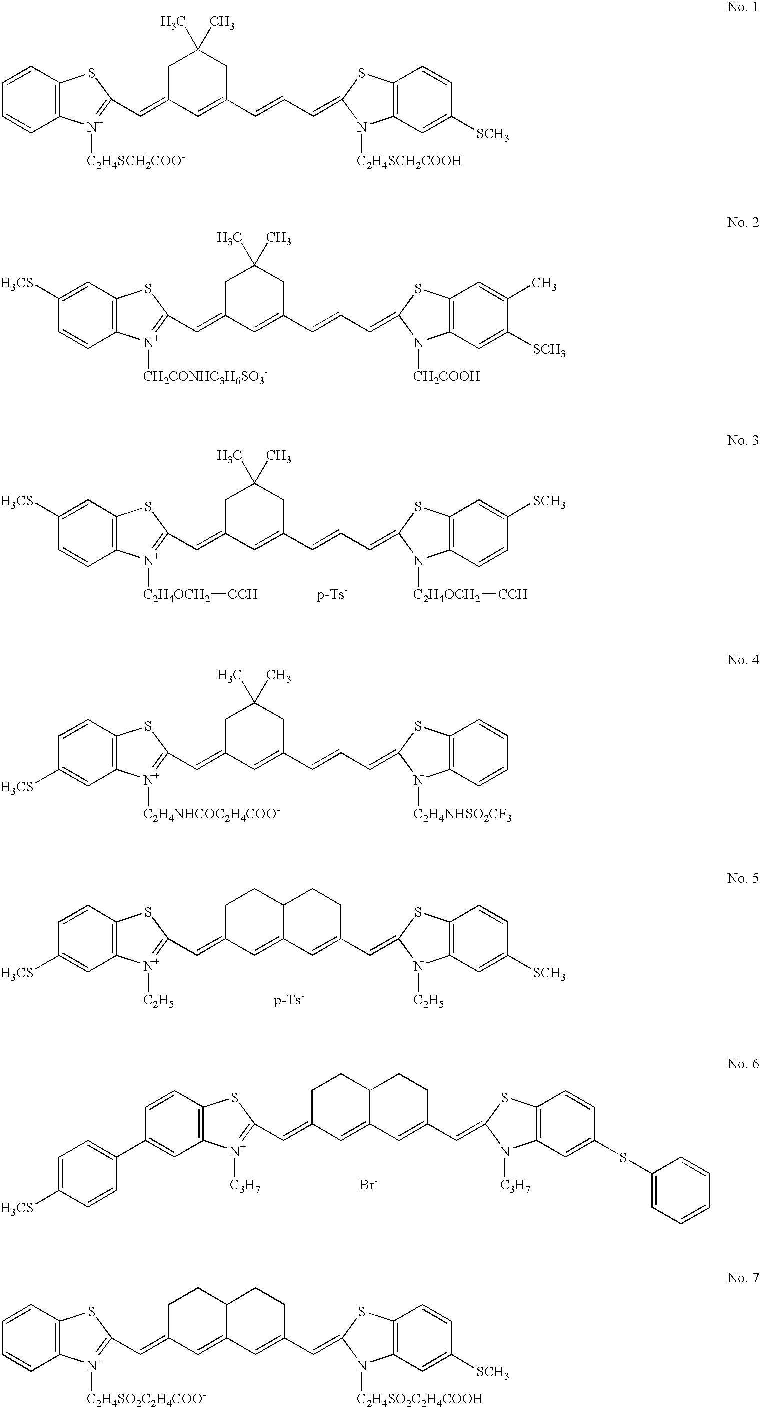

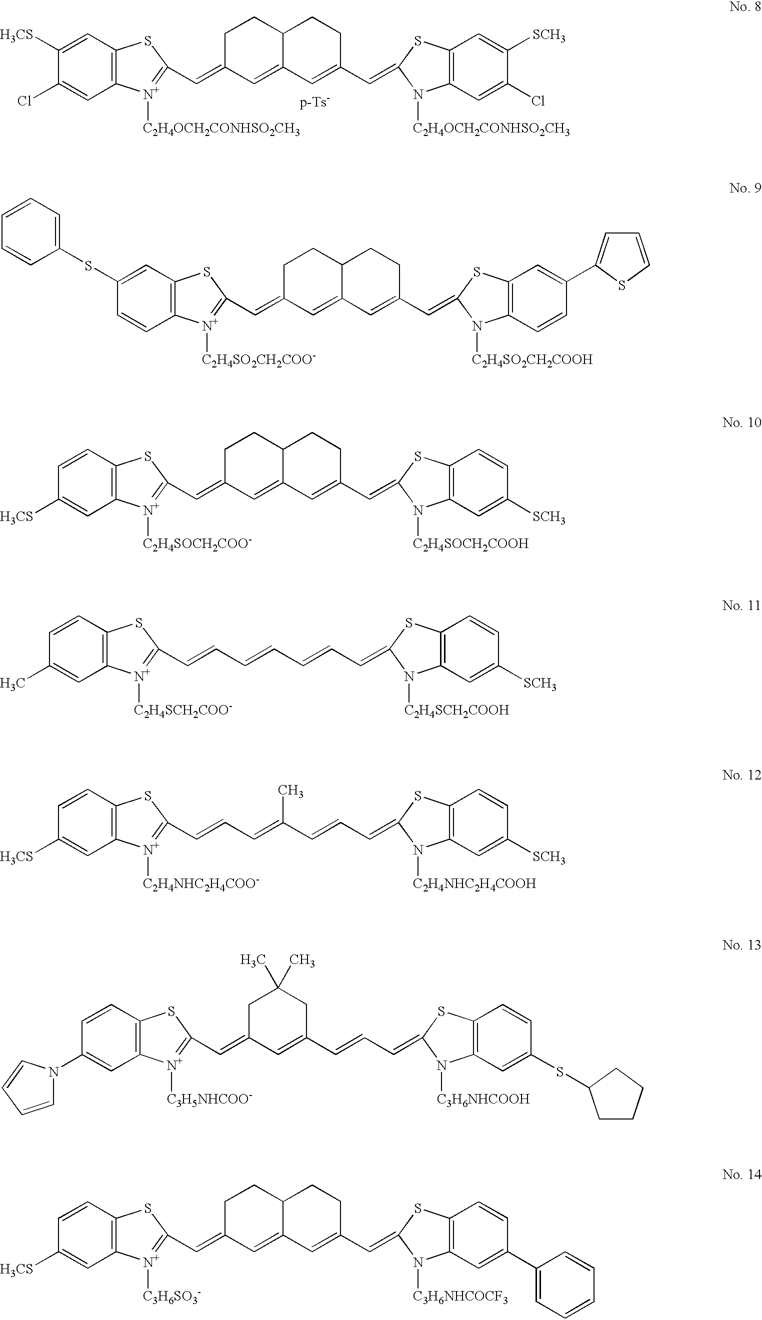

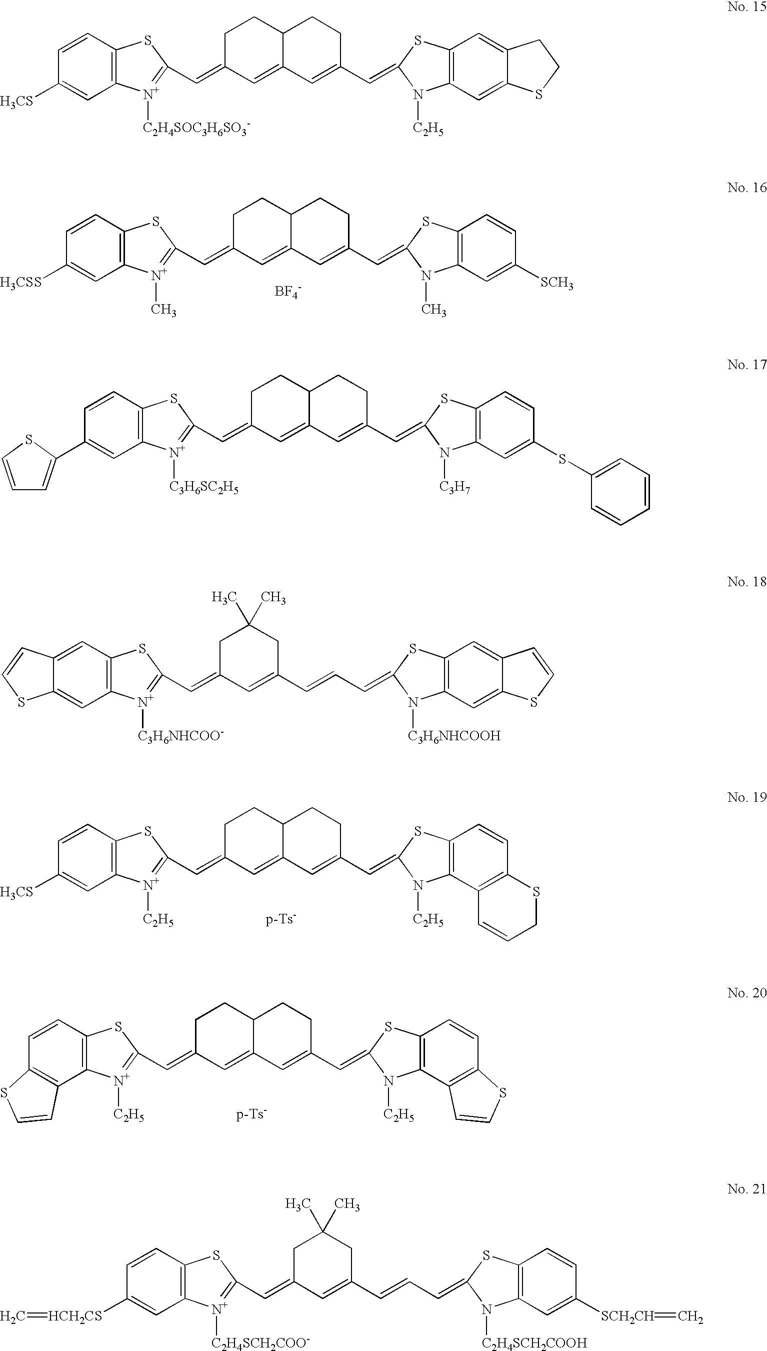

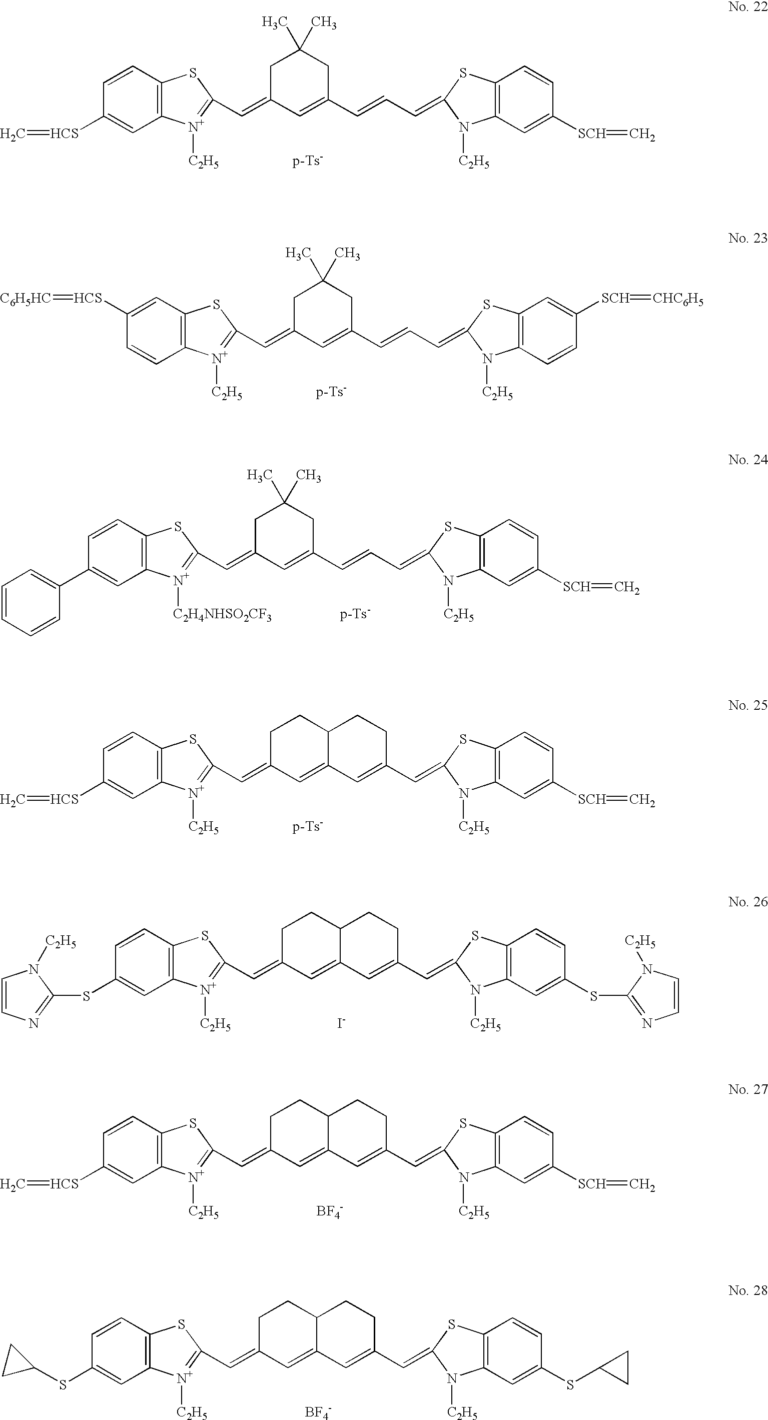

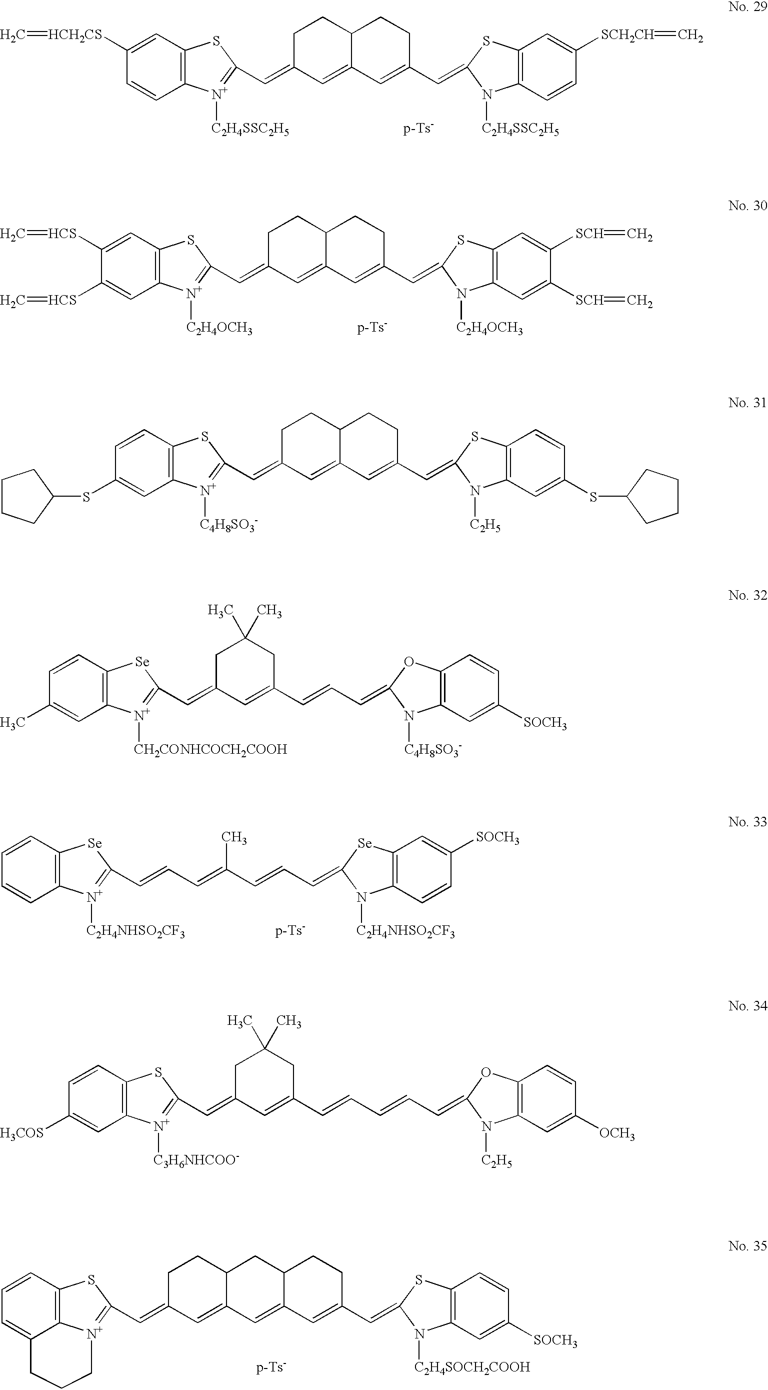

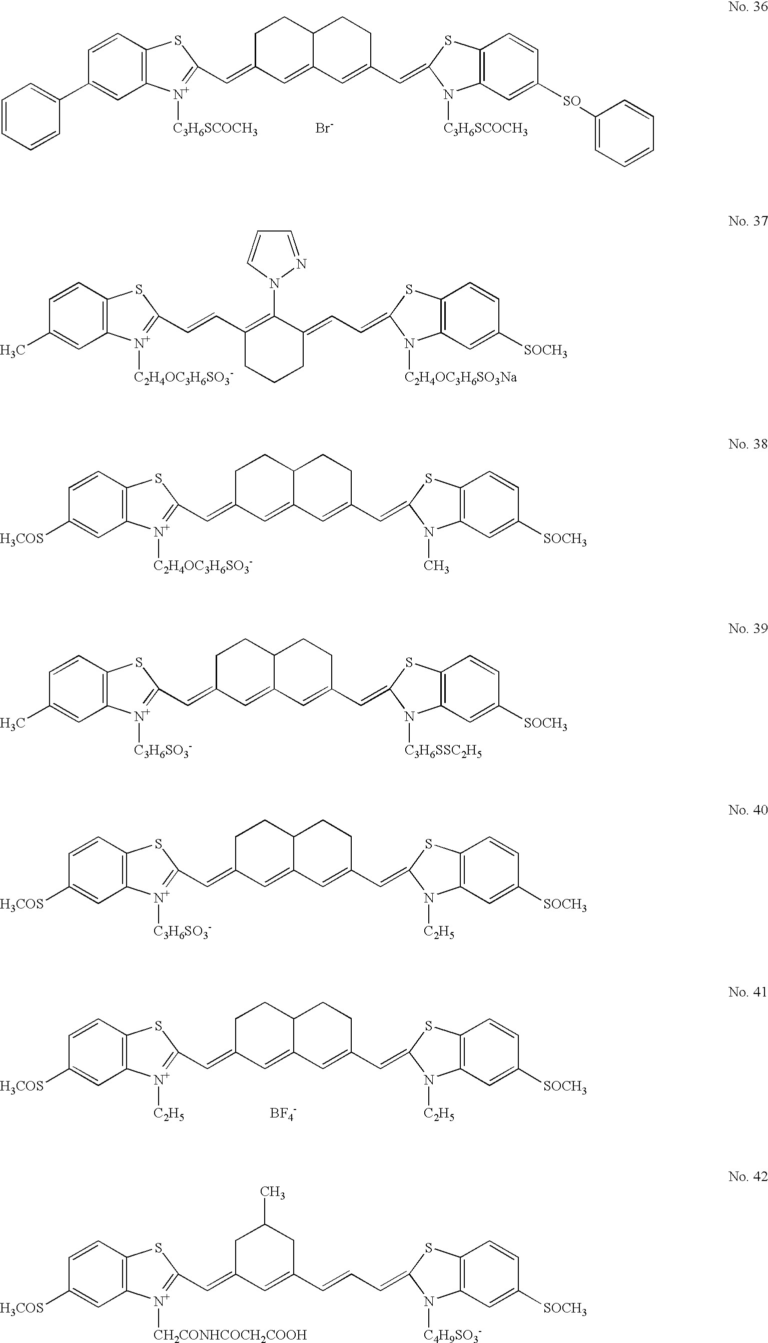

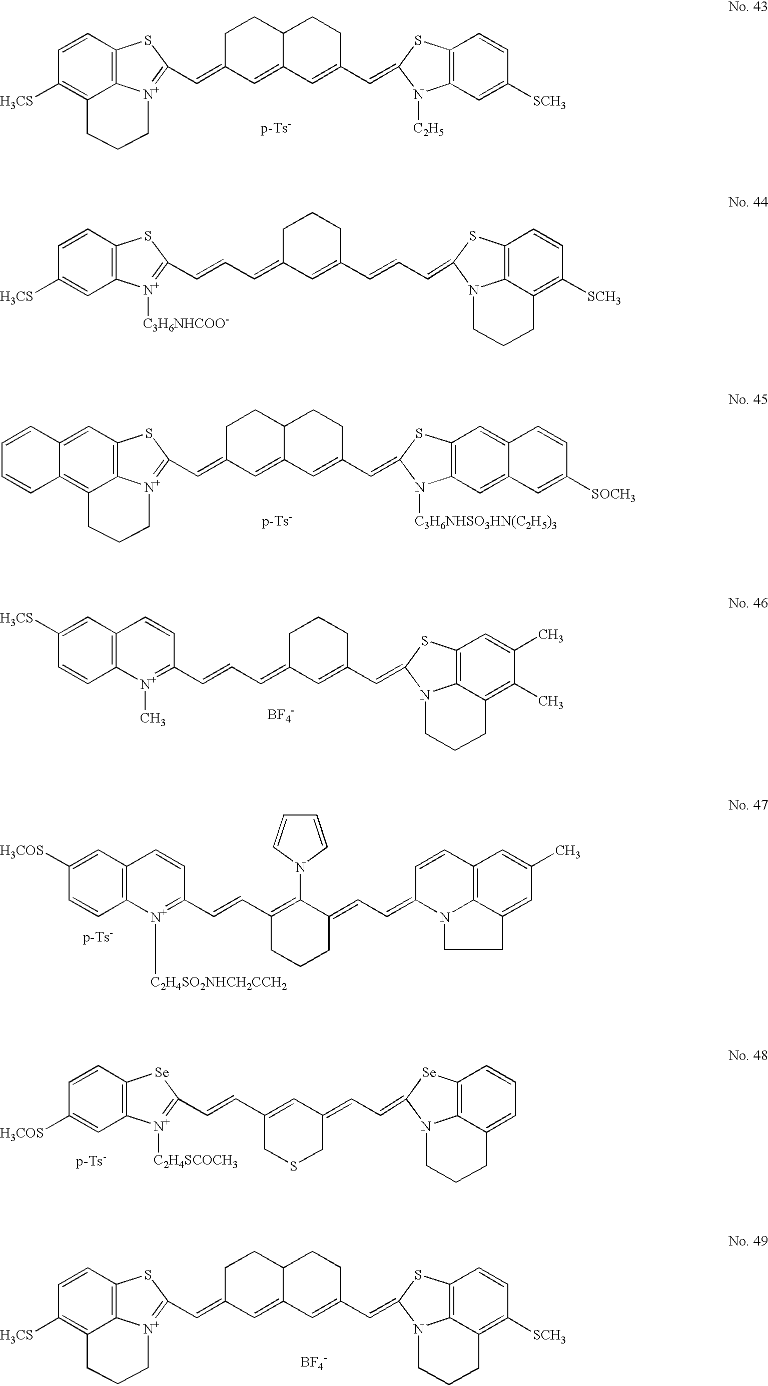

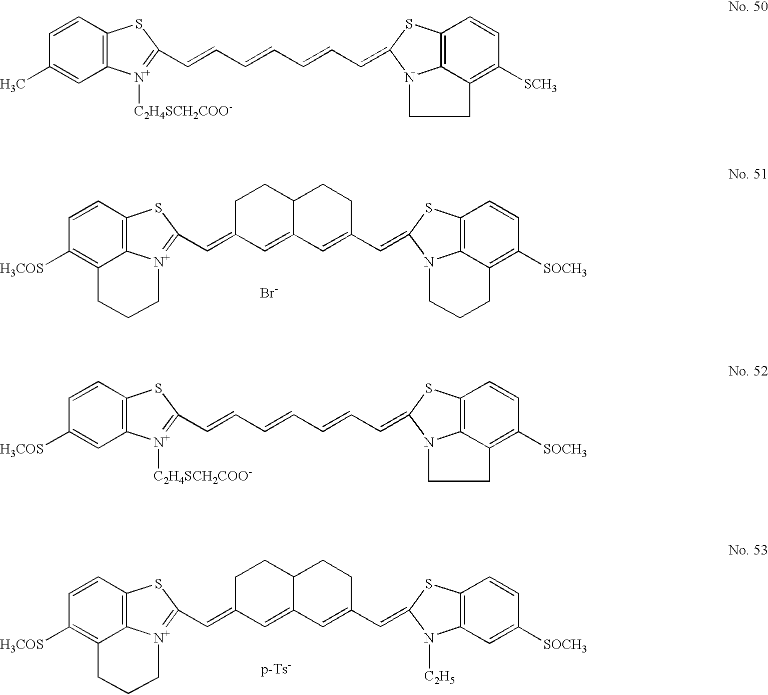

The infrared-sensitive dyes represented by formulae (2a) to (2d) for use in the present invention can be synthesized by a method described, for example, in F.M. Hammer, The Chemistry of Heterocyclic Compounds, Vol. 18, A. Weissberger (ed.), The Cyanine Dyes and Related Compounds, Interscience, New York (1964), JP-A-3-138638, JP-A-10-73900, Japanese Unexamined International Publication No. 9-510022, U.S. Pat. No. 2,734,900, British Patent 774,779, and Japanese Patent Application Nos. 10-269843 and 11-58686.

In the present invention, the infrared-sensitive dyes represented by formulae (2a) to (2d) may be used individually or in combination of two or more photo-sensitive dyes thereof. When used individually or in combination, the infrared-sensitive dye(s) is contained in the silver halide emulsion in a total amount of 1×10⁻⁶ to 5×10⁻³ mol, preferably from 1×10⁻⁵ to 2.5×10⁻³ mol, more preferably from 4×10⁻⁵ to 1×10⁻³ mol, per mol of silver halide. In the present invention, when two or more photosensitive dyes are used in combination, these photosensitive dyes may be contained at an arbitrary ratio in the silver halide emulsion.

The heat-developable photosensitive material according to the third embodiment of the present invention preferably contains a compound represented by formula (1) in the photosensitive layer. By containing this compound, an excellent result can be obtained in view of storage stability of the silver image after heat development.

Furthermore, the photosensitive layer preferably contains a sulfonium salt. By containing the sulfonium salt, an excellent result can be obtained in view of fog generated when an undeveloped photosensitive material is stored for a long period of time.

The halogen compound represented by the following formula (X) for use in the third embodiment of the present invention is described below. In the third embodiment of the present invention, the halogen compound shown below is preferably used:

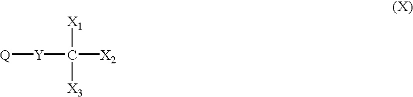

wherein:

Q represents an aryl group or a heterocyclic group,

X₁, X₂ and X₃ each independently represents a hydrogen atom, a halogen atom, a haloalkyl group, an acyl group, an alkoxycarbonyl group, an aryloxycarbonyl group, a carbamoyl group, a sulfamoyl group, a sulfonyl group, a heterocyclic group or an aryl group, provided that at least one of X₁, X₂ and X₃ is a halogen atom, and Y represents —C(═O)—, —SO— or —SO₂—.

The aryl group represented by Q may be either a monocyclic ring or a condensed ring but is preferably a monocyclic or dicyclic aryl group having from 6 to 20 carbon atoms (e.g., phenyl, naphthyl), more preferably a phenyl group or a naphthyl group, still more preferably a phenyl group.

The heterocyclic group represented by Q is preferably a 3-, 4-, 5-, 6-, 7-, 8-, 9- or 10-membered saturated or unsaturated heterocyclic group containing at least one atom of N, O and S. This group may be a monocyclic ring or may form a condensed ring with another ring.

The heterocyclic group is more preferably a 5- or 6-membered unsaturated heterocyclic group which may have a condensed ring, still more preferably a 5- or 6-membered aromatic heterocyclic ring which may have a condensed ring, particularly preferably a 5- or 6-membered aromatic heterocyclic group which may have a condensed ring containing a nitrogen atom, and most preferably a 5- or 6-membered aromatic heterocyclic group which may have a condensed ring containing from 1 to 4 nitrogen atoms.

Preferred examples of the heterocyclic ring in this heterocyclic group include imidazole, pyrazole, pyridine, pyrimidine, pyrazine, pyridazine, triazole, triazine, indole, indazole, purine, thiadiazole, oxadiazole, quinoline, phthalazine, naphthylidine, quinoxaline, quinazoline, cinnoline, pteridine, acridine, phenanthroline, phenazine, tetrazole, thiazole, oxazole, benzimidazole, benzoxazole, benzothiazole, indolenine and tetrazaindene.

Among these, more preferred are imidazole, pyridine, pyrimidine, pyrazine, pyridazine, triazole, triazine, thiadiazole, oxadiazole, quinoline, phthalazine, naphthylidine, quinoxaline, quinazoline, cinnoline, tetrazole, thiazole, oxazole, benzimidazole, benzoxazole, benzothiazole and tetrazaindene, still more preferred are imidazole, pyridine, pyrimidine, pyrazine, pyridazine, triazole, triazine, thiadiazole, quinoline, phthalazine, naphthylidine, quinoxaline, quinazoline, cinnoline, tetrazole, thiazole, benzimidazole and benzothiazole, particularly preferred are pyridine, thiadiazole, quinoline and benzothiazole.

The aryl group and the heterocyclic group represented by Q each may have a substituent in addition to —Y— C(X₁) (X₂) (X₃) in formula (X).

Preferred examples of the substituent include an alkyl group, an alkenyl group, an aryl group, an alkoxyl group, an aryloxy group, an acyloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, a sulfonyl group, a ureido group, a phosphoric acid amido group, a halogen atom, a cyano group, a sulfo group, a carboxyl group, a nitro group and a heterocyclic group. Among these, more preferred are an alkyl group, an aryl group, an alkoxyl group, an aryloxy group, an acyl group, an acylamino group, an alkoxycarbonylamino group, an aryloxycarbonylamino group, a sulfonylamino group, a sulfamoyl group, a carbamoyl group, a ureido group, a phosphoric acid amido group, a halogen atom, a cyano group, a nitro group and a heterocyclic group, still more preferred are an alkyl group, an aryl group, an alkoxyl group, an aryloxy group, an acyl group, an acylamino group, a sulfonylamino group, a sulfamoyl group, a carbamoyl group, a halogen atom, a cyano group, a nitro group and a heterocyclic group, particularly preferred are an alkyl group, an aryl group and a halogen atom.

X₁, X₂ and X₃ in formula (X) each is preferably a halogen atom, a haloalkyl group, an acyl group, an alkoxycarbonyl group, an aryloxycarbonyl group, a carbamoyl group, a sulfamoyl group, a sulfonyl group or a heterocyclic group, more preferably a halogen atom, a haloalkyl group, an acyl group, an alkoxycarbonyl group, an aryloxycarbonyl group or a sulfonyl group, still more preferably a halogen atom or a trihalomethyl group, particularly preferably a halogen atom.

Among the halogen atoms, preferred are a chlorine atom, a bromine atom and a iodine atom, more preferred are a chlorine atom and a bromine atom, still more preferably a bromine atom.

Y represents —C(═O)—, —SO— or —SO₂—, and Y is preferably —SO₂—.

Specific examples of the halogen compound represented by formula (X) are set forth below, however, the present invention is not limited thereto.

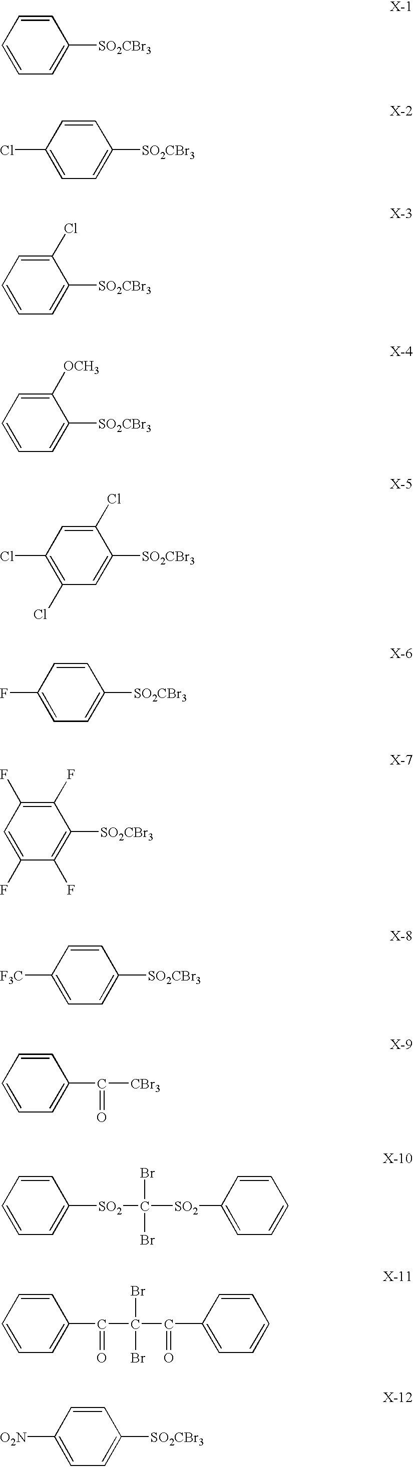

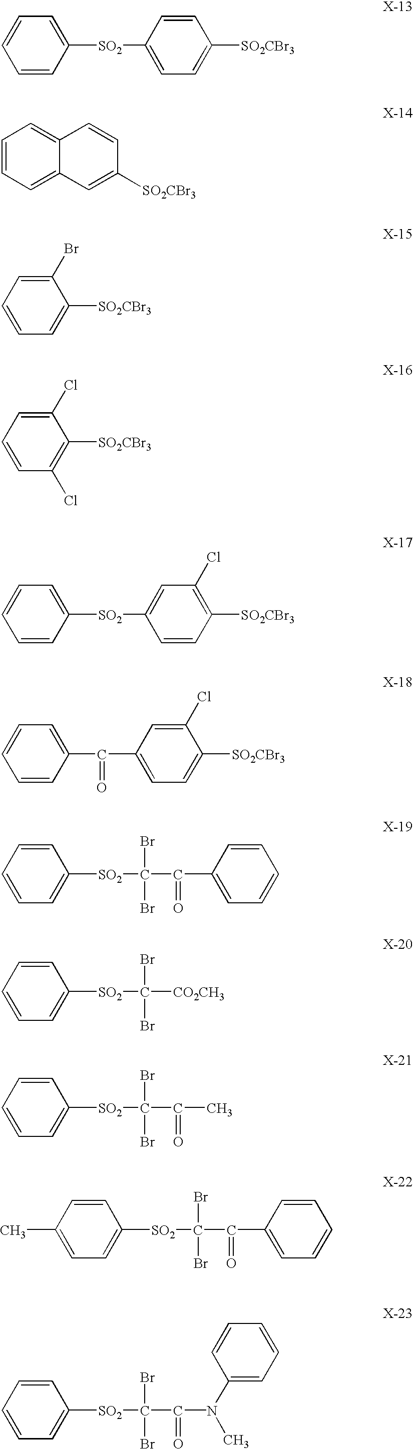

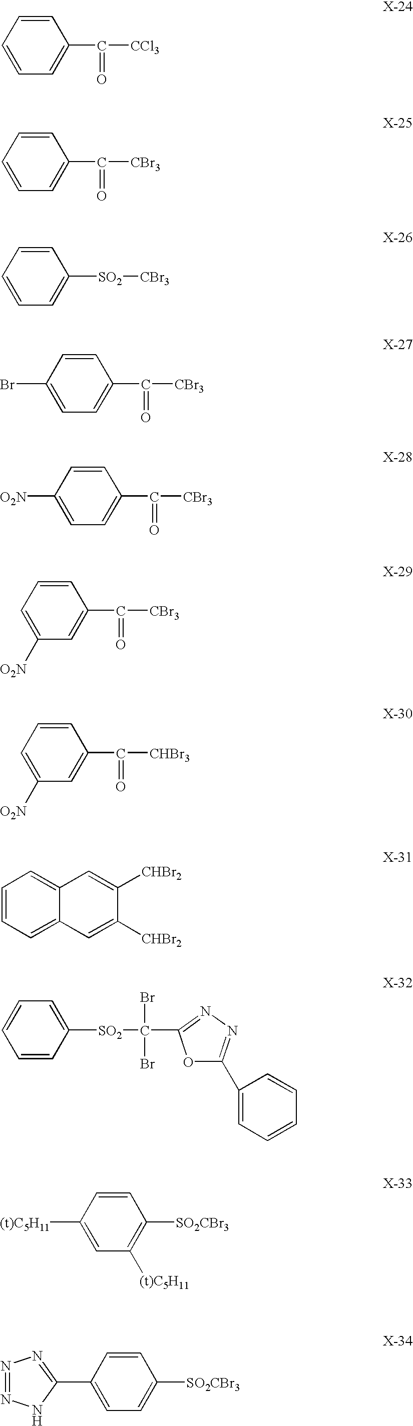

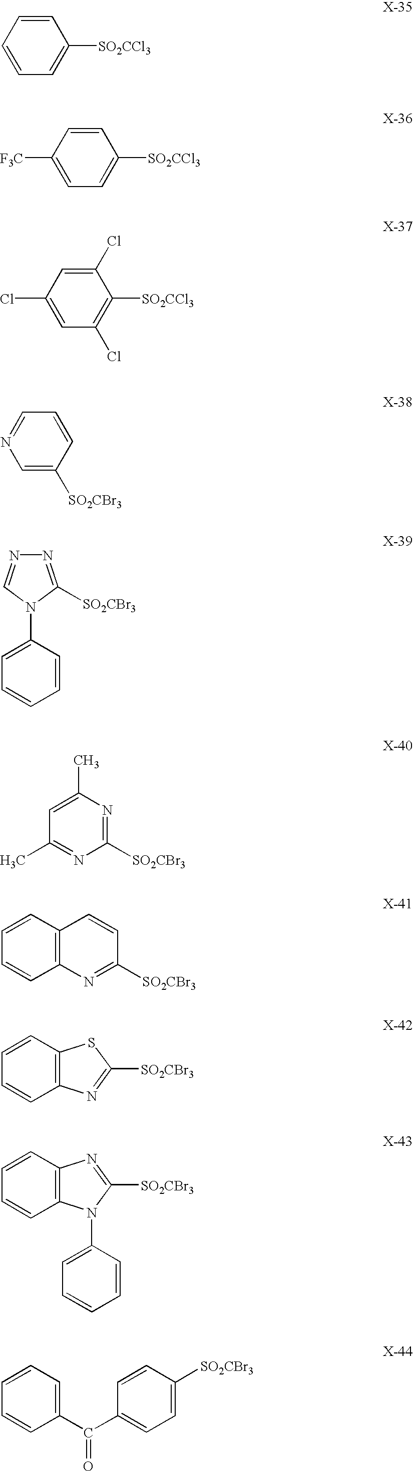

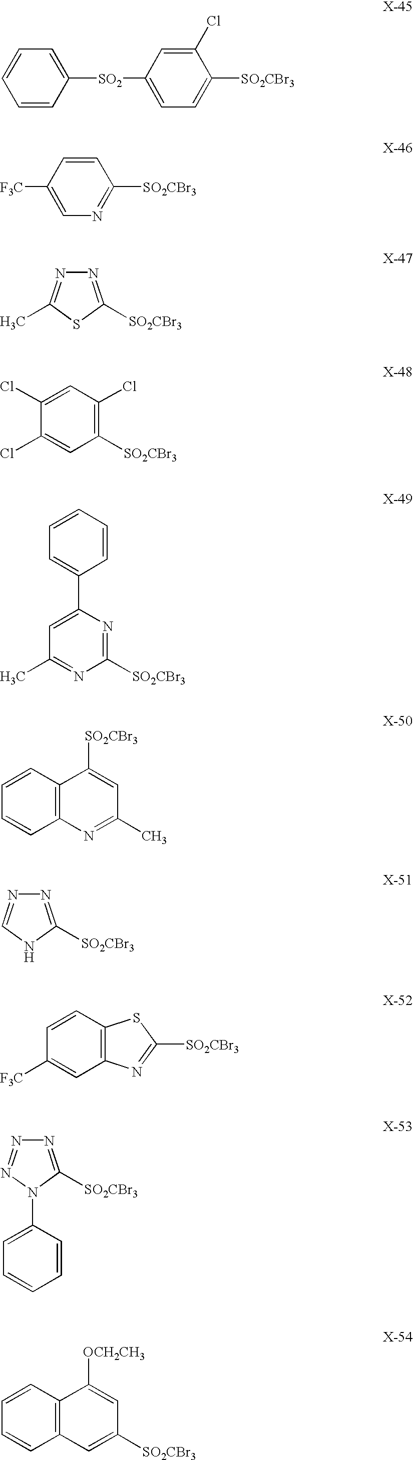

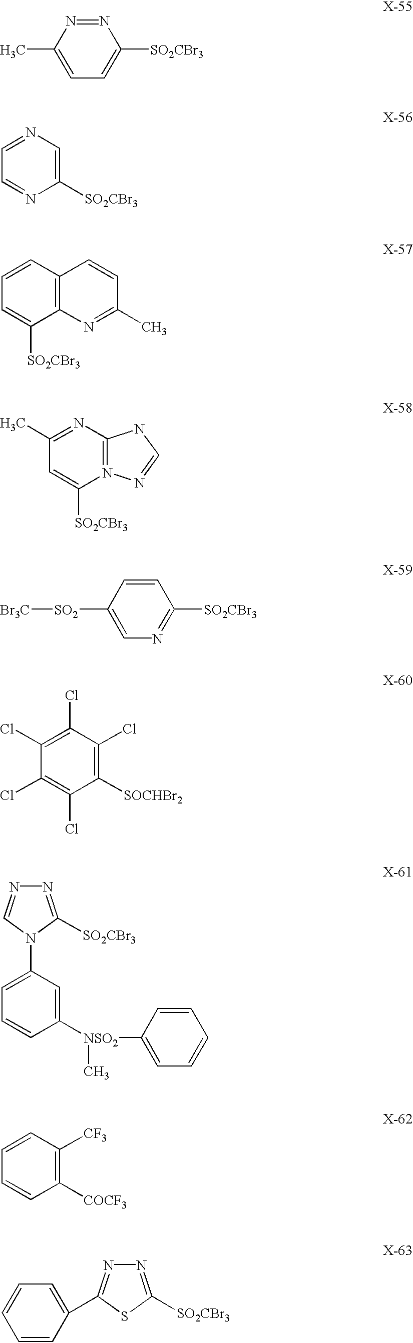

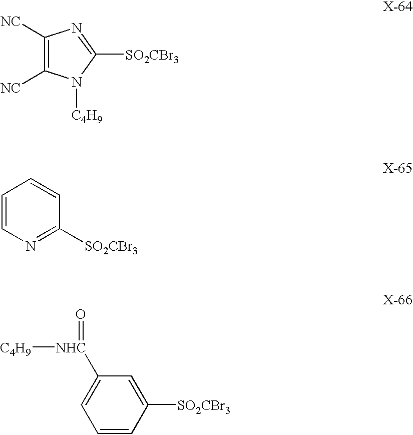

The photosensitive layer contains the halogen compound represented by formula (X), whereby fog is reduced at the heat development. The content of the halogen compound is preferably from 1×10⁻⁴ to 1 mol, more preferably from 1×10⁻³ to 0.5 mol, per mol of silver.

If the halogen compound content is too small, fog increases to cause overall fogging, whereas if the content is excessively large, low sensitivity results and the image density decreases.

The compound represented by the following formula (I) is described in detail below.

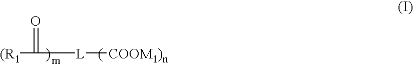

In formula (I), M₁ represents a hydrogen atom or a cation.

R₁ represents a hydrogen atom; a group represented by —OM₂ (wherein M₂ represents a hydrogen atom or a cation); an alkyl group substituted by a group containing at least one heteroatom; an aryl group substituted by at least one group selected from the group consisting of an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, an alkoxycarbonyloxy group, an aryloxycarbonyloxy group, a sulfonylamino group, a sulfamoyl group, a carbamoyl group, an alkylthio group, an arylthio group, an amino group, a sulfonyl group, a sulfinyl group, a sulfonyloxy group, a ureido group, a silyl group, a mercapto group, a hydroxy group, a nitroso group, a sulfo group, a carboxyl group, a phosphoric acid ester group, a heterocyclic group and a halogenoalkyl group; or a heterocyclic group.

Specific examples of the cation represented by M₁ and M₂ include alkali metal ion (e.g., lithium ion, sodium ion, potassium ion, cesium ion), alkaline earth metal ion (e.g., magnesium ion, calcium ion), ammonium (e.g., ammonium, trimethylammonium, triethylammonium, tetramethylammonium, tetraethylammonium, tetrabutylammonium, 1,2-ethane-diammonium), pyridinium, imidazolium and phosphonium (e.g., tetrabutylphosphonium).

M₁ and M₂ each is preferably a hydrogen atom or an alkali metal ion, more preferably a hydrogen atom.

When R₁ is an alkyl group substituted by a group containing at least one heteroatom, specific examples of the group containing at least one heteroatom are described below.

Amino Group:

An amino group preferably having from 0 to 20 carbon atoms, more preferably from 0 to 10 carbon atoms, still more preferably from 0 to 6 carbon atoms, such as amino, methylamino, dimethylamino, diethylamino and dibenzylamino.

Alkoxy Group:

An alkoxy group preferably having from 1 to 20 carbon atoms, more preferably from 1 to 12 carbon atoms, still more preferably from 1 to 8 carbon atoms, such as methoxy, ethoxy and butoxy.

Aryloxy Group:

An aryloxy group preferably having from 6 to 20 carbon atoms, more preferably from 6 to 16 carbon atoms, still more preferably from 6 to 12 carbon atoms, such as phenyloxy and 2-naphthyloxy.

Acyl Group:

An acyl group preferably having from to 20 carbon atoms, more preferably from 1 to 16 carbon atoms, still more preferably from 1 to 12 carbon atoms, such as acetyl, benzoyl, formyl and pivaloyl.

Alkoxycarbonyl Group:

An alkoxycarbonyl group preferably having from 2 to 20 carbon atoms, more preferably from 2 to 16 carbon atoms, still more preferably from 2 to 12 carbon atoms, such as methoxycarbonyl and ethoxycarbonyl.

Acryloxycarbonyl Group:

An aryloxycarbonyl group preferably having from 7 to 20 carbon atoms, more preferably from 7 to 16 carbon atoms, still more preferably from 7 to 10 carbon atoms, such as phenyloxycarbonyl.

Acyloxy Group:

An acyloxy group preferably having from 2 to 20 carbon atoms, more preferably from 2 to 16 carbon atoms, still more preferably from 2 to 10 carbon atoms, such as acetoxy and benzoyloxy.

Acylamio Group:

An acylamino group preferably having from 2 to 20 carbon atoms, more preferably from 2 to 16 carbon atoms, still more preferably from 2 to 10 carbon atoms, such as acetylamino and benzoylamino.

Alkoxycarbonylamino Group:

An alkoxycarbonylamino group preferably having from 2 to 20 carbon atoms, more preferably from 2 to 16 carbon atoms, still more preferably from 2 to 12 carbon atoms, such as methoxycarbonylamino.

Aryloxycarbonylamino Group:

An aryloxycarbonylamino group preferably having from 7 to 20 carbon atoms, more preferably from 7 to 16 carbon atoms, still more preferably from 7 to 12 carbon atoms, such as phenyloxycarbonylamino.

Sulfonylamino Group:

A sulfonylamino group preferably having from 1 to 20 carbon atoms, more preferably from 1 to 16 carbon atoms, still more preferably from 1 to 12 carbon atoms, such as methanesulfonylamino and benzenesulfonylamino.

Sulfamoyl Group:

A sulfamoyl group preferably having from 0 to 20 carbon atoms, more preferably from 0 to 16 carbon atoms, still more preferably from 0 to 12 carbon atoms, such as sulfamoyl, methylsulfamoyl, dimethylsulfamoyl and phenylsulfamoyl.

Carbamoyl Group:

A carbamoyl group preferably having from 1 to 20 carbon atoms, more preferably from 1 to 16 carbon atoms, still more preferably from 1 to 12 carbon atoms, such as carbamoyl, methylcarbamoyl, diethylcarbamoyl and phenylcarbamoyl.

Alkylthio Group:

An alkylthio group preferably having from 1 to 20 carbon atoms, more preferably from 1 to 16 carbon atoms, still more preferably from 1 to 12 carbon atoms, such as methylthio and ethylthio.

Arylthio Group:

An arylthio group preferably having from 6 to 20 carbon atoms, more preferably from 6 to 16 carbon atoms, still more preferably from 6 to 12 carbon atoms, such as phenylthio.

Sulfonyl Group:

A sulfonyl group preferably having from 1 to 20 carbon atoms, more preferably from 1 to 16 carbon atoms, still more preferably from 1 to 12 carbon atoms, such as mesyl and tosyl.

Sulfinyl Group:

A sulfinyl group preferably having from 1 to 20 carbon atoms, more preferably from 1 to 16 carbon atoms, still more preferably from 1 to 12 carbon atoms, such as methanesulfinyl and benzenesulfinyl.

Ureido Group:

A ureido group preferably having from 1 to 20 carbon atoms, more preferably from 1 to 16 carbon atoms, still more preferably from 1 to 12 carbon atoms, such as ureido, methylureido and phenylureido.

Phosphoric Acid Amido Group:

A phosphoric acid amido group preferably having from 1 to 20 carbon atoms, more preferably from 1 to 16 carbon atoms, still more preferably from 1 to 12 carbon atoms, such as diethylphosphoric acid amide and phenylphosphoric acid amide.

Hydroxy Group, Mercapto Group and Halogen Atom:

For example, a fluorine atom, a chlorine atom, a bromine atom and a iodine atom.

Heterocyclic Group:

For example, imidazolyl, pyridyl, furyl, piperidyl and morpholino.

Others:

A cyano group, a sulfo group, a carboxyl group, a nitro group, a hydroxamic acid group, a sulfino group and a hydrazino group.

When R₁ is an alkyl group substituted by a group containing at least one heteroatom, the alkyl group is preferably an alkyl group having from 1 to 20 carbon atoms, more preferably from 1 to 12 carbon atoms, still more preferably from 1 to 8 carbon atoms, such as methyl, ethyl, iso-propyl, tert-butyl, n-octyl, n-decyl, n-hexadecyl, cyclopropyl, cyclopentyl and cyclohexyl.

When R₁ is an aryl group substituted by at least one group selected from the group consisting of an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, an alkoxycarbonyloxy group, an aryloxycarbonyloxy group, a sulfonylamino group, a sulfamoyl group, a carbamoyl group, an alkylthio group, an arylthio group, an amino group, a sulfonyl group, a sulfinyl group, a sulfonyloxy group, a ureido group, a silyl group, a mercapto group, a hydroxy group, a nitroso group, a sulfo group, a carboxyl group, a phosphoric acid ester group, a heterocyclic group and a halogenoalkyl group, specific examples of each substituent are described below.

Alkoxy Group:

An alkoxy group preferably having from 1 to 20 carbon atoms, more preferably from 1 to 12 carbon atoms, still more preferably from 1 to 8 carbon atoms, such as methoxy, ethoxy and butoxy.

Aryloxy Group:

An aryloxy group preferably having from 6 to 20 carbon atoms, more preferably from 6 to 16 carbon atoms, still more preferably from 6 to 12 carbon atoms, such as phenyloxy and 2-naphthyloxy.

Acyl Group:

An acyl group preferably having from 1 to 20 carbon atoms, more preferably from 1 to 16 carbon atoms, still more preferably from 1 to 12 carbon atoms, such as acetyl, benzoyl, formyl and pivaloyl.

Alkoxycarbonyl Group:

An alkoxycarbonyl group preferably having from 2 to 20 carbon atoms, more preferably from 2 to 16 carbon atoms, still more preferably from 2 to 12 carbon atoms, such as methoxycarbonyl and ethoxycarbonyl.

Aryloxycarbonyl Group:

An aryloxycarbonyl group preferably having from 7 to 20 carbon atoms, more preferably from 7 to 16 carbon atoms, still more preferably from 7 to 10 carbon atoms, such as phenyloxycarbonyl.

Acyloxy Group:

An acyloxy group preferably having from 2 to 20 carbon atoms, more preferably from 2 to 16 carbon atoms, still more preferably from 2 to 10 carbon atoms, such as acetoxy and benzoyloxy.

Acylamino Group:

An acylamino group preferably having from 2 to 20 carbon atoms, more preferably from 2 to 16 carbon atoms, still more preferably from 2 to 10 carbon atoms, such as acetylamino and benzoylamino.

Alkoxycarbonylamino Group:

An alkoxycarbonylamino group preferably having from 2 to 20 carbon atoms, more preferably from 2 to 16 carbon atoms, still more preferably from 2 to 12 carbon atoms, such as methoxycarbonylamino.

Aryloxycarbonylamino Group:

An aryloxycarbonylamino group preferably having from 7 to 20 carbon atoms, more preferably from 7 to 16 carbon atoms, still more preferably from 7 to 12 carbon atoms, such as phenyloxycarbonylamino.

Alkoxycarbonyloxy Group:

An alkoxycarbonyloxy group preferably having from 2 to 20 carbon atoms, more preferably from 2 to 16 carbon atoms, still more preferably from 2 to 12 carbon atoms, such as ethoxycarbonyloxy.

Aryloxycarbonyloxy Group:

An aryloxycarbonyloxy group preferably having from 7 to 20 carbon atoms, more preferably from 7 to 16 carbon atoms, still more preferably from 7 to 12 carbon atoms, such as phenyloxycarbonyloxy.

Sulfonylamino Group:

A sulfonylamino group preferably having from 1 to 20 carbon atoms, more preferably from 1 to 16 carbon atoms, still more preferably from 1 to 12 carbon atoms, such as methanesulfonylamino and benzenesulfonylamino.

Sulfamoyl Group:

A sulfamoyl group preferably having from 0 to 20 carbon atoms, more preferably from 0 to 16 carbon atoms, still more preferably from 0 to 12 carbon atoms, such as sulfamoyl, methylsulfamoyl, dimethylsulfamoyl and phenylsulfamoyl.

Carbamoyl Group:

A carbamoyl group preferably having from 1 to 20 carbon atoms, more preferably from 1 to 16 carbon atoms, still more preferably from 1 to 12 carbon atoms, such as carbamoyl, methylcarbamoyl, diethylcarbamoyl and phenylcarbamoyl.

Alkylthio Group:

An alkylthio group preferably having from 1 to 20 carbon atoms, more preferably from 1 to 16 carbon atoms, still more preferably from 1 to 12 carbon atoms, such as methylthio and ethylthio.

Arylthio Group:

An arylthio group preferably having from 6 to 20 carbon atoms, more preferably from 6 to 16 carbon atoms, still more preferably from 6 to 12 carbon atoms, such as phenylthio.

Amino Group:

An amino group preferably having from 0 to 20 carbon atoms, more preferably from 0 to 10 carbon atoms, still more preferably from 0 to 6 carbon atoms, such as amino, methylamino, dimethylamino, diethylamino and dibenzylamino.

Sulfonyl Group:

A sulfonyl group preferably having from 1 to 20 carbon atoms, more preferably from 1 to 16 carbon atoms, still more preferably from 1 to 12 carbon atoms, such as mesyl and tosyl.

Sulfinyl Group:

A sulfinyl group preferably having from 1 to 20 carbon atoms, more preferably from 1 to 16 carbon atoms, still more preferably from 1 to 12 carbon atoms, such as methanesulfinyl and benzenesulfinyl.

Sulfonyloxy Group:

A sulfonyloxy group preferably having from 1 to 20 carbon atoms, more preferably from 1 to 16 carbon atoms, still more preferably from 1 to 12 carbon atoms, such as mesyloxy and tosyloxy.

Ureido Group:

A ureido group preferably having from 1 to 20 carbon atoms, more preferably from 1 to 16 carbon atoms, still more preferably from 1 to 12 carbon atoms, such as ureido, methylureido and phenylureido.

Silyl Group:

A silyl group preferably having from 1 to 20 carbon atoms, more preferably from 1 to 16 carbon atoms, still more preferably from 1 to 12 carbon atoms, such as trimethylsilyl.

Phosphoric Acid Ester Group:

A phosphoric acid ester group preferably having from 1 to 20 carbon atoms, more preferably from 1 to 16 carbon atoms, still more preferably from 1 to 12 carbon atoms, such as diethylphosphoric acid ester and phenylphosphoric acid ester.

Heterocyclic Group:

For example, imidazolyl, pyridyl, furyl, piperidyl and morpholino.

Halogenoalkyl Group:

For example, chloromethyl, dibromomethyl and trifluoromethyl.

When R₁ is an aryl group substituted by the above-described substituent, the aryl group is preferably an aryl group having from 6 to 30 carbon atoms, more preferably from 6 to 20 carbon atoms, still more preferably from 6 to 12 carbon atoms, such as phenyl, p-methylphenyl and naphthyl.

When R₁ is an aryl group substituted by the above-described substituent, R₁ is preferably an aryl group substituted by at least one group selected from the group consisting of an alkoxy group, an aryloxy group, an acyl group, an acylamino group and a sulfonyl group.

When R₁ is a heterocyclic group, preferred examples of the heterocyclic group include imidazolyl, pyridyl, furyl, piperidyl and morpholino.

In formula (I), L represents a linking group. The linking group is preferably an alkylene group, an arylene group or a heterocyclic group, more preferably an arylene group, still more preferably orthophenylene.

m represents an integer of 0 to 5 and m is preferably 0 or 1, more preferably 0.

n represents an integer of 1 to 3 and n is preferably 1.

However, in formula (I), when m is 0 or when m is 1 and R₁ is —OH, L represents a linking group substituted by from 1 to 3 groups selected from the group consisting of a halogen atom, an acyloxy group, an acylamino group, an alkoxycarbonyl group, an aryloxycarbonyl group, a formyl group, an aryloxycarbonylamino group, an alkoxycarbonyloxy group, an aryloxycarbonyloxy group, a sulfonylamino group, a sulfamoyl group, a carbamoyl group, an amino group, a sulfonyl group, a sulfinyl group, a sulfonyloxy group, a ureido group, a silyl group, a mercapto group, a hydroxy group, a nitroso group, a sulfo group, a phosphoric acid ester group and a heterocyclic group.

Specific examples of each substituent are the same as specific examples of substituents when R₁ is an aryl group.

When m and n each is 1, L is preferably an orthophenylene group or an alkylene group having from 6 to 20 carbon atoms.

When m is 0 and n is 1, L is preferably a phenyl group substituted by from 1 to 3 groups selected from the group consisting of a halogen atom, an acyloxy group, an aryloxy group, a carbonylamino group, an aryloxycarbonyloxy group and a sulfonyloxy group, more preferably a phenyl group substituted by a halogen atom or a sulfonyloxy group.

Although L in formula (I) is a monovalent group when m is 0 and n is 1, L is referred to as a linking group in the present invention including such a case.

When R₁ is —OM₂, L is preferably an alkylene group, a phenylene group or a hetero group.

Specific examples of the compound represented by formula (I) are set forth below, however, the present invention is not limited thereto.

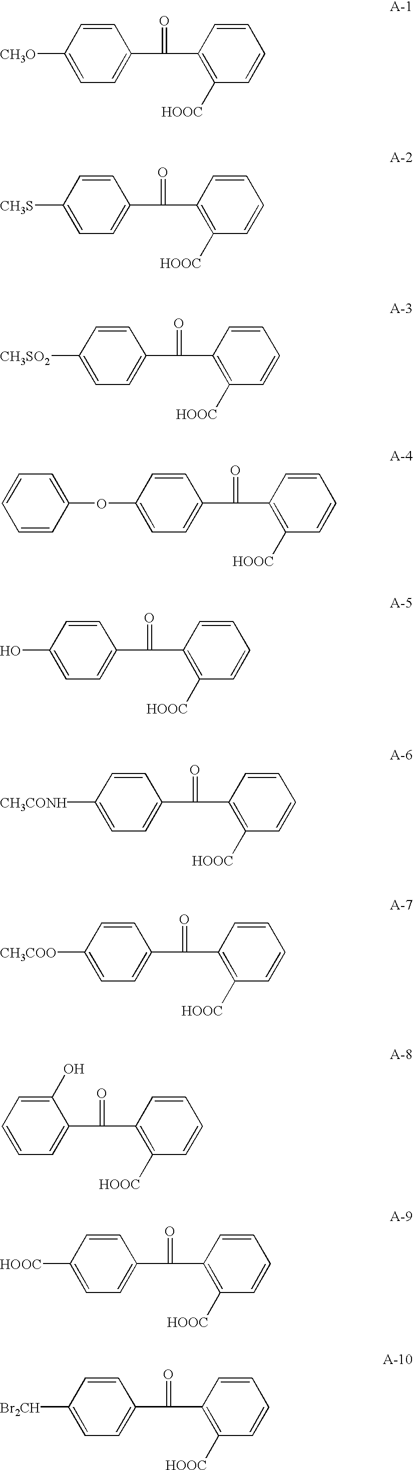

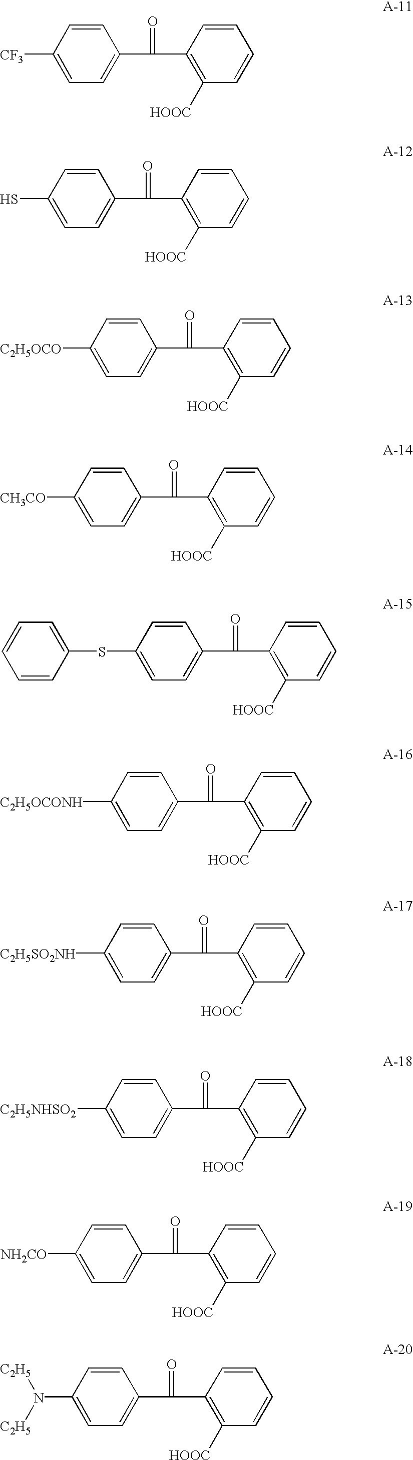

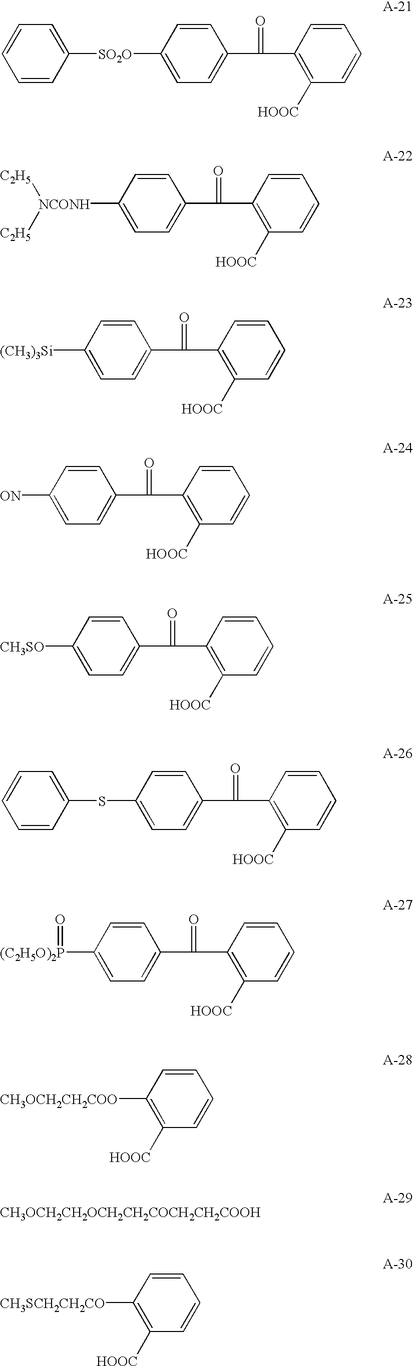

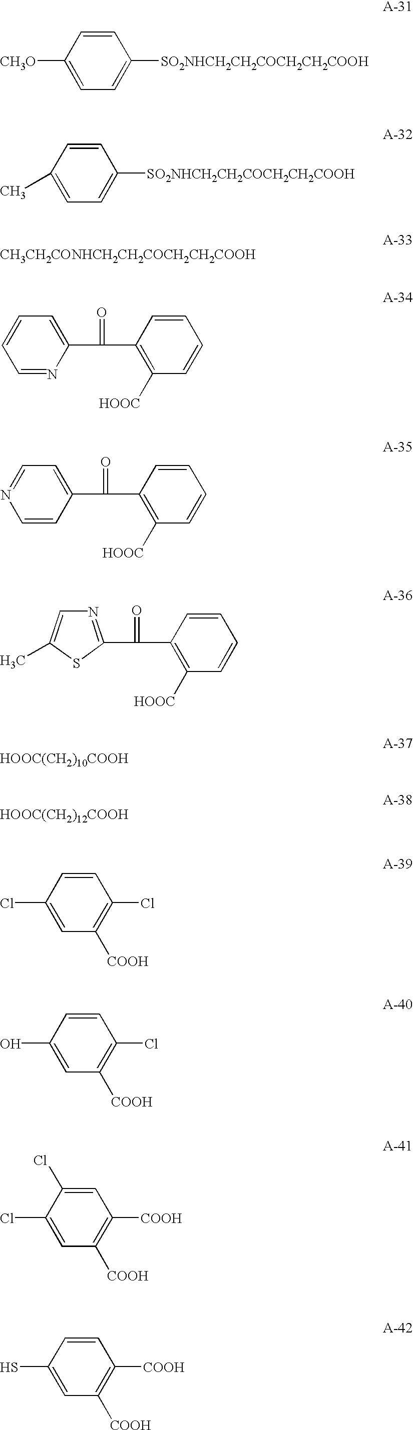

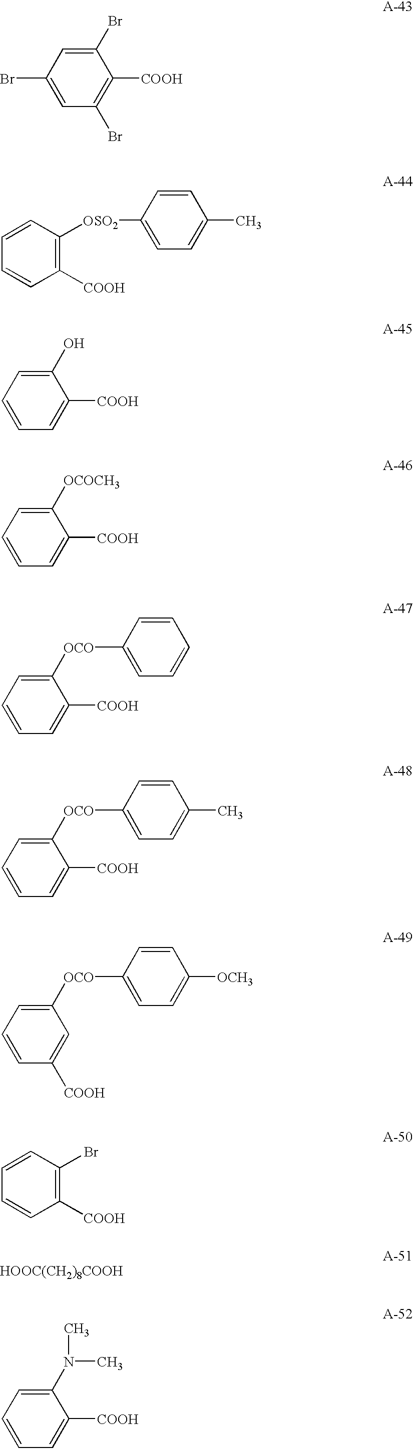

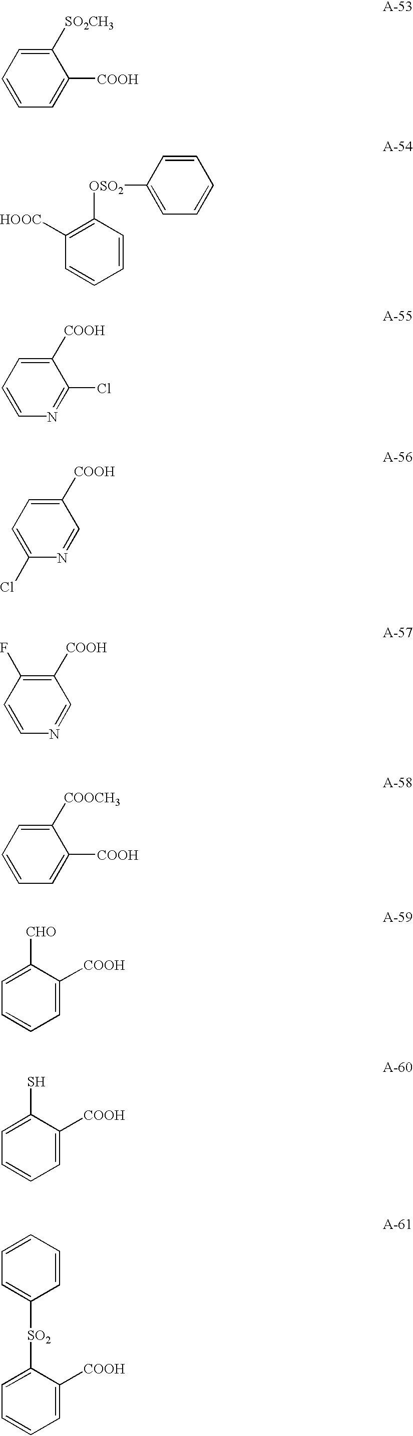

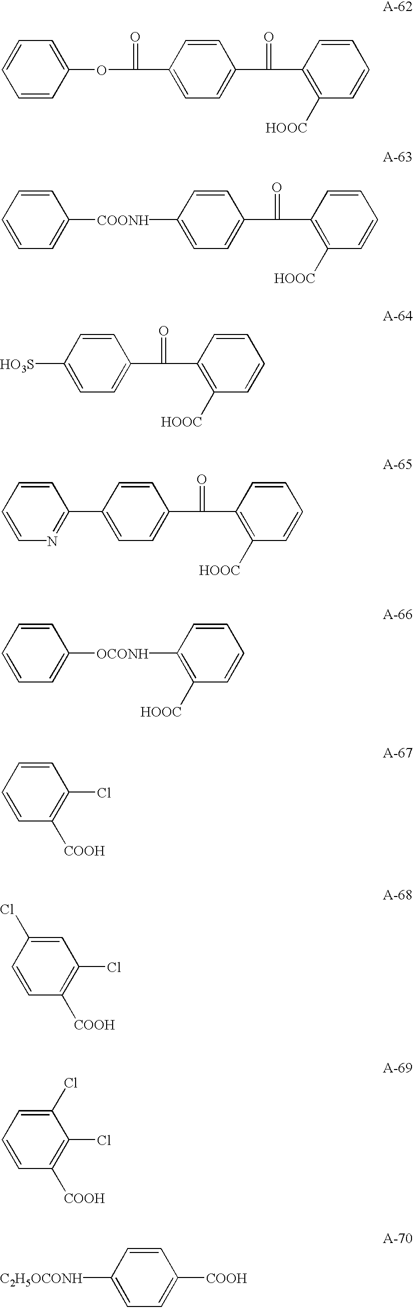

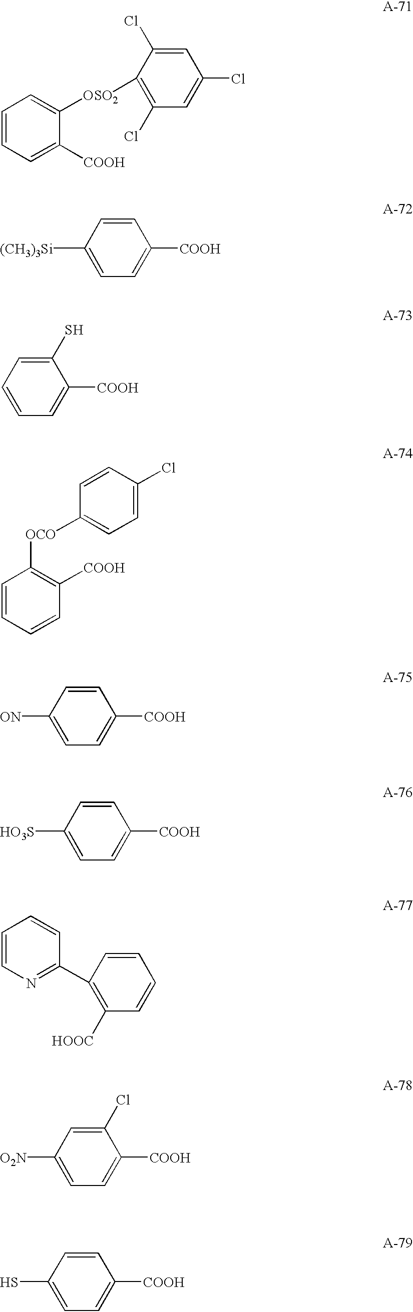

The compound represented by formula (I) for use in the present invention may be a commercially available compound or may be synthesized according to the method described, for example, in Chem. Pham. Bulletin, 31(8), 2632 (1983), J. Chem. Soc., Section B Physical Organic Chemistry, Part 1, pp. 145-148 (1971), J. Amer. Chem. Soc., 77, 1909 (1955), Org. Prep. Proced. Int., 28(5), 609 (1996), Chem. Ber., 44, 1236 (1911), J. Amer. Chem. Soc., 60, 2502 (1938), Bull. Soc. Khim. Fr., 25(3), 173 (1901), Chem. Abstr., 9861 (1960), DE 297018, and Justus Liebigs Ann. Chem., 300 299 (1898).

By incorporating the compound represented by formula (I) into the photosensitive material of the present invention, particularly to the photosensitive layer, the storage stability of silver image after heat development is improved.

The content of the compound represented by formula (I) is not particularly limited, however, the content is preferably from 10⁻⁴ to 1 mol/mol-Ag, more preferably from 10⁻³ to 0.3 mol/mol-Ag, based on Ag contained in the photosensitive material of the present invention.

If the content of the compound is small, the color tone of silver image is readily changed with the passage of time, whereas if the content is excessive, the sensitivity decreases.

The compound represented by formula (I) can be incorporated into either a photosensitive layer or a non-photosensitive layer but is preferably incorporated into a photosensitive layer.

A representative embodiment is a heat-developable photosensitive material comprising a support having thereon at least one photosensitive layer and a layer adjacent thereto, wherein the photosensitive layer contains a photosensitive silver halide, an organic silver salt and a binder and further contains at least one compound represented by formula (I).

The compound represented by formula (I) for use in the present invention is preferably added after dissolving it in an organic solvent.

The sulfonium salt which can be used in the heat-developable photosensitive material according to the third embodiment of the present invention is described below. When a sulfonium salt is used in the heat-developable photosensitive material of the present invention, particularly in the photosensitive layer thereof, increase of fog in aging during storage of a stock photosensitive material is reduced.

The sulfonium salt for use in the present invention is preferably a compound represented by the following formula (S):

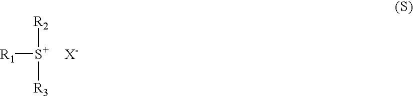

wherein R₁, R₂ and R₃ each independently represents an aliphatic or aromatic group which may contain a heteroatom, any two of R₁ to R₃ may combine with each other to form a ring or may be bonded to one or more other sulfonium salt group, and X⁻ represents a counter anion.

Examples of the aliphatic group represented by R₁, R² and R₃ include a branched or linear alkyl group having from 1 to 10 carbon atoms (e.g., methyl, ethyl, propyl, butyl, pentyl, iso-pentyl, 2-ethylhexyl, octyl, decyl), an alkenyl group having from 3 to 10 carbon atoms (e.g., 2-propenyl, 3-butenyl, 1-methyl-3-propenyl, 3-pentenyl, 1-methyl-3-butenyl, 4-hexenyl) and an aralkyl group having from 7 to 10 carbon atoms (e.g., benzyl, phenethyl).

The aromatic group represented by R₁, R₂ and R₃ is preferably an aryl group such as phenyl group and naphthyl group, or an aromatic heterocyclic group such as thienyl group, furanyl group and pyrazolyl group. If desired, this aromatic group may have, as a substituent, an alkyl group having 5 or less carbon atoms (e.g., methyl), an alkoxyl group having 5 or less carbon atoms (e.g., methoxy), a halogen atom (e.g., chlorine, bromine, iodine, fluorine), a carboxy group having 5 or less carbon atoms, a cyano group, a nitro group or a combination of any two or more thereof.

For the counter anion represented by X⁻, a halide anion, HSO₄⁻, a halogen-containing complex anion, an inorganic anion such as tetrafluoroborate, hexafluoro-phosphate or hexafluoroarsenate, an organic anion represented by R¹CO₂⁻ or R¹SO₃⁻ (wherein R¹ represents an alkyl group or an aryl group and may have a substituent), or the like is used.

In the present invention, a sulfonium salt where R¹, R² and R³ each is an aromatic group is preferred, and a triarylsulfonium salt where R¹, R² and R³ each is a phenyl group is more preferred. Here, this phenyl group may have a substituent or may be unsubstituted.

Specific examples of the compound represented by formula (S) for use in the present invention are set forth below, however, the present invention is not limited thereto.

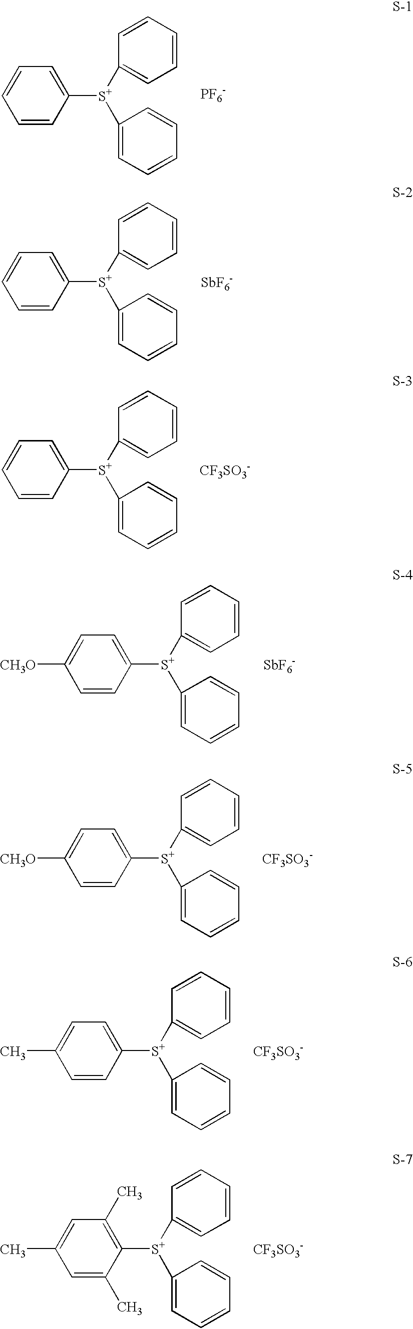

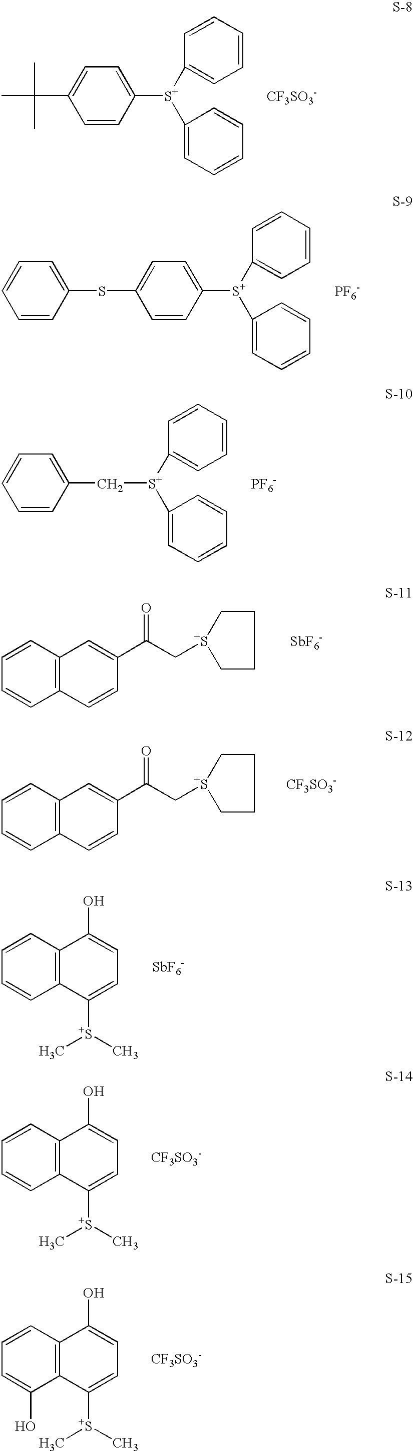

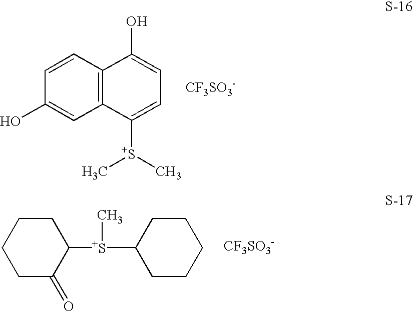

The content of the sulfonium salt contained in the heat-developable photosensitive material of the present invention is preferably from 0.001 to 1.0 mol, more preferably from 0.01 to 0.1 mol, per mol of silver.

The phthalazines and phthalazinones for use in the heat-developable photosensitive material according to the fourth embodiment of the present invention are described below.

The phthalazines and phthalazinones preferably have a substituent such as alkyl group, aryl group or halogen and are reduced in the solubility in water, because these are not volatilized and act effectively at heat development. The phthalazines and phthalazinones more preferably have, as a substituent, an alkyl group having from 3 to 12 carbon atoms. It is sufficient if a phthalazine or a phthalazinone is contained on the support surface in the side having a photosensitive layer (containing a photosensitive silver halide; also called an image-forming layer) of the heat-developable photosensitive material, and may be added to either a photosensitive layer or a non-photosensitive layer such as protective layer. The phthalazine or phthalazinone is suitably added, as an amount added per mol of silver, in an amount of 10⁻⁴ to 1 mol/Ag, preferably from 10⁻³ to 0.3 mol/Ag, more preferably from 10⁻³ to 0.1 mol/Ag. The phthalazines and phthalazinones may be used individually or in combination of two or more thereof. Specific preferred examples of the phthalazines and phthalazinones for use in the present invention are set forth below, however, the present invention is not limited thereto.

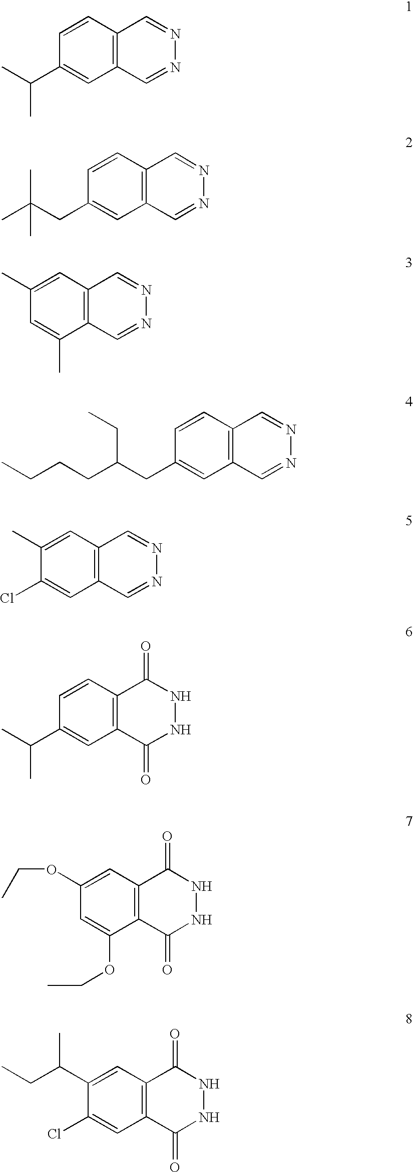

From the standpoint of achieving the object of the present invention, the heat-developable photosensitive material of the present invention preferably contains at least one hydrazine derivative represented by formula (H-1), (H-2), (H-3), (H-4), (H-5) or (A).

The compound represented by formula (H-1) for use in the present invention is described below.

R₁₁ represents an alkyl group, an aryl group or a heterocyclic group. Specific examples of the alkyl group include a methyl group, an ethyl group, a tert-butyl group, a 2-octyl group, a cyclohexyl group, a benzyl group, a diphenylmethyl group and triphenylmethyl group. Specific examples of the aryl group include phenyl, p-methylphenyl and naphthyl. Specific examples of the heterocyclic group include a triazole residue, an imidazole residue, a pyridine residue, a pyrimidine residue, an indole residue, a benzothiazole residue, a benzimidazole residue, a furan residue, a thiophene residue, a piperidino group, a pyrrolidino group and a morpholino group.

R₁₂ represents a heterocyclic group, an alkenyl group or an amino group. Specific examples of the heterocyclic group include a triazole residue, an imidazole residue, a pyridine residue, a pyrimidine residue, an indole residue, a benzothiazole residue, a benzimidazole residue, a furan residue, a thiophene residue, a piperidino group, a pyrrolidino group and a morpholino group. Specific examples of the alkenyl group include an ethenyl group and a propenyl group. Specific examples of the amino group include a dimethylamino group, a diethylamino group and an ethylmethylamino group.

X represents an oxygen atom or a sulfur atom. A₁ and A₂ both represents a hydrogen atom, or one of A₁ and A₂ represents a hydrogen atom and the other represents an acyl group (e.g., acetyl, trifluoroacetyl, benzoyl), a sulfonyl group (e.g., methanesulfonyl, toluenesulfonyl) or an oxalyl group (e.g., ethoxalyl).

The compound represented by formula (H-2) is described below.

R₂₁ represents a substituted or unsubstituted alkyl, aryl or heteroaryl group. Specific examples of the alkyl group include a methyl group, an ethyl group, a tert-butyl group, a 2-octyl group, a cyclohexyl group, a benzyl group and a diphenylmethyl group. R₂₁ is preferably an aryl group or a heteroaryl group, more preferably a substituted or unsubstituted phenyl group.

R₂₂ represents a hydrogen atom, an alkylamino group, an arylamino group or a heterocyclic amino group. Specific examples of the alkylamino group include a methylamino group, an ethylamino group, a propylamino group, a butylamino group, a dimethylamino group, a diethylamino group and an ethylmethylamino group. Specific examples of the arylamino group include an anilino group. Specific examples of the heterocyclic amino group include a thiazolylamino group, a benzimidazolylamino group and a benzothiazolylamino group. R₂₂ is preferably a dimethylamino group or a diethylamino group.

A₁ and A₂ are the same as A₁ and A₂ in formula (H-1)

The compound represented by formula (H-3) is described below.

R₃₁ and R₃₂ each represents an alkyl group (having the same meaning as the alkyl group represented by R₁₂), an alkenyl group (having the same meaning as the alkenyl group represented by R₁₂), an aryl group (having the same meaning as the aryl group represented by R₁₂), a heteroaryl group, an alkoxy group, an alkenyloxy group (the alkenyl here has the same meaning as the alkenyl group represented by R₁₂), an aryloxy group, a heterocyclic oxy group (the heterocyclic group here has the same meaning as the heterocyclic group described above as a substituent of R₁₁), an alkylthio group (the alkyl group here has the same meaning as the alkyl group described above as a substituent of R₁₁), an alkenylthio group (the alkenyl group here has the same meaning as the alkenyl group described above as a substituent of R₁₂), an arylthio group (the aryl group here has the same meaning as the aryl group described above as a substituent of R₁₁) or a heterocyclic thio group (the heterocyclic group here has the same meaning as the heterocyclic group described above as a substituent of R₁₁). R₃₁ and R₃₂ each is preferably an aryl group or an alkoxy group. More preferably, at least one of R₃₁ and R₃₂ is a tert-butoxy group. In another preferred structure, R₃₁ is a substituted or unsubstituted phenyl group and R₃₂ is a tert-butoxy group.

G₃₁ and G₃₂ represents a —(CO)ₚ— group, a —C(═S)— group, a sulfonyl group, a sulfoxy group, a —P(═O)R₃₃— group or an iminomethylene group, p represents an integer of 1 or 2, and R₃₃ represents an alkyl group (the alkyl group here has the same meaning as the alkyl group described above as a substituent of R₁₁), an alkenyl group (the alkenyl group here has the same meaning as the alkenyl group described above as a substituent of R₁₂), an alkynyl group, an aryl group (the aryl group here has the same meaning as the aryl group described above as a substituent of R₁₁), an alkoxy group, an alkenyloxy group (the alkenyl group here has the same meaning as the alkenyl group described above as a substituent of R₁₂), an alkynyloxy group, an aryloxy group or an amino group (having the same meaning as the amino group described above as a substituent of R₁₂). However, when G₃₁ is a sulfonyl group, G₃₂ is not a carbonyl group. G₃₁ and G₃₂ each is preferably a —CO— group, a —COCO— group, a sulfonyl group or a —CS— group, more preferably both are a —CO— group or a sulfonyl group.

A₁ and A₂ are the same as A₁ and A₂ in formula (H-1).

The compound represented by formula (H-4) is described below.

R₄₁ represents a hydrogen atom or a monovalent substituent, preferably an alkyl group, an aryl group, a heteroaryl group, an alkoxy group or an amino group, more preferably an aryl group or a heteroaryl group.

A₁ and A₂ are the same as A₁ and A₂ in formula (H-1).

The compound represented by formula (H-5) is described below.

R₅₁, R₅₂ and R₅₃ each independently represents a substituted or unsubstituted aryl group (the aryl group here has the same meaning as the aryl group described above as a substituent of R₁₁) or a heteroaryl group. Preferably, R₅₁, R₅₂ and R₅₃ all are a substituted or unsubstituted phenyl group, and more preferably, R₅₁, R₅₂ and R₅₃ all are an unsubstituted phenyl group.

R₅₄ and R₅₅ each represents an unsubstituted or substituted alkyl group. Specific examples thereof include a methyl group, an ethyl group, a tert-butyl group, a 2-octyl group, a cyclohexyl group, a benzyl group and a diphenylmethyl group. R₅₄ and R₅₅ both are preferably an ethyl group.

A₁ and A₂ are the same as A₁ and A₂ in formula (H-1).

Specific examples of the compounds represented by formulae (H-1) to (H-5) for use in the present invention are set forth below, however, the present invention is not limited thereto.

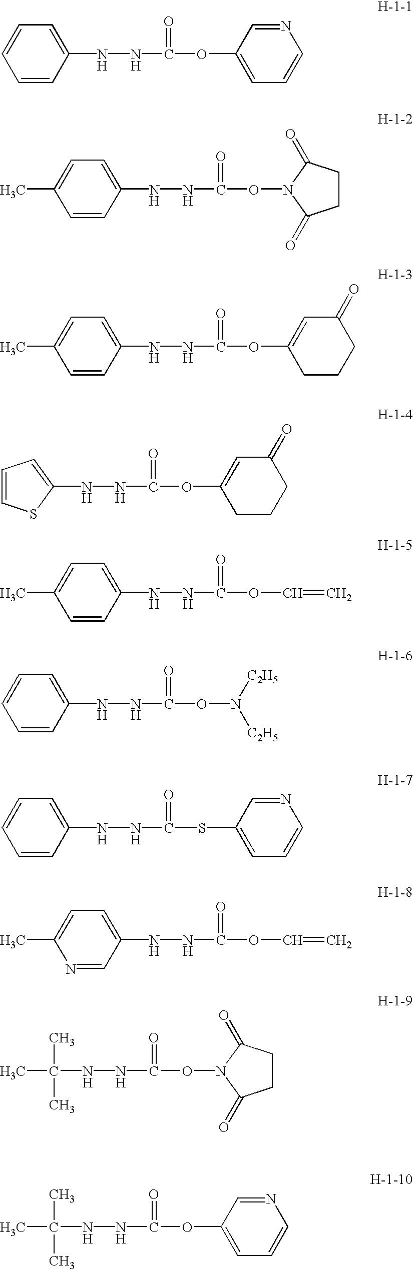

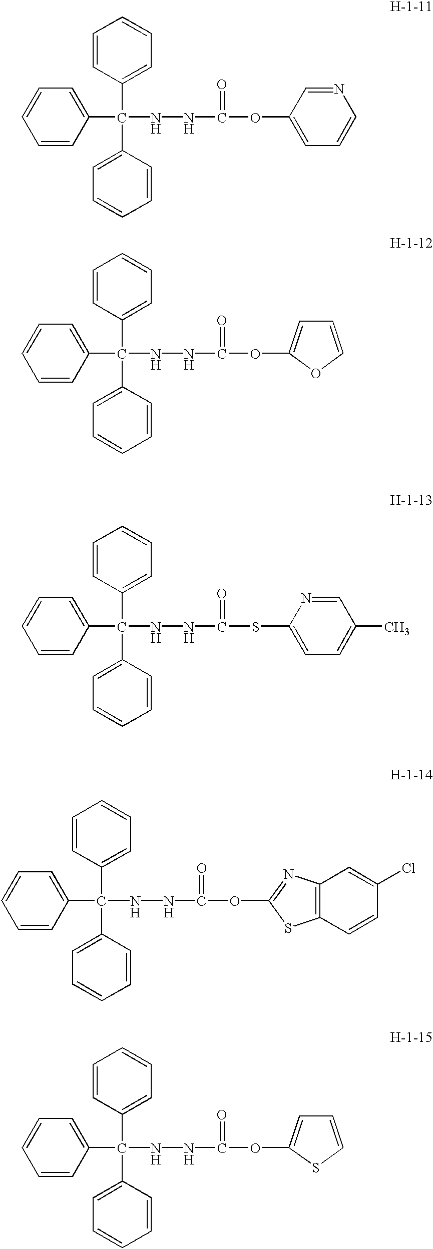

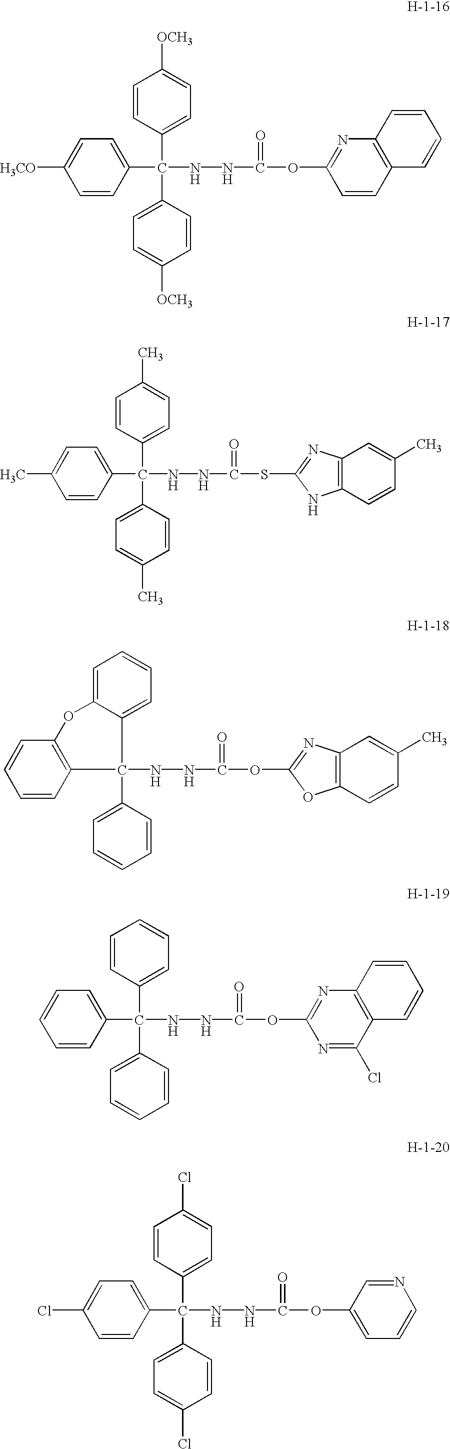

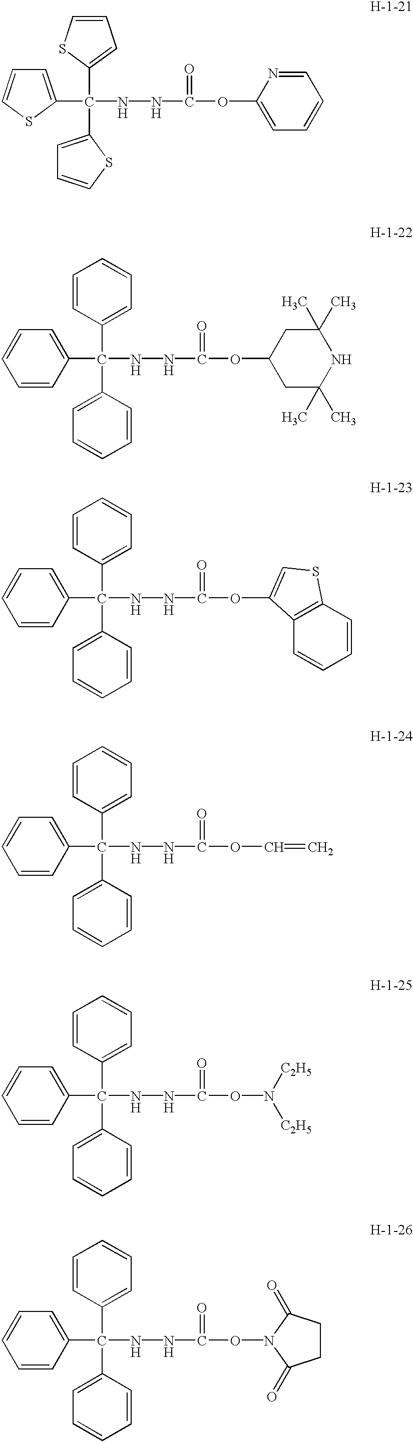

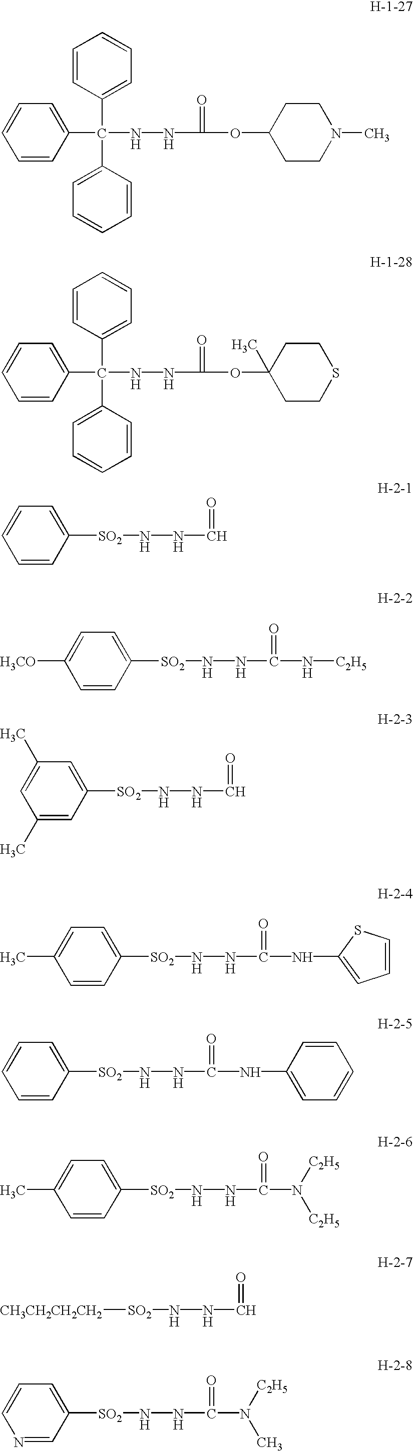

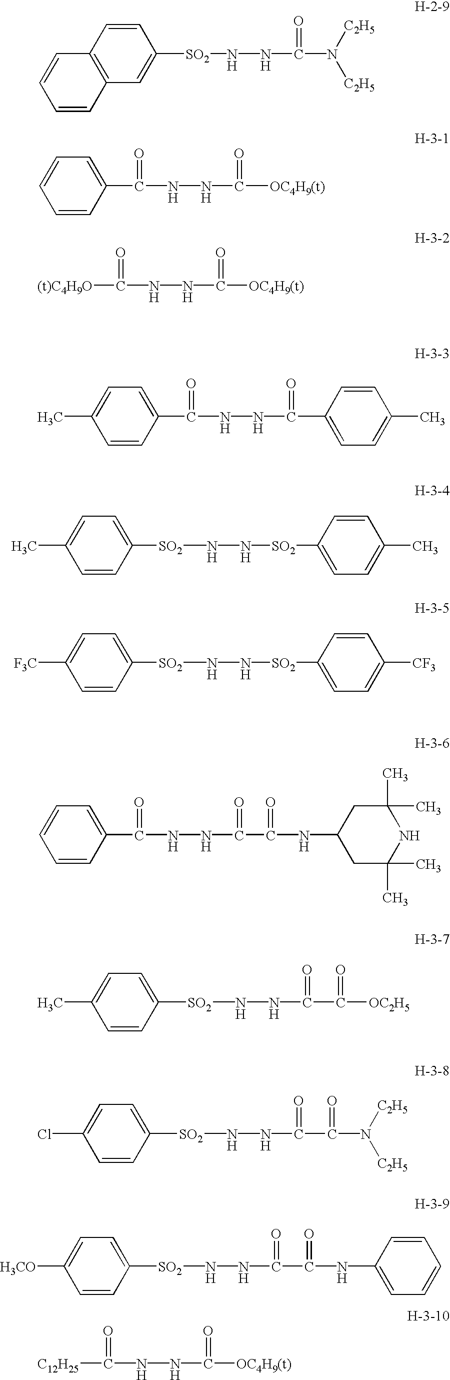

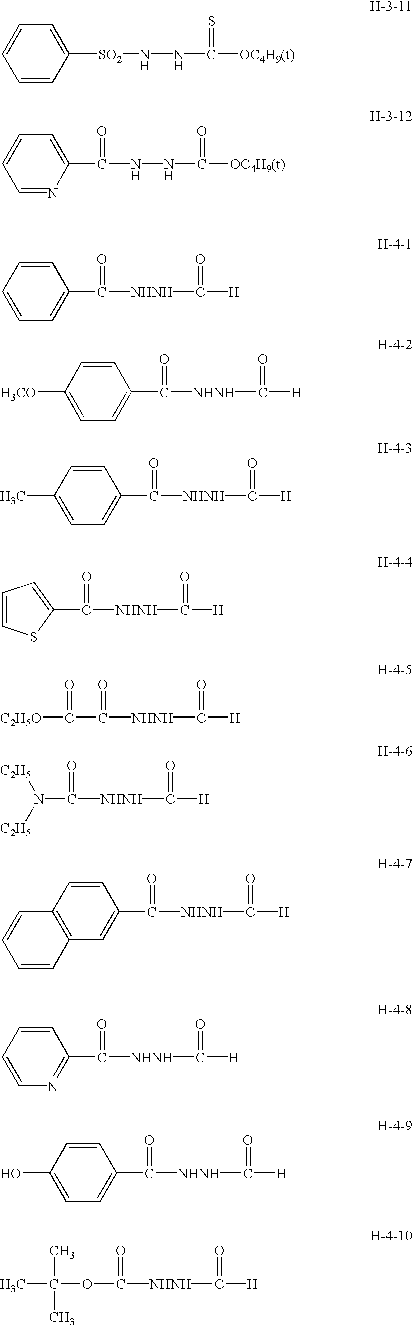

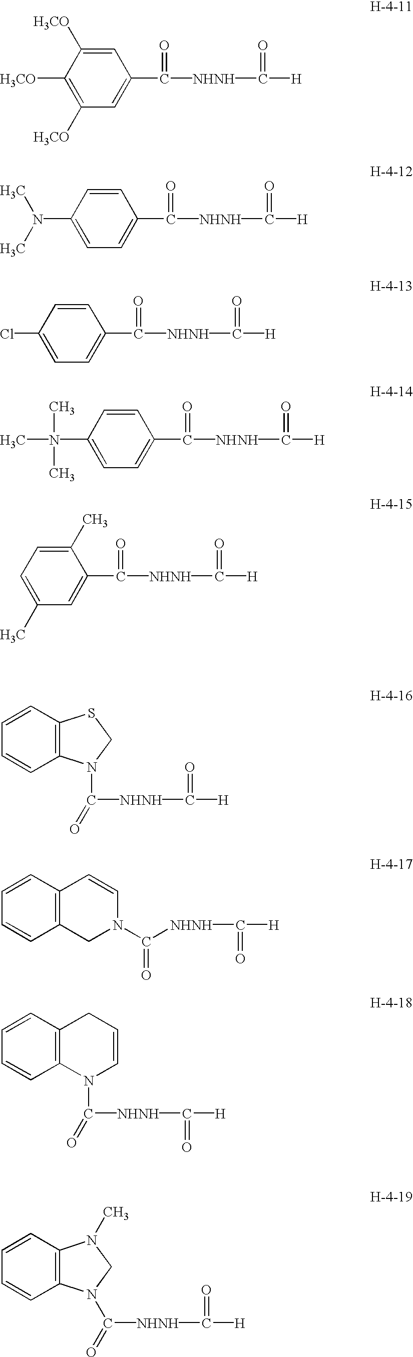

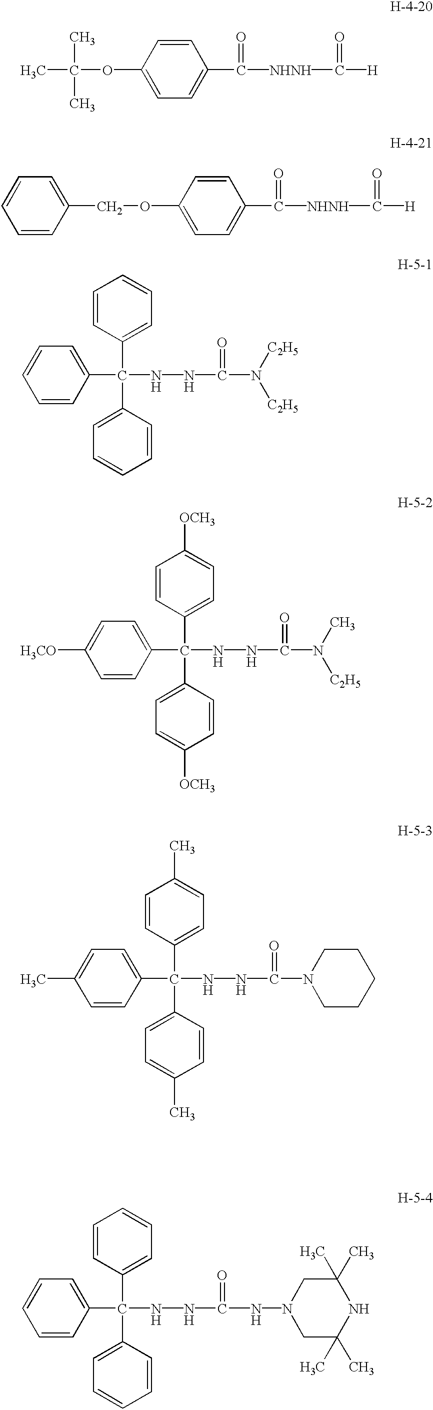

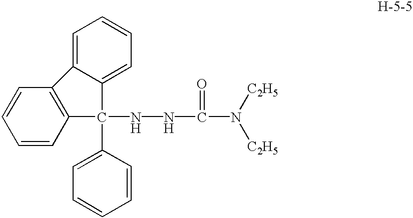

The compound represented by formula (A) is described in detail below.

In formula (A), Q¹ represents an aryl group or a heterocyclic group, preferably an aryl group having from 6 to 40 carbon atoms or a heterocyclic group having from 2 to 40 carbon atoms. Examples of the aryl group represented by Q¹ include a phenyl group and a naphthyl group. These groups each may have a substituent. The substituent may be any group as long as it can be substituted to the benzene ring and examples thereof include a halogen atom, an alkyl group, an aryl group, a heterocyclic group, a hydroxy group, an alkoxy group, an aryloxy group, an acyloxy group, an alkylthio group, an arylthio group, an amino group, an acylamino group, a sulfonamido group, a ureido group, a urethane group, an acyl group, an alkoxycarbonyl group, a carbamoyl group, a sulfamoyl group, a sulfonyl group, a sulfoxide group, a cyano group, a nitro group, a sulfo group and a carboxy group.

When the group represented by Q¹ is an aryl group, the aryl group is preferably an aryl group substituted by an electron-withdrawing group. At least one electron-withdrawing group is preferably a halogen atom, a heterocyclic group, an acyl group, an alkoxycarbonyl group, a carbamoyl group, a sulfamoyl group, a sulfonyl group, a sulfoxide group, a cyano group, a nitro group, a fluoroalkyl group such as trifluoromethyl group, a trifluoroaryl group such as pentafluorophenyl group, or an electron-withdrawing group equal to or higher than these electron-withdrawing groups. Among these, preferred are strong electron-withdrawing groups such as alkoxycarbonyl group, carbamoyl group, sulfamoyl group, sulfonyl group, cyano group and trifluoromethyl group, more preferred are an alkoxycarbonyl group, a sulfonyl group, a cyano group and a trifluoromethyl group. The number of substituents of the aryl group represented by Q¹ is from 0 to 5 and at least one substituent is preferably a strong electron-withdrawing group described above, more preferably further substituted by any one of the above-described electron-withdrawing groups.

When Q¹ is a heterocyclic group, preferred examples of the heterocyclic group include a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring and a thiophene ring. These heterocyclic rings may be a monocyclic ring or a condensed ring formed by the condensation with each other.

The heterocyclic ring may have a substituent and when two or more substituents are present, these substituents may be the same or different. Examples of the substituent include a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. These substituents each may further have a substituent, if possible, and preferred examples of the substituent include a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

The group represented by R¹ is preferably an alkyl group having from 1 to 40 carbon atoms, an alkenyl group having from 2 to 40 carbon atoms, a cycloalkyl group having from 3 to 40 carbon atoms, an aryl group having from 6 to 40 carbon atoms or a heterocyclic group having from 2 to 40 carbon atoms. These groups each may further have a substituent.

When R¹ is an alkyl group, the alkyl group is preferably a primary alkyl group having from 4 to 30 carbon atoms, a secondary alkyl group having from 3 to 30 carbon atoms or a tertiary alkyl group having from 4 to 30 carbon atoms, more preferably a primary alkyl group having from 6 to 18 carbon atoms, a secondary alkyl group having from 3 to 18 carbon atoms or a tertiary alkyl group having from 4 to 18 carbon atoms. Among these, a secondary or tertiary alkyl group is more preferred, and a tertiary alkyl group is particularly preferred. Specific examples of the alkyl group include a methyl group, a propyl group, a n-butyl group, a n-hexyl group, a n-octyl group, a n-dodecyl group, a n-hexadecyl group, a neopentyl group, a 2-ethylhexyl group, a 2-octyloctyl group, an isopropyl group, a 1-hexylhexyl group, a tert-butyl group, a 1,1,3,3-tetramethyloctyl group, a 1,1-dimethylhexyl group, a 1,1-dimethyldecyl group, a benzyl group, a phenethyl group, a phenoxyethyl group and a 2,4-di-tert-amylphenoxypropyl group.

When R¹ is an alkenyl group, the alkenyl group is preferably an alkenyl group having from 2 to 20 carbon atoms and examples thereof include a vinyl group, an allyl group and an oleyl group. When R¹ is a cycloalkyl group, the cycloalkyl group is preferably a cycloalkyl group having from 3 to 20 carbon atoms and examples thereof include a cyclopropyl group, a 1-ethylcyclopropyl group, a cyclopentyl group, a cyclohexyl group, a 1-methylcyclohexyl group, a 2,2,2-bicyclooctyl group, a norbornyl group and an adamantyl group.

When R¹ is an aryl group, examples of the aryl group include a phenyl group and a naphthyl group. These groups each may have a substituent. The substituent may be any group as long as it can be substituted to the benzene ring and examples thereof include a halogen atom, an alkyl group, an aryl group, a heterocyclic group, a hydroxy group, an alkoxy group, an aryloxy group, an acyloxy group, an alkylthio group, an arylthio group, an amino group, an acylamino group, a sulfonamido group, a ureido group, a urethane group, an acyl group, an alkoxycarbonyl group, a carbamoyl group, a sulfamoyl group, a sulfonyl group, a sulfoxide group, a cyano group, a nitro group, a sulfo group and a carboxy group.

When R¹ is a heterocyclic group, examples of the heterocyclic group include a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring and a thiophene ring. A condensed ring formed by the condensation of these groups with each other is also preferred.

The heterocyclic group may have a substituent and when two or more substituents are present, these substituents may be the same or different. Examples of the substituent include a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. These substituents each may further have a substituent, if possible, and preferred examples of the substituent include a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

Among the compounds represented by formula (A), preferred are those where Q¹ is a 5- or 6-membered unsaturated ring, more preferred are those where Q¹ is a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isoxazole ring or a ring formed by the condensation of such a ring with a benzene ring or an unsaturated heterocyclic ring, still more preferred are those where Q¹ is a quinazoline ring.

Q¹ preferably has at least one electron-withdrawing substituent. Preferred examples of the substituent include a fluoroalkyl group (e.g., trifluoromethyl, pentafluoro-ethyl, 1,1-difluoroethyl, difluoromethyl, fluoromethyl, heptafluoropropyl, pentafluorophenyl), a cyano group, a halogen atom (e.g., fluoro, chloro, bromo, iodo), an acyl group, an alkoxycarbonyl group, a carbamoyl group, an alkylsulfonyl group and an arylsulfonyl group. Among these, a trifluoromethyl group is more preferred.

Specific examples of the compound represented by formula (A) for use in the present invention are set forth below, however, the compound for use in the present invention is not limited to these specific examples.

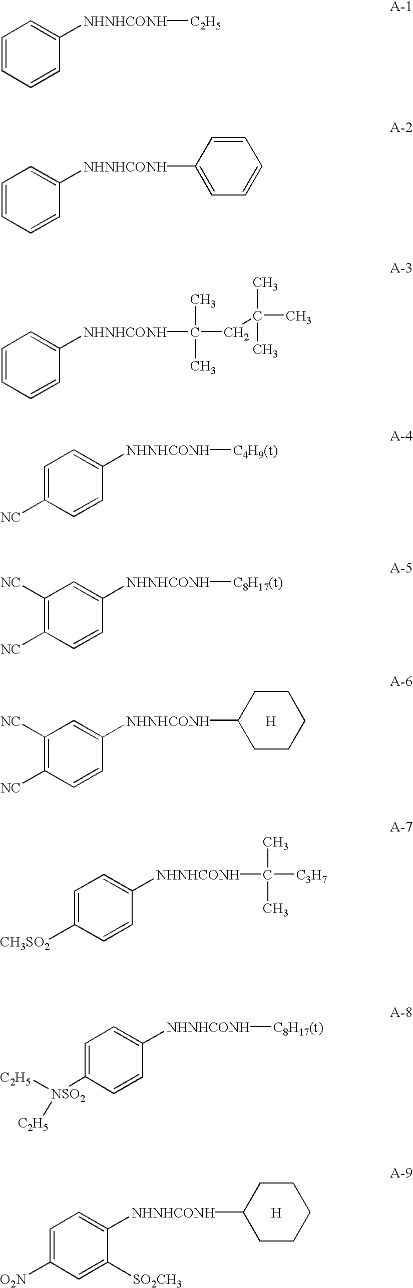

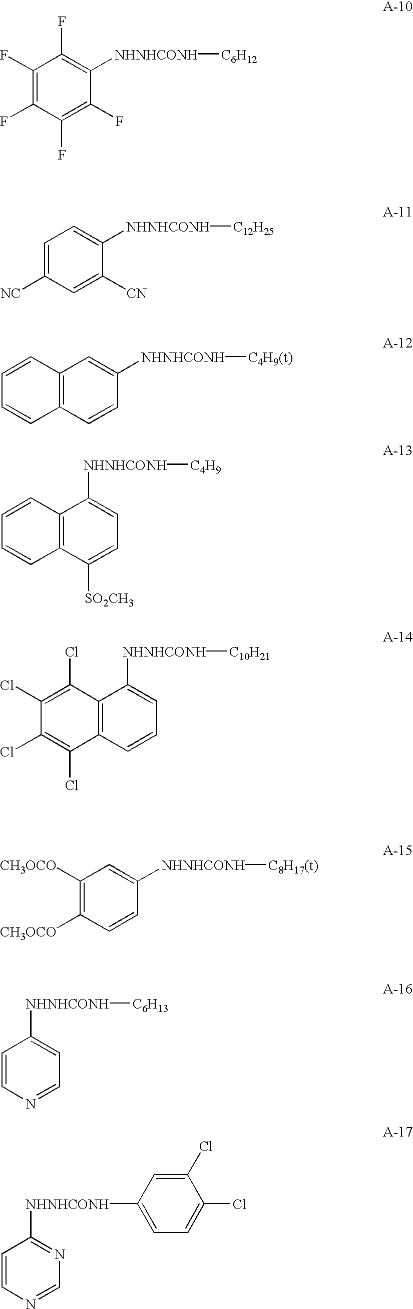

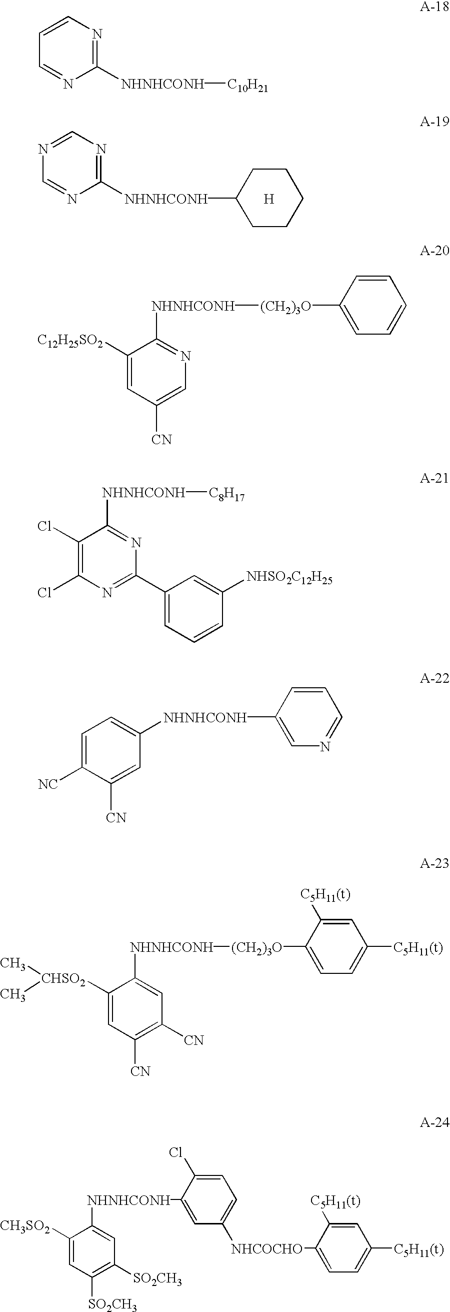

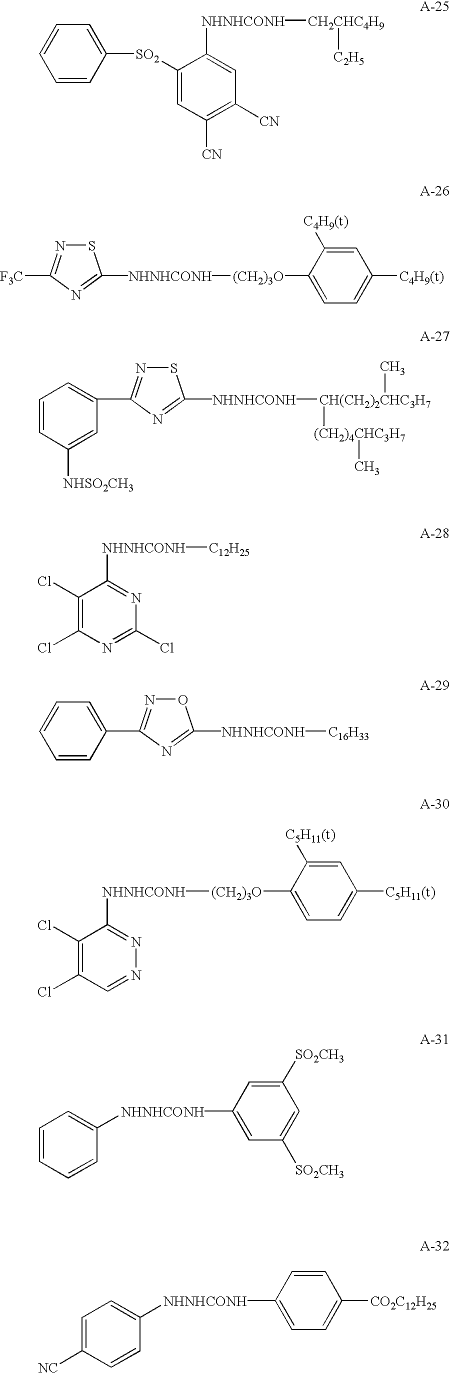

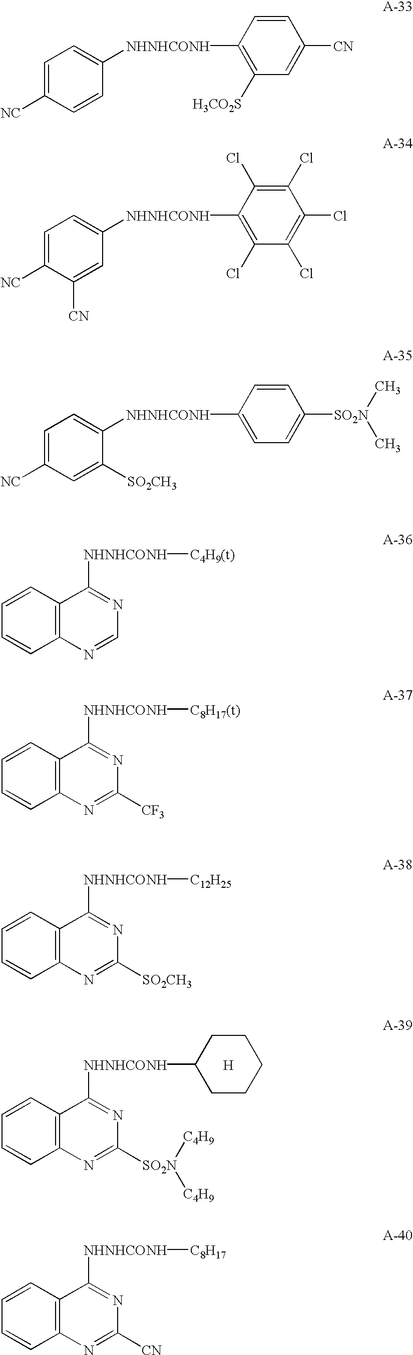

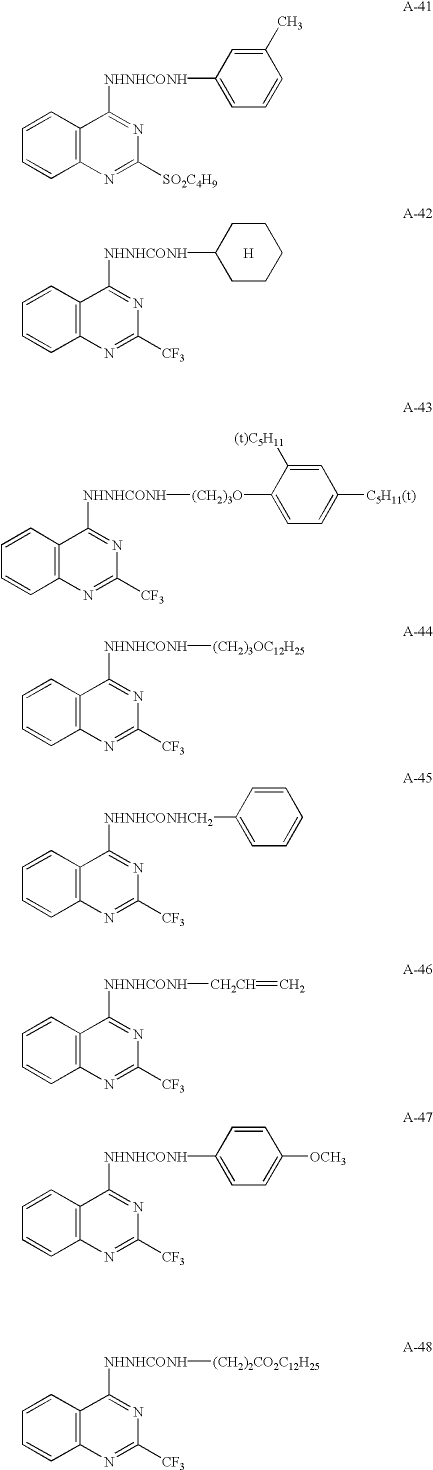

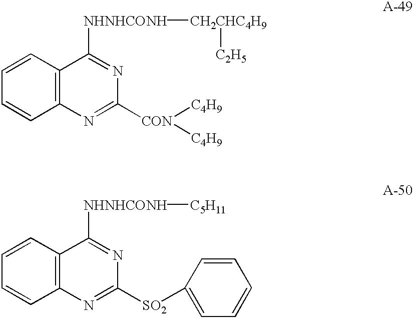

The layer to which the hydrazine derivative is added may be any layer as long as it is on the support surface in the side having the photosensitive layer but is preferably the photosensitive layer and/or a layer adjacent to the photosensitive layer. The optimal amount of the hydrazine derivative added varies depending on the grain size of silver halide grain, the halogen composition, the degree of chemical sensitization, the kind of inhibitor, and the like and cannot be indiscriminately specified, however, the amount added is approximately from 10⁻⁴ to 10 mol, preferably from 10⁻³ to 1 mol, per mol of silver halide. The hydrazine derivative for use in the present invention can be used by dissolving it in an appropriate organic solvent such as alcohols (e.g., methanol, ethanol, propanol, fluorinated alcohol), ketones (e.g., acetone, methyl ethyl ketone), dimethylformamide, dimethylsulfoxide and methyl cellosolve. This hydrazine derivative may also be used as an emulsification dispersion product obtained by a well-known emulsification dispersion method of dissolving the compound using an oil such as dibutyl phthalate, tricresyl phosphate, glyceryl triacetate or diethyl phthalate, and an auxiliary solvent such as ethyl acetate or cyclohexanone, and mechanically emulsification-dispersing the resulting solution. Furthermore, the hydrazine derivative may be used by dispersing the powder of the hydrazine derivative in water using a ball mill, a colloid mill or an ultrasonic wave according to a well-known solid dispersion method.

From the standpoint of achieving the object of the present invention, the heat-developable photosensitive material according to the fourth embodiment of the present invention preferably contains at least one compound represented by formula (1), (2), (3) or (A).

The compounds represented by formulae (1) to (3) are described below.

In formula (1), X represents an atomic group capable of forming a heterocyclic ring having at least one of —SO₃M, —COOM and —OM. Examples of the heterocyclic group formed include an oxazole ring, a thiazole ring, an imidazole ring, a selenazole ring, a triazole ring, a tetrazole ring, a thiadiazole ring, an oxadiazole ring, a pentazole ring, a pyrimidine ring, a thiazine ring, a triazine ring, a thiodiazine ring and these rings each combined with another carbon ring or heterocyclic ring, such as benzothiazole ring, benzotriazole ring, benzimidazole ring, benzoxazole ring, benzoselenazole ring, naphthoxazole ring, triaza-indolizine ring, diazaindolizine ring and tetraaza-indolizine ring. These heterocyclic rings each may have a substituent and the substituent is an aliphatic group, an aromatic group or a heterocyclic group. Among those heterocyclic groups, preferred are an imidazole ring, a tetrazole ring, a benzimidazole ring, a benzothiazole ring, a benzoxazole ring and a triazole ring. The substituent is preferably an aliphatic group (for example, a lower alkyl group (e.g., methyl, ethyl) and an aralkyl group (e.g., benzyl)) or an aromatic group (e.g., phenyl). In formula (1), M represents a hydrogen atom, a metal atom such as transition metal atom (e.g., alkali metal, silver, gold, palladium), an ammonium group or a quaternary phosphonium group.

The compounds represented by formulae (2) and (3) are described below.

In formulae (2) and (3), A₄ and A₄¹ ′ each represents —SO₃M, —COOM or —OM, and M represents a hydrogen atom, a metal atom (preferably a transition metal or the like capable of forming a bond with sulfur or selenium, such as alkali metal, silver, gold and palladium), a quaternary ammonium group or a phosphonium group. A₄ and A₄′ may be the same or different in the structure. m is an integer of 1 to 10.

A₅ and A₅′ each represents an electron-withdrawing group (preferably, for example, a fluorine atom, a trifluoromethyl group, a cyano group, a nitro group, —SOCF₃ group, —SO₂NH₂ group or —SO₂CH₃ group), and A₅ and A₅′ may be the same or different in the structure. n is an integer of 1 to 10.

A₆ and A₆′ each represents a functional group containing a sulfur, selenium or tellurium atom capable of combining with silver ion (the functional group is preferably, for example, a mercapto group, a thione group, a —SeH group, a ═Se group, a —TeH group or a ═Te group), and A₆ and A₆′ may be the same or different in the structure. r represents 1 or 2.

Y, Y₁ and Y₂ each represents an aliphatic group (preferably, for example, an aliphatic hydrocarbon having from 4 to 20 carbon atoms), an aromatic group (preferably, for example, a benzene ring or a naphthalene ring) or a heterocyclic group (e.g., oxazole ring, thiazole ring, imidazole ring, selenazole ring, triazole ring, tetrazole ring, thiadiazole ring, oxadiazole ring, pentazole ring, pyrimidine ring, thiazine ring, triazine ring, thiodiazine ring).

Z represents a sulfur atom, a selenium atom or a tellurium atom, and p represents 1 or 2.

In addition to the substituents A₄, A₄′, A₅, A₅′, A₆ and A₆′, the compound may have a substituent such as a halogen atom except for fluorine, a hydroxyl group, an amino group, an acylamino group, an alkylamino group, an alkyl group, an alkenyl group, a cycloalkyl group, an aryl group, an alkoxy group, an aryloxy group, an alkylthio group, an alkoxycarbonyl group, a carbamoyl group, an alkoxyalkyl group, an aminoalkyl group, an acylaminoalkyl group, a hydroxyalkyl group, a carboxyalkyl group, a sulfoalkyl group and an alkylsulfonamido group.

These compounds can be synthesized by or in accordance with the method described, for example, in J Chem. Soc. Sect. C, page 626 (1965), ibid., page 1347 (1971), J. Org. Chem., Vol. 34, page 534 (1969), JP-A-60-184057 (the term “JP-A” as used herein means an “unexamined published Japanese patent application”) and JP-A-60-204742. Some of these compounds are commercially available as a chemical reagent. These compounds each may be added in the form of powder as it is or in the form of a solution obtained by dissolving the compound in a low boiling point organic solvent such as methanol, ethanol and ethyl acetate, water or a mixed solvent of a low boiling point organic solvent and water. At this time, a pH adjusting agent for changing the pH so as to increase the solubility may be used, if desired. Depending on the case, when the compound is added as a fine particle solid dispersion, a higher effect can be obtained. In any case, the amount added is from 0.01 to 0.5 g, preferably from 0.02 to 0.2 g, per mol of silver. The layer to which these compounds each is added may be any layer as long as it is on the support surface in the side having the photosensitive layer but is preferably the photosensitive layer. In the case of adding to the photosensitive layer, the compound represented by formula (1), (2) or (3) may be added on use separately from a silver halide emulsion and a hydrophilic colloid solution or may be simultaneously mixed and added.

Specific examples of the compounds represented by formulae (1) to (3) for use in the present invention are set forth below, however, the present invention is not limited thereto.

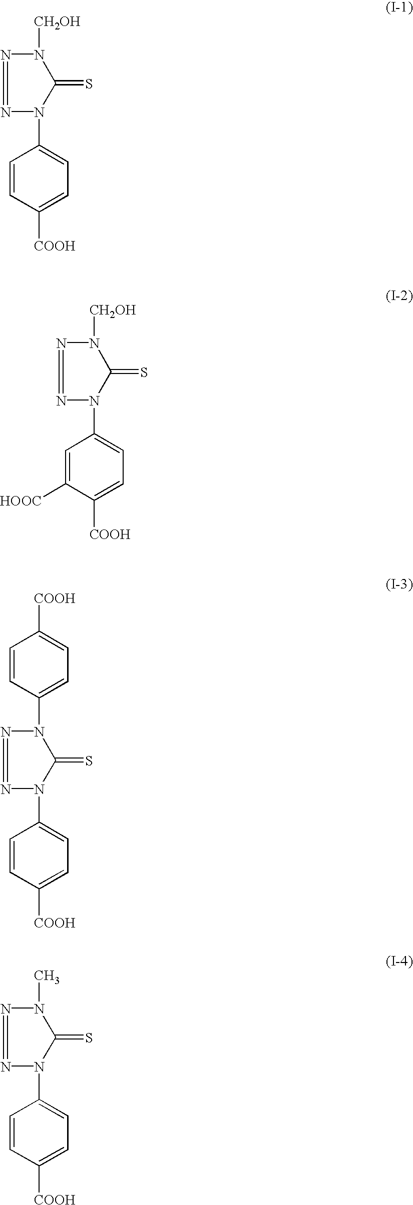

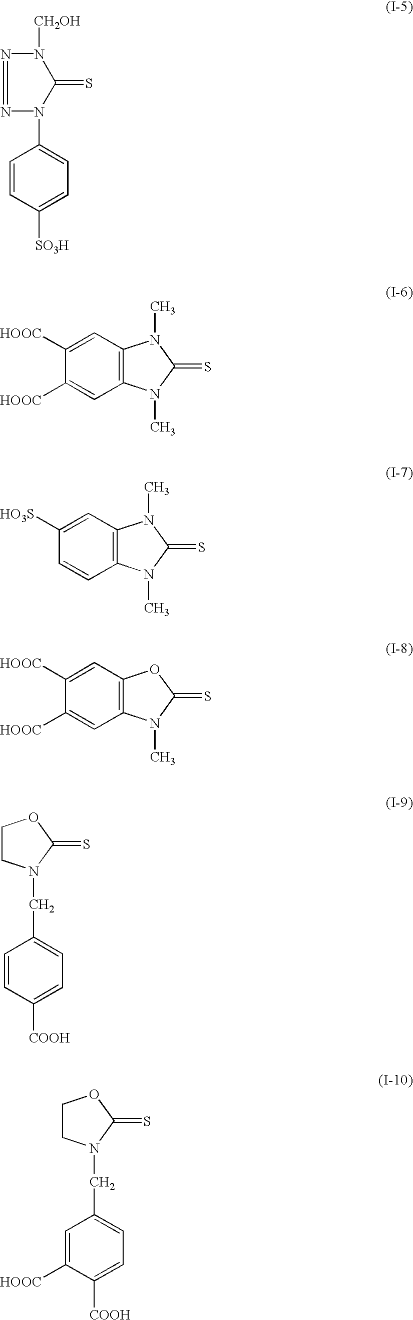

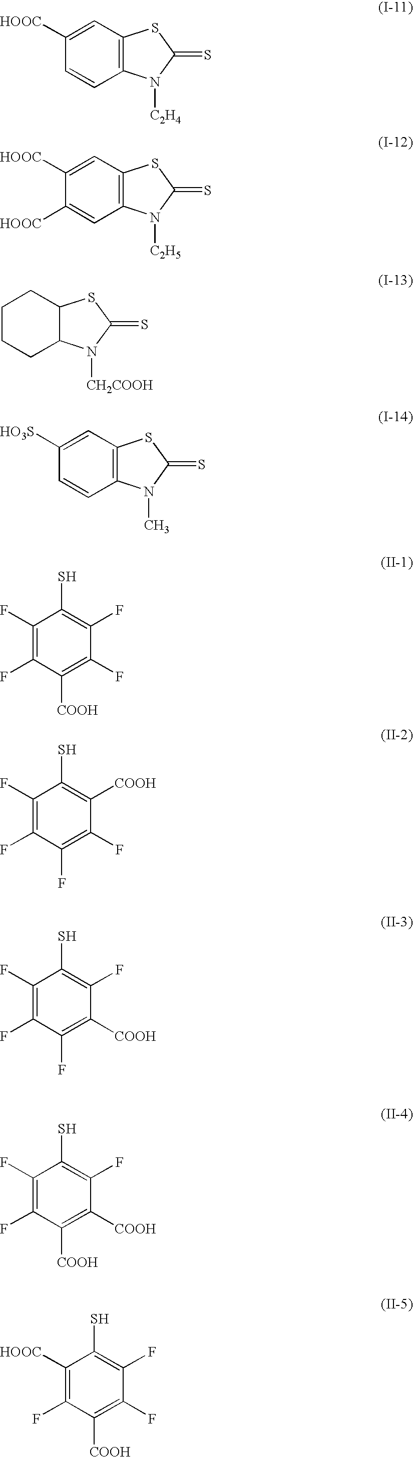

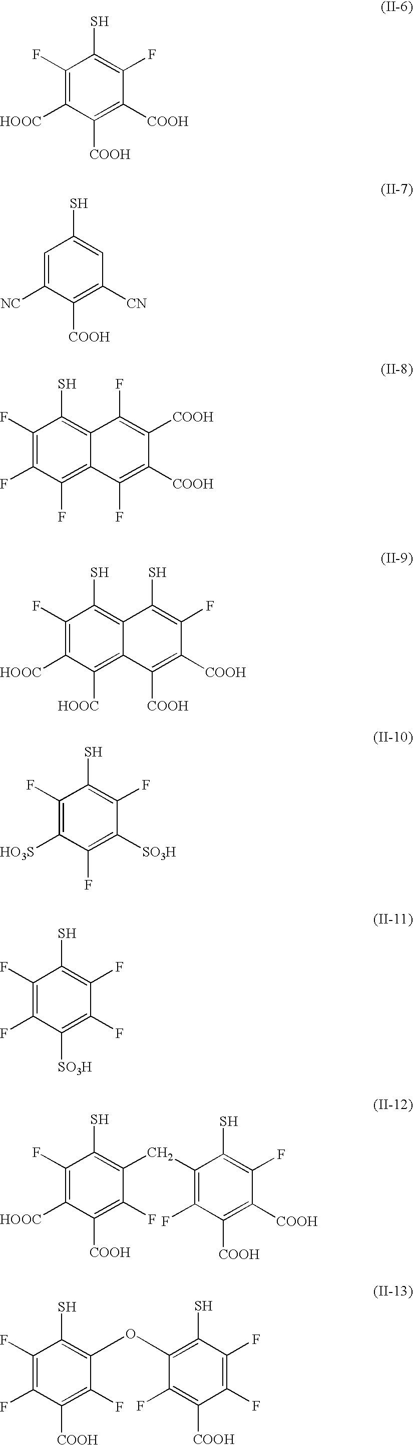

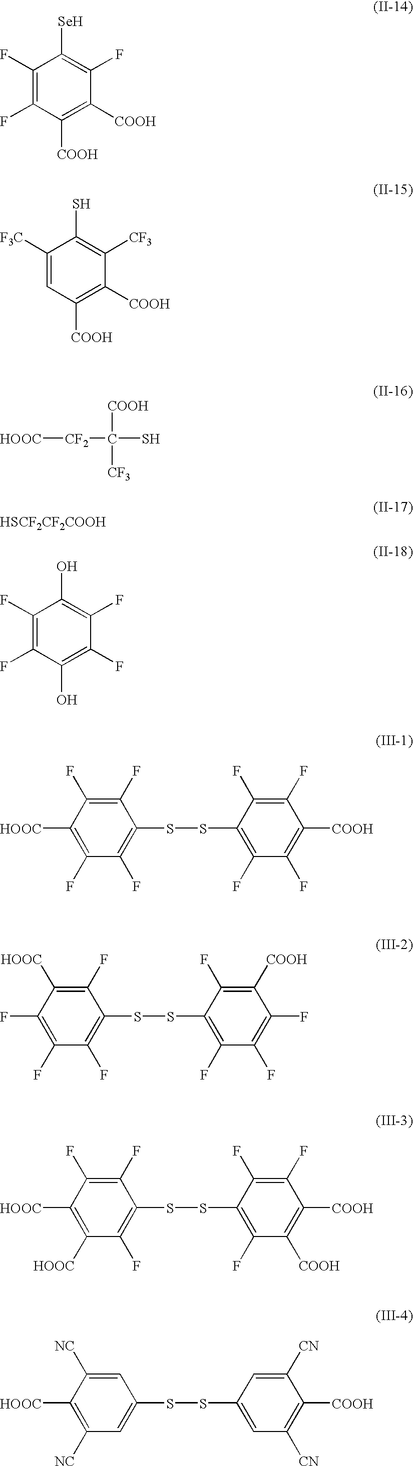

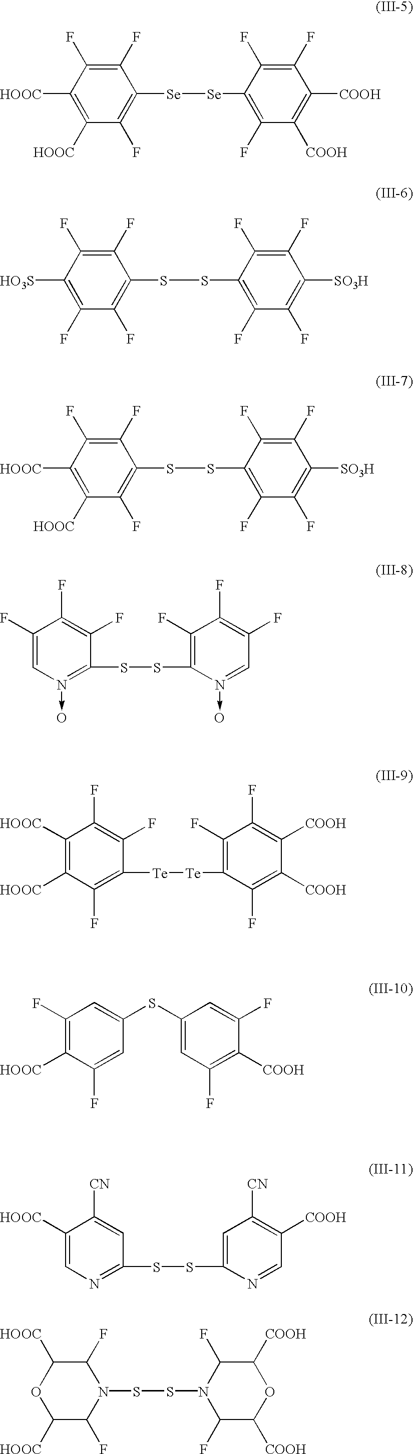

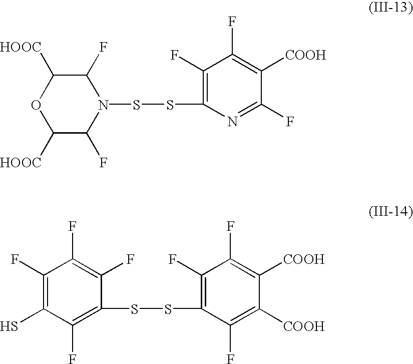

In the present invention, at least one hindered phenol compound represented by the following formula (II) is preferably further contained.

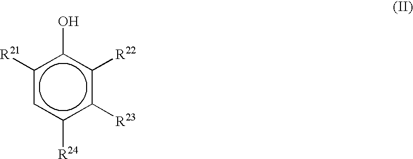

In formula (II), R²¹ and R²² each independently represents a hydrogen atom, an alkyl group or an acylamino group, provided that R² and R²² each is not a 2-hydroxyphenylmethyl group and that R²¹ and R²² are not a hydrogen atom at the same time, R²³ represents a hydrogen atom or an alkyl group, and R²⁴ represents a substituent capable of substituting to the benzene ring.

Formula (I) is described in detail below.

When R²¹ is an alkyl group, the alkyl group is preferably an alkyl group having from 1 to 30 carbon atoms, more preferably an alkyl group having from 1 to 10 carbon atoms. The alkyl group may have a substituent. Specific preferred examples of the unsubstituted alkyl group include a methyl group, an ethyl group, a butyl group, an octyl group, an isopropyl group, a tert-butyl group, a tert-octyl group, a tert-amyl group, a sec-butyl group, a cyclohexyl group and a 1-methyl-cyclohexyl group. Among these, more preferred is a group sterically larger than an isopropyl group, such as isopropyl group, isononyl group, tert-butyl group, tert-amyl group, tert-octyl group, cyclohexyl group, 1-methyl-cyclohexyl group and adamantyl group, and still more preferred is a tertiary alkyl group such as tert-butyl group, tert-octyl group and tert-amyl group.

When the alkyl group has a substituent, examples of the substituent include a halogen atom, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group.

When R²² is an alkyl group, the alkyl group is preferably an alkyl group having from 1 to 30 carbon atoms, more preferably an unsubstituted alkyl group having from 1 to 24 carbon atoms. The alkyl group may have a substituent. Specific preferred examples of the unsubstituted alkyl group include a methyl group, an ethyl group, a butyl group, an octyl group, an isopropyl group, a tert-butyl group, a tert-octyl group, a tert-amyl group, a sec-butyl group, a cyclohexyl group and a 1-methyl-cyclohexyl group. Examples of the substituent are the same as those described for R²¹.

When R²¹ and R²² each is an acylamino group, the acylamino group is preferably an acylamino group having from 1 to 30 carbon atoms, more preferably an acylamino group having from 1 to 10 carbon atoms. The acylamino group may be unsubstituted or may have a substituent. Specific examples thereof include an acetylamino group, an alkoxyacetylamino group and an aryloxyacetylamino group.

R²¹ is preferably an alkyl group out of a hydrogen atom, an alkyl group and an acyl group. On the other hand, R²² is preferably a hydrogen atom or an unsubstituted alkyl group having from 1 to 24 carbon atoms, specifically, a methyl group, an isopropyl group or a tert-butyl group, out of a hydrogen atom, an alkyl group and an acylamino group.

R²¹ and R²² each is not a 2-hydroxyphenylmethyl group and are not a hydrogen atom at the same time.

R²³ represents a hydrogen atom or an alkyl group, preferably a hydrogen atom or an alkyl group having from 1 to 30 carbon atoms, more preferably a hydrogen atom or an unsubstituted alkyl group having from to 24 carbon atoms. The alkyl group is the same as the alkyl group described for R²². Specific examples thereof include a methyl group, an isopropyl group and a tert-butyl group. Either one of R²² and R²³ is preferably a hydrogen atom.

R²⁴ represents a group capable of substituting to the benzene ring. R²⁴ is preferably a substituted or unsubstituted alkyl group having from 1 to 30 carbon atoms or an oxycarbonyl group having from 2 to 30 carbon atoms, more preferably an alkyl group having from 1 to 24 carbon atoms. Examples of the substituent of the alkyl group include an aryl group, an amino group, an alkoxy group, an oxycarbonyl group, an acylamino group, an acyloxy group, an imido group and a ureido group. Among these, preferred are an aryl group, an amino group, an oxycarbonyl group and an alkoxy group.

The compound of formula (II) preferably has a structure represented by formula (III).

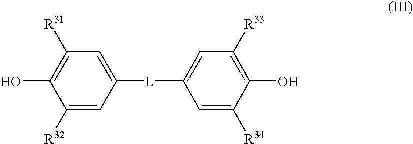

In Formula (III), R³¹, R³², R³³ and R³⁴ each is independently a substituted or unsubstituted alkyl group having from 1 to 20 carbon atoms, preferably an alkyl group having from 1 to 10 carbon atoms. The substituent of the alkyl group is not particularly limited but preferred examples thereof include an aryl group, a hydroxy group, an alkoxy group, an aryloxy group, an alkylthio group, an arylthio group, an acylamino group, a sulfonamido group, a sulfonyl group, a phosphoryl group, an acyl group, a carbamoyl group, an ester group and a halogen atom. Preferably, at least one group sterically larger than an isopropyl group is present, such as isopropyl group, isononyl group, tert-butyl group, tert-amyl group, tert-octyl group, cyclohexyl group, 1-methyl-cyclohexyl group and adamantyl group, and more preferably, two or more groups sterically larger than an isopropyl group are present. The group sterically larger than an isopropyl group is preferably a tertiary alkyl group such as tert-butyl group, tert-octyl group and tert-amyl group.

L represents a —S— group or —CHR¹³— group. R¹³ represents a hydrogen atom or an alkyl group having from 1 to 20 carbon atoms, which may have a substituent. Examples of the substituent of the alkyl group include a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group and a sulfamoyl group. When the alkyl group is unsubstituted, specific examples thereof include a methyl group, an ethyl group, a propyl group, a butyl group, a heptyl group, an undecyl group, an isopropyl group, a 1-ethylpentyl group and a 2,4,4-trimethylpentyl group.

Specific examples of the compounds represented by formulae (II) and (III) for use in the present invention are set forth below, however, the present invention is not limited thereto.

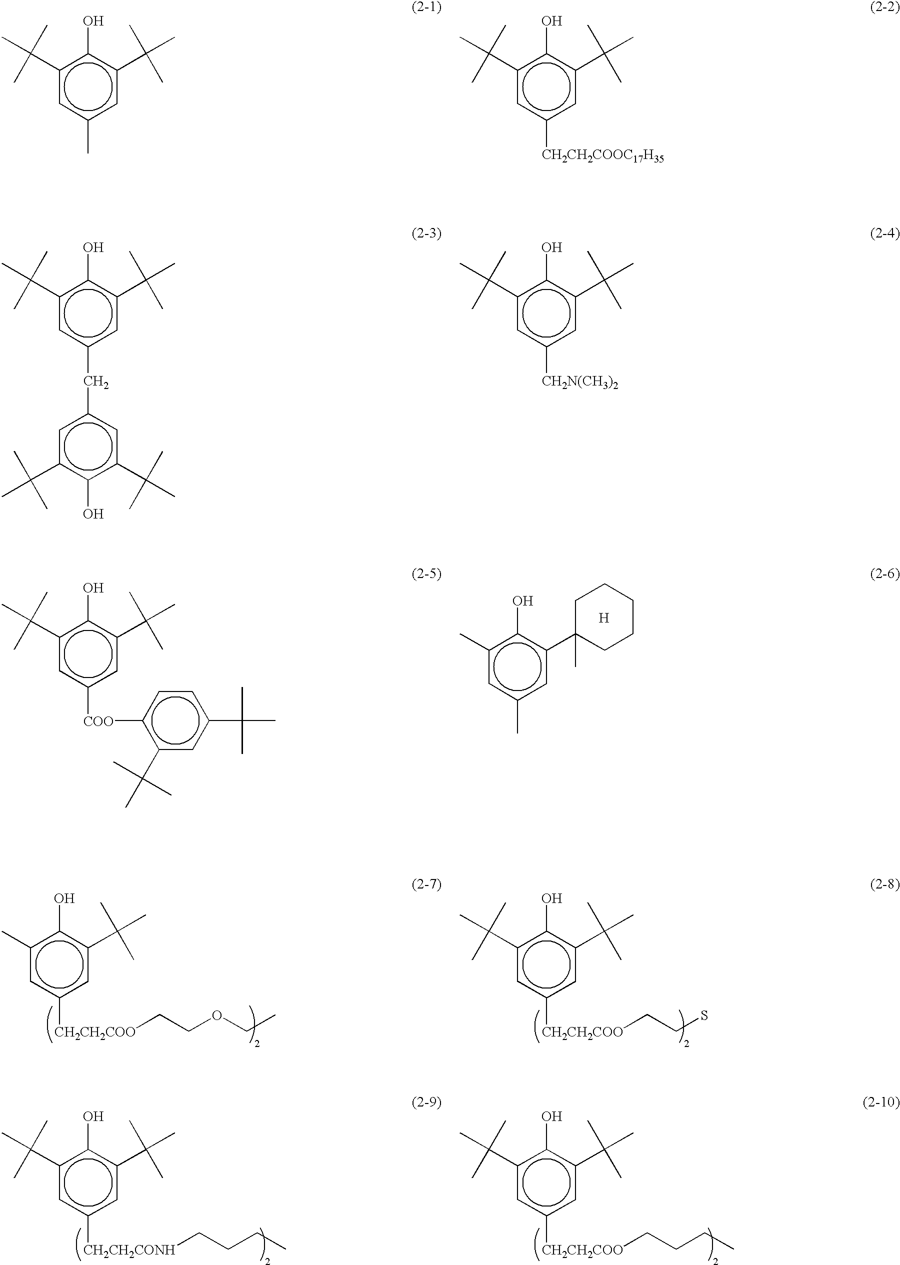

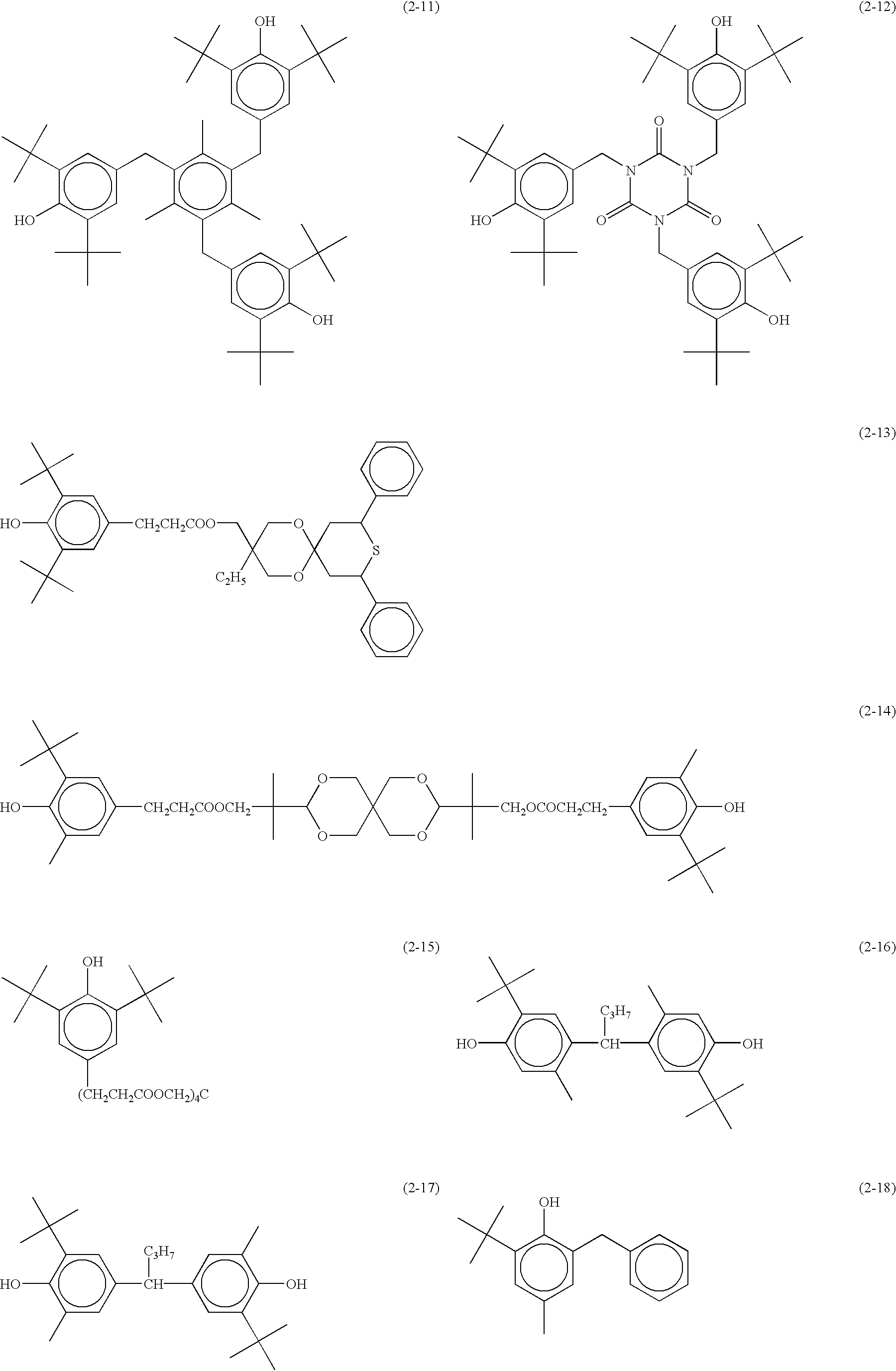

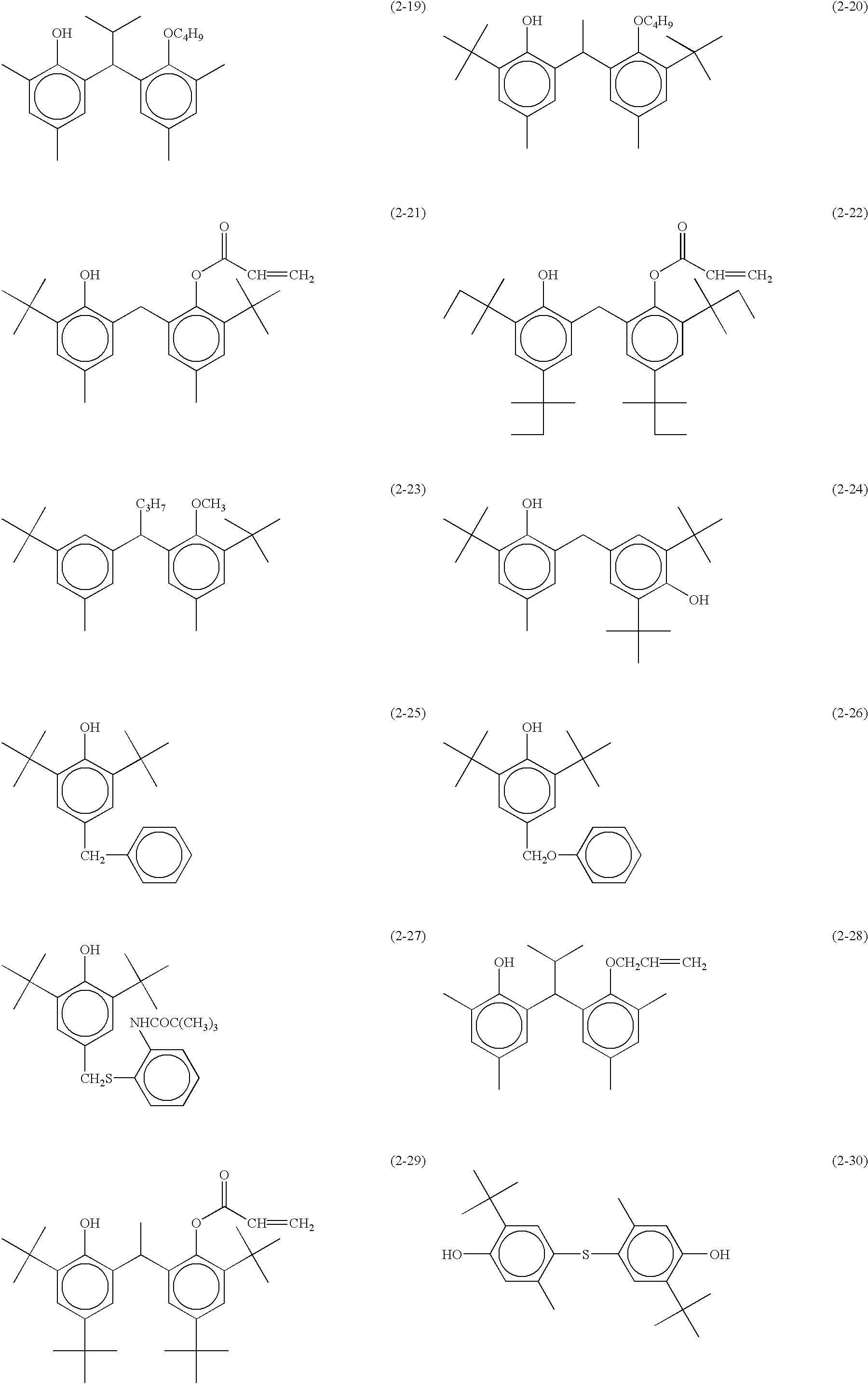

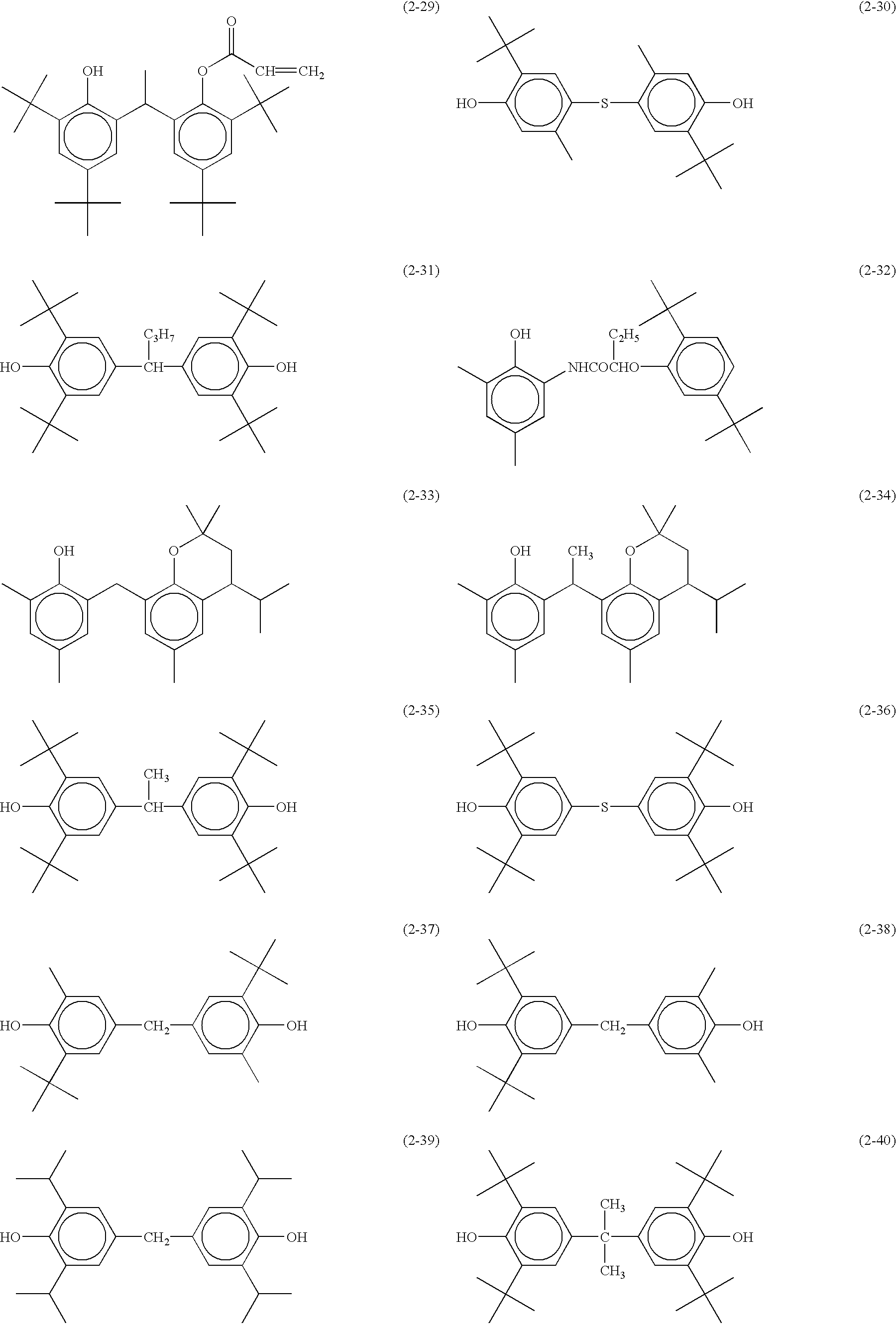

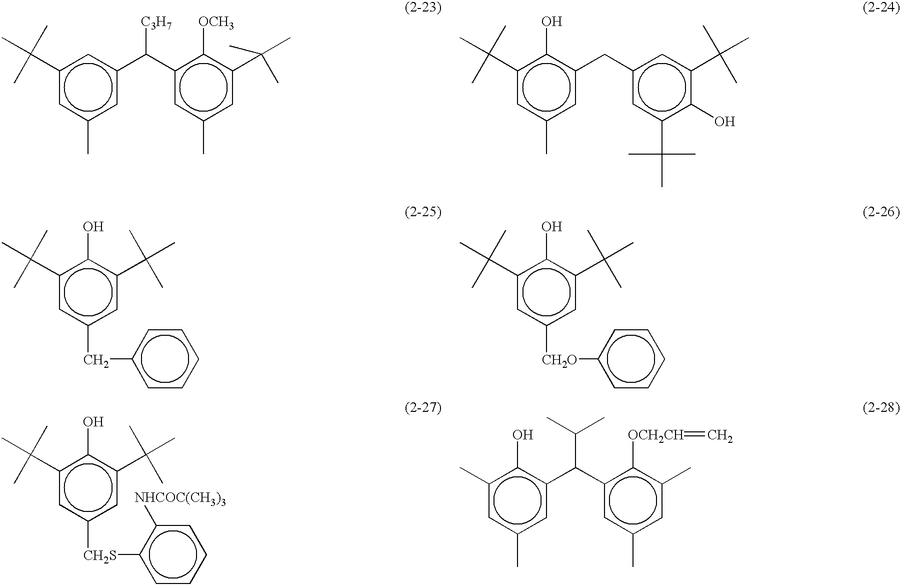

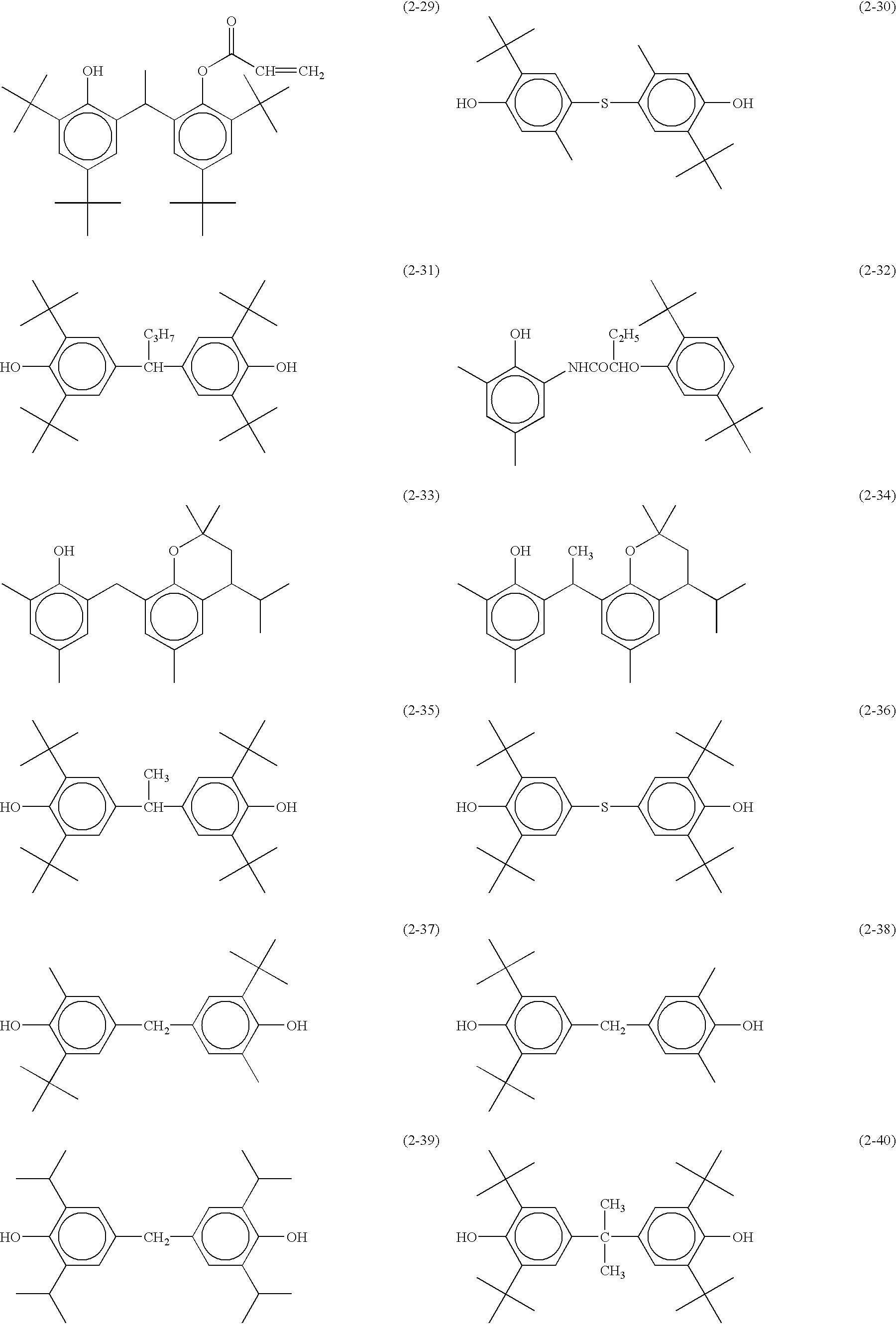

The compound represented by formula (II) or (III) can be added to any layer as long as it is a layer on the support surface in the side having the photosensitive layer. The amount added is approximately from 10⁻⁶ to 10⁻¹ mol, preferably from 10⁻⁵ to 10⁻² mol, per mol of silver halide. The compound can be added by dissolving it in an appropriate organic solvent such as alcohols (e.g., methanol, ethanol, propanol, fluorinated alcohol), ketones (e.g., acetone, methyl ethyl ketone), dimethylformamide, dimethylsulfoxide and methyl cellosolve. The compound may also be used as an emulsification dispersion product obtained by a well-known emulsification dispersion method of dissolving the compound using an oil such as dibutyl phthalate, tricresyl phosphate, glyceryl triacetate or diethyl phthalate, and an auxiliary solvent such as ethyl acetate or cyclohexanone, and mechanically emulsification-dispersing the resulting solution. Also, the compound may be used by dispersing it using a method known as a solid dispersion method.

The heat-developable photosensitive material of the present invention contains an organic silver salt. The organic silver salt which can be used in the present invention is a silver salt which is relatively stable to light but forms a silver image when heated at 80° C. or more in the presence of an exposed photocatalyst (e.g., a latent image of photosensitive silver halide) and a reducing agent. The organic silver salt may be any organic substance containing a source capable of reducing silver ion. A silver salt of an organic acid, particularly, a silver salt of a long chain (having from 10 to 30, preferably from 15 to 28 carbon atoms) fatty carboxylic acid, is preferred. An organic or inorganic silver salt complex where the ligand has a complex stability constant of 4.0 to 10.0 is also preferred. Such a non-photosensitive organic silver salt is described in JP-A-10-62899 (paragraphs 0048 to 0049), EP-A-0803764 (page 18, line 24 to page 19, line 37), EP-A-0962812, JP-A-11-349591, JP-A-2000-7683 and JP-A-2000-72711. The organic silver salt preferably contains a silver salt of an organic compound having a carboxyl group. Examples thereof include a silver salt of an aliphatic carboxylic acid and a silver salt of an aromatic carboxylic acid, however, the present invention is not limited thereto. Preferred examples of the silver salt of an aliphatic carboxylic acid include silver behenate, silver stearate, silver oleate, silver laurate, silver caproate, silver myristate, silver palmitate, silver maleate, silver fumarate, silver tatrate, silver linoleate, silver butyrate, silver camphorate and mixtures thereof. The organic silver salt as a silver-supplying substance can constitute preferably from about 5 to 30 mass % of the image-forming layer.

The shape of the organic silver salt which can be in the present invention is not particularly limited but a needle-like crystal having a short axis and a long axis is preferred. In the field of silver halide photographic material, it is well known that the size and the covering force of a silver salt crystal grain are in the relationship of inverse proportion. This relationship also applies in the heat-developable photosensitive material of the present invention and when the organic silver salt grain as an image-forming part of the heat-developable photosensitive material is large, this means that the covering force is small and the image density is low. In the present invention, the grain crystal preferably has a short axis of 0.01 to 0.20 μm and a long axis of 0.10 to 5.0 μm, more preferably a short axis of 0.01 to 0.15 μm and a long axis of 0.10 to 4.0 μm. The grain size distribution of the organic silver salt is preferably monodisperse. The monodisperse means that the percentage of a value obtained by dividing the standard deviation of each length of the short axis and the long axis by the short axis or the long axis is preferably 100% or less, more preferably 80% or less, still more preferably 50% or less. The shape of the organic silver salt can be determined from a transmission electron microscope image of an organic silver salt dispersion. In another method, the monodispersity is determined from the standard deviation of a volume weighted average diameter of the organic silver salt. In this case, the monodisperse means that the percentage (coefficient of variation) of a value obtained by dividing the standard deviation by the volume weighted average diameter is preferably 100% or less, more preferably 80% or less, still more preferably 50% or less. In the measurement of monodispersity, for example, laser light is irradiated on an organic silver salt dispersed in a solution, an autocorrelation function of fluctuation of scattered light with respect to the time change is determined and from the autocorrelation function obtained, the grain size (volume weighted average diameter) can be determined.

The organic silver salt can be used in a desired amount but is preferably, as a silver coated amount, from 0.1 to 5 g/m², more preferably from 1 to 3 g/m².

The heat-developable photosensitive material of the present invention contains a photosensitive silver halide. The method for forming a photosensitive silver halide for use in the present invention is well known in the art and, for example, the methods described in Research Disclosure, No. 17029 (June, 1978) and U.S. Pat. No. 3,700,458 may be used. Specifically, a method of adding a halogen-containing compound in a prepared organic silver salt and thereby converting a part of silver of the organic silver salt into photosensitive silver halide, and a method of adding a silver-supplying compound and a halogen-supplying compound to gelatin or other polymer solution to prepare a photosensitive silver halide grain and mixing the silver halide grain with an organic silver salt can be used. In the present invention, the latter method is preferred. The size of photosensitive silver halide grain is preferably small for the purpose of suppressing occurrence of white turbidity after the image formation. Specifically, the grain size is preferably from 0.01 to 0.15 μm, more preferably from 0.02 to 0.10 μm. If the silver halide grain size is too small, insufficient sensitivity results, whereas if it is excessively large, there arises a problem that haze of the photosensitive material increases. The grain size as used herein means the length of an edge of a silver halide grain when the silver halide grain is a so-called regular crystal such as cubic or octahedral grain. In the case where the silver halide grain is a tabular grain, the grain size means a diameter of a circle image having the same area as the projected area of a main plane. In the case of other irregular crystals, for example, a spherical grain or a bar-like grain, the grain size means a diameter of a sphere having the same volume as the silver halide grain.

Examples of the shape of silver halide grain include cubic form, octahedral form, tabular form, spherical form, bar form and pebble-like form. In the present invention, a cubic grain and a tabular grain are particularly preferred. In the case of using a tabular silver halide grain, the average aspect ratio is preferably from 100:1 to 2:1, more preferably from 50:1 to 3:1. A silver halide grain having rounded corners can also be preferably used. Although the face index (Miller indices) of the outer surface of a photosensitive silver halide grain is not particularly limited, {100} faces capable of giving a high spectral sensitization efficiency upon adsorption of a spectral sensitizing dye preferably occupy a high percentage. The percentage is preferably 50% or more, more preferably 65% or more, still more preferably 80% or more. The percentage of {1001 faces according to the Miller indices can be determined by the method described in T. Tani, J. Imaging Sci., 29, 165 (1985) utilizing the adsorption dependency of {111} face and {100} face when a sensitizing dye is adsorbed. The photosensitive silver halide is not particularly limited on the halogen composition and silver chloride, silver chlorobromide, silver bromide, silver iodobromide, silver iodochlorobromide or silver iodide may be used. Among these, in the present invention, silver bromide and silver iodobromide are preferred, silver iodobromide is more preferred. The silver iodide content is preferably from 0.1 to 40 mol %, more preferably from 0.1 to 20 mol %. The halogen composition distribution within the grain may be uniform or the halogen composition may be stepwise or continuously changed, however, a silver iodobromide having a high silver iodide content in the inside of the grain is preferred. A silver halide grain having a core/shell structure may also be preferably used. With respect to the structure, the core/shell grain preferably has from 2 to 5-ply structure, more preferably from 2 to 4-ply structure.

The photosensitive silver halide grain for use in the present invention preferably contains at least one complex of a metal selected from the group consisting of rhodium, rhenium, ruthenium, osmium, iridium, cobalt, mercury and iron. One of these metal complexes may be used or two or more complexes of the same metal or different metals may be used in combination. The metal complex content is preferably from 1 nmol to 10 mmol, more preferably from 10 nmol to 100 μmol, per mol of silver. As for the specific structure of metal complex, metal complexes having structures described in JP-A-7-225449 may be used. In the case of cobalt and iron compounds, a hexacyano metal complex is preferred. Specific examples thereof include ferricyanate ion, ferrocyanate ion and hexacyanocobaltate ion, however, the present invention is not limited thereto. The metal complex-containing phase in the silver halide may be uniform or the metal complex may contained in a high concentration in the core part or in the shell part. In this respect, there is not particular limitation.

The photosensitive silver halide grain can be desalted by washing using a method known in the art such as noodle method and flocculation method but in the present invention, the photosensitive silver halide grain may not be desalted.

The photosensitive silver halide grain for use in the present invention is preferably subjected to chemical sensitization. As well known in the art, the chemical sensitization is preferably performed using sulfur sensitization, selenium sensitization or tellurium sensitization. Also, a noble metal sensitization method using a gold, platinum, palladium or iridium compound or the like, or a reduction sensitization method may be used. As for the compound which is preferably used in the sulfur sensitization, selenium sensitization or tellurium sensitization, known compounds can be used, for example, compounds described in JP-A-7-128768 can be used.

In the present invention, the amount of photo-sensitive silver halide used is preferably from 0.01 to 0.5 mol, more preferably from 0.02 to 0.3 mol, still more preferably from 0.03 to 0.25 mol, per mol of organic silver salt. The mixing method or mixing conditions of separately prepared photosensitive silver halide and organic silver salt are not particularly limited as long as the effect of the present invention can be satisfactorily brought out, but for example, a method of mixing silver halide grain and organic silver salt each after the completion of preparation in a high-speed stirring machine, a ball mill, a sand mill, a colloid mill, a vibration mill, a homogenizer or the like, and a method of preparing an organic silver salt by mixing photosensitive silver halide after completion of preparation at any timing during the preparation of the organic silver salt may be used.

As for the preparation method of silver halide for use in the present invention, a so-called halidation method is also preferably used, where a part of silver of the organic silver salts is halogenated with an organic or inorganic halide. The organic halide used here may be any compound as long as it reacts with the organic silver salt and forms a silver halide, however, examples thereof include N-halogenoimides (e.g., N-bromosuccinimide), halogenated quaternary nitrogen compounds (e.g., tetrabutylammonium bromide) and aggregates of halogenated quaternary nitrogen compound and halogen molecule (e.g., pyridinium bromide perbromide). The inorganic halide compound may be any compound as long as it reacts with the organic silver salt and forms a silver halide, however, examples thereof include alkali metal halides or ammonium halides (e.g., sodium chloride, lithium bromide, potassium iodide, ammonium bromide), alkali earth metal halides (e.g., calcium bromide, magnesium chloride), transition metal halides (e.g., ferric chloride, cupric bromide), metal complexes having a halogen ligand (e.g., sodium bromoiridate, ammonium chlororhodate) and halogen atoms (e.g., bromine, chlorine, iodine). Also, organic and inorganic halides can be used in a desired combination. The amount of the halide compound added at the halidation is preferably 1 to 500 mmol, more preferably 10 to 250 mmol, in terms of halogen atom per 1 mol of the organic silver salt.

As for the sensitizing dye which can be used in the present invention, a sensitizing dye capable of spectrally sensitizing a silver halide grain in the desired wavelength region when adsorbed to the silver halide grain and having a spectral sensitivity suitable for the spectral characteristics of exposure light source can be advantageously selected. Examples of the sensitizing dye and the addition method therefor include compounds described in JP-A-11-65021 (paragraph Nos. 0103 to 0109), compounds represented by formula (II) of JP-A-10-186572, dyes represented by formula (I) and described in paragraph No. 0106 of JP-A-11-119374, dyes described in U.S. Pat. Nos. 5,510,236, 5,541,054 and 3,871,887 (Example 5), dyes disclosed in JP-A-2-96131 and JP-A-59-48753, and those described in EP-A-0803764 (page 19, line 38 to page 20, line 35) and Japanese Patent Application Nos. 2000-86865 and 2000-102560. These sensitizing dyes may be used individually or in combination of two or more thereof. In the present invention, the amount of the sensitizing dye added may be appropriately selected according to the performance such as sensitivity or fog but is preferably from 10⁻⁶ to 1 mol, more preferably from 10⁻⁴ to 10⁻¹ mol, per mol of silver halide in the photosensitive layer. Combination of sensitizing dyes is often used particularly for the purpose of supersensitization. A dye which itself has no spectral sensitization effect or a substance which absorbs substantially no visible light but shows supersensitization may be contained together with the sensitizing dye in the emulsion. Useful sensitizing dyes, combination of dyes, which shows supersensitization, and substances of showing supersensitization are described in Research Disclosure, Vol. 176, 17643, IV-J, page 23 (December, 1978), JP-B-49-25500 (the term “JP-B” as used herein means an “examined Japanese patent publication”), JP-B-43-4933, JP-A-59-19032 and JP-A-59-192242. In the case of using a spectral sensitizing dye represented by formulae (2a) to (2d), the above-described known sensitizing dye can be used in combination with the spectral sensitization dye of formulae (2a) to (2d).

The heat-developable photosensitive material of the present invention contains a reducing agent for organic silver salt. The reducing agent for organic silver salt may be any substance, preferably organic substance, capable of reducing silver ion into a metal silver. Conventional photographic developing agents such as phenidone, hydroquinone and catechol are useful but a o-bisphenol reducing agent is preferred. Examples of the o-bisphenol reducing agent include bis(2-hydroxy-3-tert-butyl-5-methylphenyl)methane, 2,2-bis(4-hydroxy-3-methylphenyl)propane, 4,4-ethylidene-bis(2-tert-butyl-6-methylphenol), 1,1-bis(2-hydroxy-3,5-dimethylphenyl)-3,5,5-trimethylhexane, bis(2-hydroxy-3-tert-butyl-5-ethylphenyl)methane, 1,1-bis(2-hydroxy-3-tert-butyl-5-methylphenyl)butane, 1,1-bis(2-hydroxy-3,5-dimethylphenyl)-2-methylpropane and 2,2-bis(3,5-dimethyl-4-hydroxyphenyl)propane. The reducing agent is preferably contained in an amount of 5 to 50 mol %, more preferably from 10 to 40 mol %, per mol of silver on the surface having the image-forming layer. The layer to which the reducing agent is added may be any layer on the surface having the image-forming layer but is preferably used in the image-forming layer.

In the heat-developable photosensitive material of the present invention, a color toning agent is preferably added. The color toning agent is described in JP-A-10-62899 (paragraph Nos. 0054 to 0055), EP-A-0803764 (page 21, lines 23 to 48) and JP-A-2000-35631. Particularly preferred are phthalazinones (phthalazinone and phthalazinone derivatives and metal salts, e.g., 4-(1-naphthyl)phthalazinone, 6-chlorophthalazinone, 5,7-dimethoxyphthalazinone, 2,3-dihydro-1,4-phthalazinone); combinations of a phthalazinone and a phthalic acid (e.g., phthalic acid, 4-methylphthalic acid, 4-nitrophthalic acid, tetrachlorophthalic anhydride); phthalazines (phthalazine and phthalazine derivatives and metal salts, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine; and combinations of a phthalazine and a phthalic acid. Among these, combinations of a phthalazine and a phthalic acid are preferred. The color toning agent is preferably contained in an amount of 0.1 to 50% mol, more preferably from 0.5 to 20% mol, per mol of silver on the surface having the image-forming layer.

The binder for the photosensitive layer of the heat-developable photosensitive material of the present invention may be freely selected from natural and synthetic resins such as gelatin, polyvinyl butyral, polyvinyl acetal, polyvinyl chloride, polyvinyl acetate, cellulose acetate, polyolefin, polyester, polystyrene, polyacrylonitrile, polycarbonate, butyl ethyl cellulose, methacrylate copolymers, anhydrous maleic acid ester copolymers, polystyrene and butadiene-styrene copolymers.

Among these, preferred as the binder are polyvinyl butyral, cellulose acetate, cellulose butyrate and derivatives thereof. Examples thereof are set forth below, however, the present invention is not limited thereto.

1. Polyvinyl butyral

2. Polyvinyl butyral carboxyl group derivative (monomer:carboxyl group=1:1)

3. Polyvinyl butyral carboxyl group derivative (monomer:carboxyl group=1:2)

4. Polyvinyl butyral amino group derivative (monomer:amino group=1:1)

5. Polyvinyl butyral amino group derivative (monomer:amino group=1:2)

6. Polyvinyl butyral carboxyl group and amino group derivative (monomer:carboxyl group:amino group=1:1:1)

7. Polystyrene amino group derivative (monomer:amino group=1:1)

8. Polystyrene amino group derivative (monomer:amino group=1:2)

9. Polystyrene carboxyl group and amino group derivative (monomer:carboxyl group:amino group 1:1:1)

10. Cellulose acetate

11. Cellulose acetate carboxyl group derivative (monomer:carboxyl group=1:1)

12. Cellulose acetate carboxyl group derivative (monomer:carboxyl group=1:2)

13. Cellulose acetate amino group derivative (monomer:amino group=1:1)

14. Cellulose acetate amino group derivative (monomer:amino group=1:2)

15. Cellulose acetate carboxyl group and amino group derivative (monomer:carboxyl group:amino group=1:1:1)

16. Cellulose butyrate

17. Cellulose butyrate carboxyl group derivative (monomer:carboxyl group=1:1)

18. Cellulose butyrate carboxyl group derivative (monomer:carboxyl group=1:2)

19. Cellulose butyrate amino group derivative (monomer:amino group=1:1)

20. Cellulose butyrate amino group derivative (monomer:amino group=1:2)

21. Cellulose butyrate carboxyl group and amino group derivative (monomer:carboxyl group:amino group=1:1:1)

The polyvinyl butyral, cellulose acetate, cellulose butyrate or a derivative thereof include the above-described specific examples can also be used in a layer other than the photosensitive layer. In the heat-developable photosensitive material of the present invention, at least one polymer selected from polyvinyl butyral, cellulose acetate, cellulose butyrate and derivatives thereof is preferably used as the binder in at least one of the constituent layers.

In the present invention, the binder is used in the photosensitive layer to give a total amount large enough to hold the components in the binder, namely, in a range effective for functioning as the binder. The effective range can be appropriately determined by one skilled in the art. As a standard when the binder holds at least an organic silver salt, the ratio of the binder to the organic silver salt is, in terms of mass ratio, from 15:1 to 1:3, more preferably from 8:1 to 1:2.

In the heat-developable photosensitive material of the present invention, any one of the constituent layers preferably contains at least one compound selected from aziridine compounds described in U.S. Pat. No. 3,017,280 and JP-A-9-5916, epoxy compounds described in U.S. Pat. No. 3,017,280 and JP-A-9-5916, and carbodiimide compounds described in U.S. Pat. No. 3,100,704. These compounds act as a film hardening agent and have an effect of increasing the layer strength of the heat-developable photosensitive material.

The compound having an aziridine group, which can be used in the present invention, is described below. In the present invention, any compound may be freely used as long as it is a compound having an aziridine group and exhibiting a film hardening action, however, in practicing the present invention, the compounds specifically shown below can be preferably used.

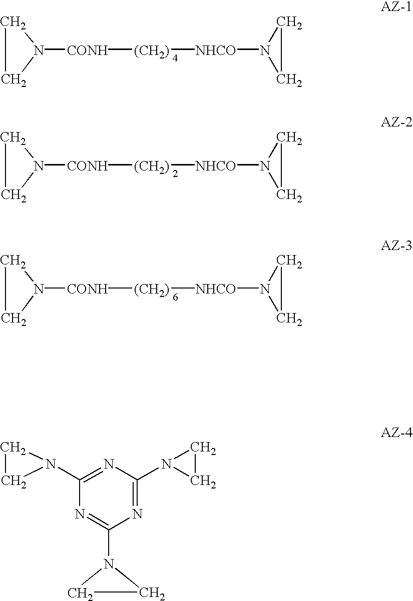

The compound having an epoxy group, which can be used in the present invention is described below. In the present invention, any compound may be freely used as long as it is a compound having an epoxy group and exhibiting a film hardening activity, however, the epoxy compound preferably contains a hydroxy group or an ether condensation. Specific examples of the compound are set forth below.

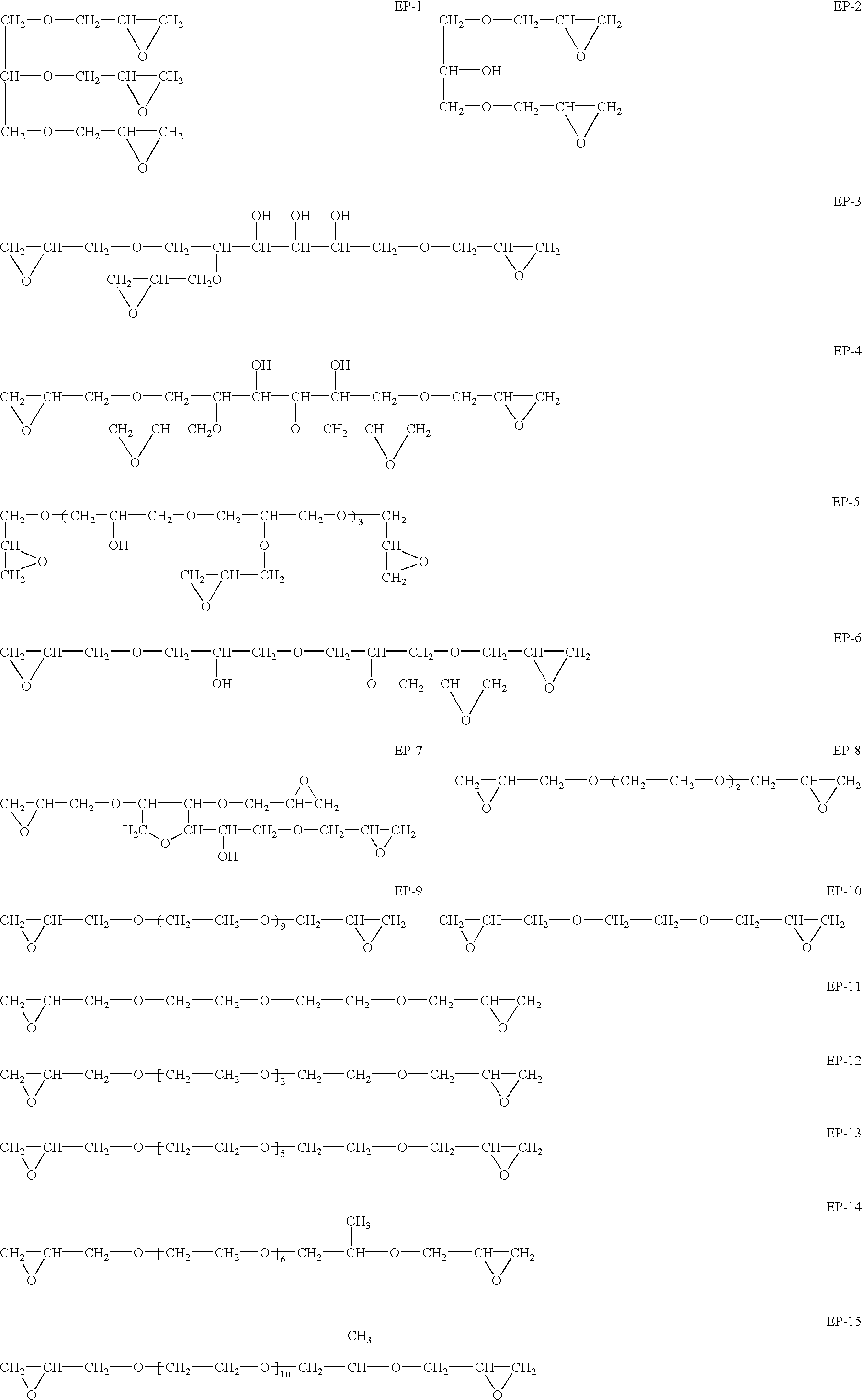

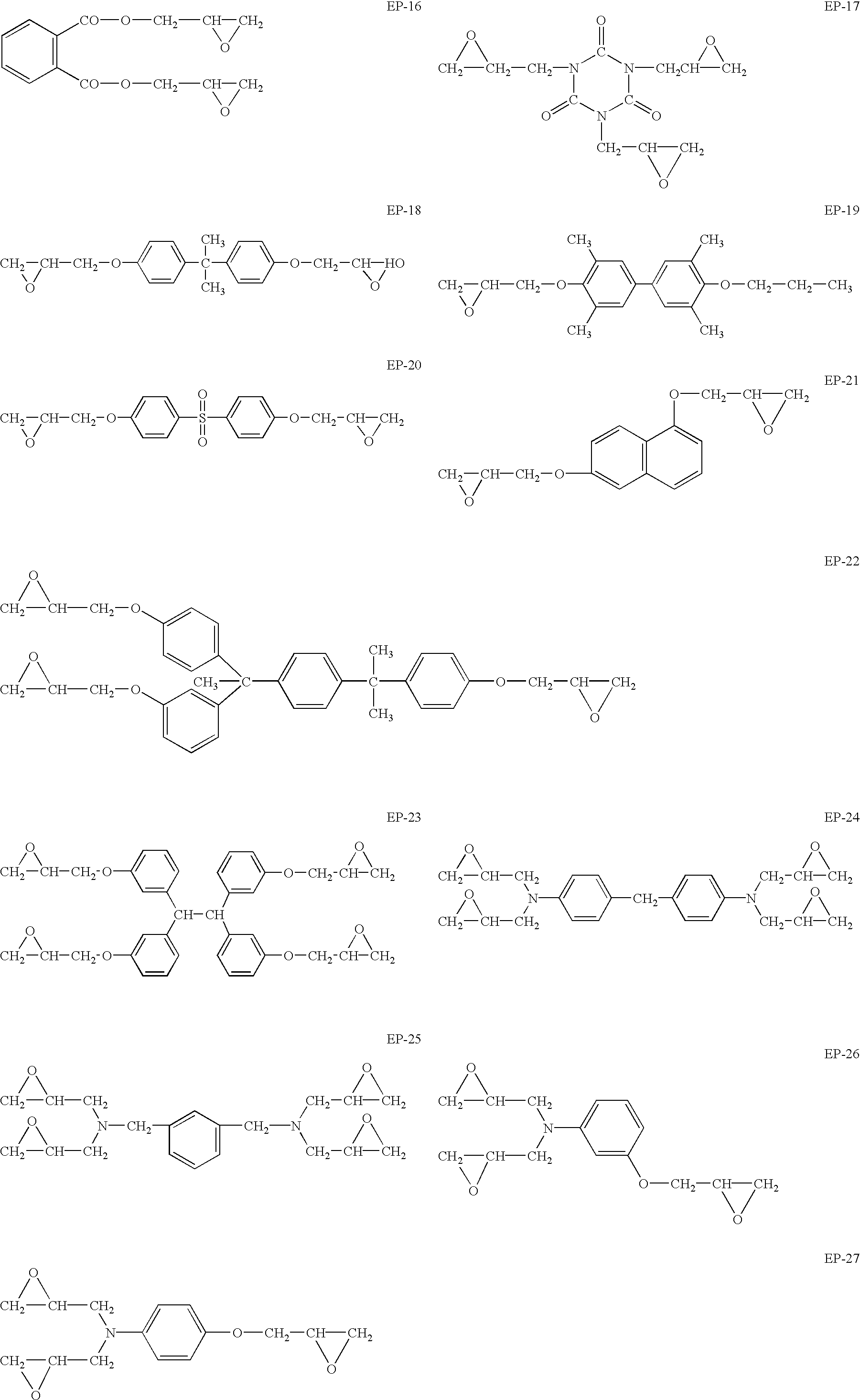

Most of these compounds are put on the market and easily available. As for the method of adding the compound having an epoxy group, the compound may be dissolved in water or an organic solvent such as alcohol, acetone or toluene and then added as it is, or the compound may be added after dispersing it using a surfactant such as dodecylbenzene sulfonate or nonylphenoxyalkylene oxide.

In the present invention, a carbodiimide compound may also be used in addition to the above-described compounds. The carbodiimide compound is preferably represented by the following formula.

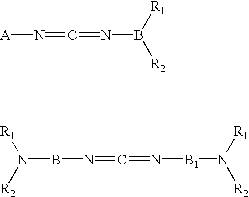

In these formulae, A represents an aliphatic group (for example, a methyl group, an ethyl group, an isopropyl group, a n-butyl group, an isobutyl group, a tert-butyl group, an allyl group, a crotyl group, a β-hydroxyethyl group or a methoxymethyl-β-bormoallyl), an aromatic group (for example, a phenyl group, a tolyl group, a xylyl group, a naphthyl group, a chlorophenyl group, a bromophenyl group, an iodophenyl group), an alicyclic group (for example, a cyclohexyl group, a bornyl group or a menthyl group) or a heterocyclic group (for example, a pyridyl group or a quinolyl group). R₁ and R₂ each represents a lower alkyl group such as methyl group, ethyl group, propyl group, isopropyl group or butyl group, and B and B₁ (which may be the same or different) each represents an alkylene group, an arylene group or an aralkylene group such as propylene group, phenylene group, tolylene group or propylphenylene group.

These di-substituted carbodiimides can be obtained by treating an N,N′-di-substituted symmetric or asymmetric thiourea having at least one tertiary amino group with a desulfurizing agent such as oxide of a heavy metal (e.g., lead, mercury) as described, for example, in Bcrichte, Vol. 71, pp. 1512-1521, ibid., Vol. 73, pp. 467-477 and pp. 1114-1123, ibid., Vol. 75, pp. 100-105, Annalen, Vol. 560, pp. 222-231, and Journal of Organic Chemistry, Vol. pp. 1024-1026.

Representative compounds are set forth below.

N-Isopropyl-N′-(4-dimethylaminophenyl)carbodiimide

N-Phenyl-N′-(4-dimethylaminophenyl)carbodiimide

N,N′-Di(4-dimethylaminophenyl)carbodiimide

N,N′-Di(4-dipropylaminotolyl)carbodiimide

N-Bornyl-N′-(4-dimethylaminophenyl)carbodiimide

N-Menthyl-N′-(4-dimethylaminophenyl)carbodiimide

N-(β-Bromoallyl)-N′-(γ-dimethylaminophenyl)carbodiimide

N-(tert-Butoxy)-N′-(γ-dimethylaminophenyl)carbodiimide

N-Cyclohexyl-N′-(4-dimethylaminophenyl)carbodiimide

N-Isopropyl-N′-(γ-dimethylaminopropyl)carbodiimide

N-Methoxymethyl-N-(γ-dimethylaminopropyl)carbodiimide

N,N′-Di(γ-pyridyl)carbodiimide

This N,N′-di-substituted carbodiimide having a tertiary amine can be formed into an ammonium salt by reacting it with an appropriate quaternizing agent such as methyl bromide, ethyl bromide, methyl iodide, ethyl iodide, dimethyl sulfate, diethyl sulfate, methyl p-toluenesulfonate and ethyl p-toluenesulfonate, directly or in the presence of ethyl acetate, chloroform, benzene, toluene or a mixed solvent thereof, whereby the solubility can be controlled. The N,N′-di-substituted carbodiimide may be added in the form of a quaternary salt.

Quaternized N,N′-di-substituted carbodiimides are set forth below.

N-Isopropyl-N′-(4-dimethylaminophenyl)carbodiimide ethyl p-toluenesulfonate

N-Phenyl-N′-(4-dimethylaminophenyl)carbodiimide ethyl p-toluenesulfonate

N,N′-Di(4-dimethylaminophenyl)carbodiimide monoetho-bromide

N,N′-Di(4-dipropylaminotolyl)carbodiimide ethyl p-toluenesulfonate

N-Bornyl-N′-(4-dimethylaminophenyl)carbodiimide methosulfate

N-Menthyl-N′-(4-dimethylaminophenyl)carbodiimide ethosulfate

N-(β-Bromoallyl)-N′-(γ-dimethylaminophenyl) carbodiimide ethosulfate

N-(tert-Butyl)-N′-(γ-dimethylaminophenyl) carbodiimide ethyl p-toluenesulfonate

N-Cyclohexyl-N′-(4-dimethylaminophenyl)carbodiimide ethyl p-toluenesulfonate

N-Isopropyl-N′-(γ-dimethylaminopropyl)carbodiimide ethobromide

N-Methoxymethyl-N-(γ-dimethylaminopropyl)carbodiimide ethyl p-toluenesulfonate

N,N′-Di(γ-pyridyl)carbodiimide monomethosulfate

The hardening agent for use in the present invention such as aziridine compound, epoxy compound and carbodiimide compound is generally used in an amount of 0.002 mol or more per mol of silver. The compound is usually used in the range from 0.002 to 2 mol, preferably from 0.003 to 0.3 mol, per mol of silver.

By using an antifoggant, a stabilizer and a stabilizer precursor, the silver halide emulsion or/and organic silver salt for use in the present invention can be further protected from the generation of additional fog and stabilized against reduction of sensitivity during stock storage. Examples of the antifoggant, stabilizer and stabilizer precursor which can be appropriately used individually or in combination include thiazonium salts described in U.S. Pat. Nos. 2,131,038 and 2,694,716, azaindenes described in U.S. Pat. Nos. 2,886,437 and 2,444,605, compounds described in JP-A-9-329865 and U.S. Pat. No. 6,083,681, mercury salts described in U.S. Pat. No. 2,728,663, urazoles described in U.S. Pat. No. 3,287,135, sulfocatechols described in U.S. Pat. No. 3,235,652, oximes, nitrons and nitroindazoles described in British Patent 623,448, polyvalent metal salts described in U.S. Pat. No. 2,839,405, thiuronium salts described in U.S. Pat. No. 3,220,839, palladium, platinum and gold salts described in U.S. Pat. Nos. 2,566,263 and 2,597,915, halogen-substituted organic compounds described in U.S. Pat. Nos. 4,108,665 and 4,442,202, triazines described in U.S. Pat. Nos. 4,128,557, 4,137,079, 4,138,365 and 4,459,350, and phosphorus compounds described in U.S. Pat. No. 4,411,985.

The antifoggant preferred in the present invention is an organic halide. In particular, polyhalomethyl compounds are more preferred and triallomethylsulfone compounds are still more preferred. Examples of the organic halide include compounds disclosed in JP-A-50-119624, JP-A-50-120328, JP-A-51-121332, JP-A-54-58022, JP-A-56-70543, JP-A-56-99335, JP-A-59-90842, JP-A-61-129642, JP-A-62-129845, JP-A-6-208191, JP-A-7-5621, JP-A-7-2781, JP-A-8-15809, JP-A-9-160167, JP-A-9-244177, JP-A-9-244178, JP-A-9-258367, JP-A-9-265150, JP-A-9-319022, JP-A-10-171063, JP-A-11-212211, JP-A-11-231460, JP-A-11-242304, and U.S. Pat. Nos. 5,340,712, 5,369,000 and 5,464,737. Specific examples include 2-(tribromomethylsulfone)quinoline, 2-(tribromomethylsulfone)pyridine, tribromomethylphenylsulfone and tribromomethylnaphthylsulfone.

Although not necessary for practicing the present invention, it is sometimes advantageous to add a mercury(II) salt as an antifoggant to the photosensitive layer. The mercury(II) salt preferred for this purpose includes mercury acetate and mercury bromide. The amount added of the mercury for use in the present invention is preferably from 1 nmol to 1 mmol, more preferably from 10 nmol to 100 μmol, per mol of silver coated.

The heat-developable photosensitive material of the present invention may contain benzoic acids for the purpose of elevating the sensitivity or preventing fog. The benzoic acids for use in the present invention may be any benzoic acid derivative but preferred examples of the structure include compounds described in U.S. Pat. Nos. 4,784,939 and 4,152,160, JP-A-9-281637, JP-A-9-329864 and JP-A-9-329865. The benzoic acids for use in the present invention may be added to any site of the photosensitive material but is preferably added to a layer on the surface having the photosensitive layer, more preferably to the organic silver salt-containing layer. As for the timing of adding benzoic acids, the addition may be performed in any step in the preparation of the coating solution. In the case of adding the benzoic acids to the organic silver salt-containing layer, the addition may be performed in any step from the preparation of organic silver salt to the preparation of the coating solution but is preferably performed between after the preparation of organic silver salt and immediately before the coating. The benzoic acids may be added in any form of a powder, a solution and a fine particle dispersion. The benzoic acids may also be added as a solution where other additives such as sensitizing dye, reducing agent and color toning agent are mixed. The amount of the benzoic acids added may be any amount but is preferably from 1 μmol to 2 mol, more preferably from 1 mmol to 0.5 mol, per mol of silver.

In the present invention, a mercapto compound, a disulfide compound and a thione compound may be contained for controlling the development by inhibiting or accelerating the development, for increasing the spectral sensitization efficiency or for enhancing the storability before and after development.

In the case of using a mercapto compound in the present invention, the mercapto compound may have any structure but is preferably represented by Ar-SM or Ar-S-S-Ar. In the formulae, M is a hydrogen atom or an alkali metal atom, and Ar is an aromatic or condensed aromatic ring having one or more atoms of nitrogen, sulfur, oxygen, selenium and tellurium. Preferred examples of the heteroaromatic ring include benzimidazole, naphthimidazole, benzothiazole, naphthothiazole, benzoxazole, naphthoxazole, benzoselenazole, benzotellurazole, imidazole, oxazole, pyrazole, triazole, thiadiazole, tetrazole, triazine, pyrimidine, pyridazine, pyrazine, pyridine, purine, quinoline and quinazolinone. This heteroaromatic ring may have a substituent, for example, selected from the group consisting of halogen (e.g., Br, C1), hydroxy, amino, carboxy, alkyl (for example, having one or more carbon atom, preferably from 1 to 4 carbon atoms) and alkoxy (for example, having one or more carbon atom, preferably from 1 to 4 carbon atoms). Examples of the mercapto-substituted heteroaromatic compound include 2-mercaptobenzimidazole, 2-mercaptobenzoxazole, 2-mercaptobenzothiazole, 2-mercapto-5-methylbenzimidazole, 6-ethoxy-2-mercaptobenzothiazole, 2,2′-dithiobis-(benzothiazole), 3-mercapto-1,2,4-triazole, 4,5-diphenyl-2-imidazolethiol, 2-mercaptoimidazole, 1-ethyl-2-mercaptobenzimidazole, 2-mercaptoquinoline, 8-mercaptopurine, 2-mercapto-4(3H)-quinazolinone, 7-trifluoromethyl-4-quinoline thiol, 2,3,5,6-tetrachloro-4-pyridine thiol, 4-amino-6-hydroxy-2-mercaptopyrimidine monohydrate, 2-amino-5-mercapto-1,3,4-thiadiazole, 3-amino-5-mercapto-1,2,4-triazole, 4-hydroxy-2-mercaptopyrimidine, 2-mercaptopyrimidine, 4,6-diamino-2-mercaptopyrimidine, 2-mercapto-4-methylpyrimidine hydrochloride, 3-mercapto-5-phenyl-1,2,4-triazole and 2-mercapto-4-phenyloxazole, however, the present invention is not limited thereto. The amount of the mercapto compound added is preferably from 0.001 to 1.0 mol, more preferably from 0.01 to 0.3 mol, per mol of silver in the photosensitive layer.

The plasticizer and lubricant which can be used in the photosensitive layer of the present invention are described in JP-A-11-65021 (paragraph No. 0117); the ultrahigh contrast-providing agent for the formation of an ultrahigh contrast image and the addition method or amount added thereof are described in JP-A-11-65021 (paragraph No. 0118), JP-A-11-223898 (paragraph Nos. 0136 to 0193), Japanese Patent Application Nos. 11-87297 (compounds represented by formula (H), formulae (1) to (3) and formulae (A) and (B)) and 11-91652 (compounds represented by formulae (III) to (V), specific compounds: Chem. 21 to Chem. 24); and the contrast-promoting agent is described in JP-A-11-65021 (paragraph No. 0102) and JP-A-11-223898 (paragraph Nos. 0194 to 0195).

The photosensitive layer containing the photo-sensitive silver halide grain for use in the present invention preferably has absorption (absorbance) of 0.1 to 0.6, more preferably from 0.2 to 0.5, at the exposure wavelength. If the absorption is large, Dmin increases and the image becomes difficult to discriminate, whereas if the absorption is small, the sharpness is impaired. In the present invention, the photosensitive layer may be rendered to have absorption by any method but use of a dye is preferred. The dye may be any dye as long as it satisfies the above-described absorption conditions and examples thereof include pyrazoloazole dyes, anthraquinone dyes, azo dyes, azomethine dyes, oxonol dyes, carbocyanine dyes, styryl dyes, triphenylmethane dyes, indoaniline dyes, indophenol dyes and squarylium dyes. Among these dyes, preferred in the present invention are anthraquinone dyes (e.g., Compounds 1 to 9 described in JP-A-5-341441, Compounds 3-6 to 3-18 and 3-23 to 3-38 described in JP-A-5-165147), azomethine dyes (e.g., Compounds 17 to 47 described in JP-A-5-341441), indoaniline dyes (e.g., Compounds 11 to 19 described in JP-A-5-289227, Compound 47 described in JP-A-5-341441, Compounds 2-10 and 2-11 described in JP-A-5-165147), azo dyes (e.g., Compounds 10 to 16 described in JP-A-5-341441) and squarylium dyes (e.g., Compounds 1 to 20 described in JP-A-10-104779, Compounds 1a to 3d described in U.S. Pat. No. 5,380,635). This dye may be added in any form of a solution, an emulsified product and a solid fine particle dispersion or may be added in the state mordanted with a polymer mordant. The amount of such a compound used may be determined according to the objective amount absorbed but, in general, the compound is preferably used in an amount of 1 μg/m² to 1 g/m².

In the present invention, any constituent layer except for the photosensitive layer containing the photosensitive silver halide grain preferably has an absorption (absorbance) of 0.1 to 3.0 and from the standpoint of preventing halation, more preferably from 0.3 to 2.0, at the exposure wavelength. The portion having an absorbance in the above-described range at the exposure wavelength is preferably a layer opposite the photosensitive layer with respect to the support (a back layer, a back surface undercoat or subbing layer or a protective layer of the back layer) or a layer between the support and the photosensitive layer containing the photosensitive silver halide grain (an undercoat or subbing layer).

In the case where the photosensitive silver halide grain is spectrally sensitized to the infrared region, the portion except for the photosensitive layer may be rendered to have absorption by any method but is preferably rendered to have an absorption maximum of 0.3 or less in the visible region. Examples of the dye which can be used for rendering the portion to have absorption are the same as those of the dye which can be used for rendering the photosensitive layer to have absorption. The dye may be the same or different from the dye used for the photosensitive silver halide layer.

In the second embodiment of the present invention, the layer opposite the photosensitive silver halide grain-containing layer with respect to the support (a back layer, a back surface undercoat or subbing layer or a protective layer of the back layer) preferably has an absorption of 0.3 to 2.0 and from the standpoint of preventing halation, more preferably from 0.4 to 2.0, at the wavelength from 750 to 1,400 nm. In the case where the photosensitive silver halide grain is spectrally sensitized to the infrared region, the absorption maximum in the region from 400 to 700 nm is preferably from 0.001 to 0.5. Examples of the dye which can be used for coloration are the same as those of the dye which can be used for rendering the photosensitive layer to have absorption. The dye may be the same or different from the dye used for the photosensitive silver halide layer.

In the case where the photosensitive silver halide grain is spectrally sensitized to the visible region, the portion except for the photosensitive layer may be rendered to have absorption by any method but a dye capable of decolorizing by a heat treatment or a combination of a compound capable of decolorizing dye by a heat treatment and a dye decolorized is preferably used. Examples of the dye capable of decolorizing and the compound capable of decolorizing dye include those described in JP-A-52-139136, JP-A-53-132334, JP-A-56-501480, JP-A-57-16060, JP-A-57-68831, JP-A-57-101835, JP-A-59-182436, JP-A-7-36145, JP-A-7-199409, JP-B-48-33692, JP-B-50-16648, JP-B-2-41734 and U.S. Pat. Nos. 4,088,497, 4,283,487, 4,548,896 and 5,187,049, however, the present invention is not limited thereto. The amount of this compound used may be determined according to the objective amount absorbed but, in general, the compound is preferably used in an amount of 1 μg/m² to 1 g/m².

In the heat-developable photosensitive material of the present invention, a surface protective layer may be provided for the purpose of preventing adhesion of the photosensitive layer (image-forming layer). For the binder in the surface protective layer, any polymer may be used. Examples of the binder include polyester, gelatin, polyvinyl alcohol and cellulose derivative. Among these, cellulose derivative is preferred. Examples of the cellulose derivative include cellulose acetate, cellulose acetate butyrate, cellulose propionate, hydroxypropyl cellulose, hydroxypropyl methyl cellulose, methyl cellulose, hydroxyethyl cellulose, carboxymethyl cellulose and a mixture thereof, but the present invention is not limited thereto.

In the present invention, the thickness of the surface protective layer is preferably from 0.1 to 10 μm, more preferably from 1 to 5 μm.

For the surface protective layer, any adhesion preventing material may be used. Examples of the adhesion preventing material include wax, liquid paraffin, silica particle, styrene-containing elastomeric block copolymer (e.g., styrene-butadiene-styrene, styrene-isoprene-styrene), cellulose acetate, cellulose acetate butyrate, cellulose propionate and a mixture thereof.

In the present invention, a light absorbing substance and a filter dye described in U.S. Pat. Nos. 3,253,921, 2,274,782, 2,527,583 and 2,956,879 may be used in the photosensitive layer or the protective layer of the photosensitive layer. Also, the dye may be mordanted as described, for example, in U.S. Pat. 3,282,699. The filter dye is preferably used in an amount of giving an absorbance of 0.1 to 3, more preferably from 0.2 to 1.5, at the exposure wavelength.

In the present invention, the photosensitive layer or the protective layer of the photosensitive layer may contain a matting agent such as starch, titanium dioxide, zinc oxide, silica and polymer beads including beads of the type described in U.S. Pat. Nos. 2,992,101 and 2,701,245. The matting degree on the emulsion surface may be any value insofar as a so-called stardust failure such as small white spot on the image area and light leakage does not occur but is preferably, in terms of the Bekk smoothness, from 200 to 10,000 seconds, more preferably from 300 to 10,000 seconds.

In the heat-developable photosensitive material of the present invention, the photosensitive layer is composed of one or more layer(s) on the support. In the case where the photosensitive layer is composed of a single layer, the layer must contain an organic silver salt, a silver halide, a reducing agent and a binder and if desired, additionally contain desired materials such as a color toning agent, a coating aid and other adjuvants. In the case where the photosensitive layer is composed of two or more layers, the first photosensitive layer (usually a layer adjacent to the substrate) must contain an organic silver salt and a silver halide and the second photosensitive layer or these two layers must contain some other components. A two-layer structure constituted by a single photosensitive layer containing all components and a protective topcoat may also be used. In the structure of a multicolor photosensitive heat-developable photographic material, a combination of these two photosensitive layers may be provided for each color or as described in U.S. Pat. No. 4,708,928, all the components may be contained in a single photosensitive layer. In the case of a multi-dye multicolor photosensitive heat-developable photographic material, the photosensitive layers are generally held separately from each other by interposing a functional or nonfunctional barrier layer between respective photosensitive layers as described in U.S. Pat. No. 4,460,681.

The heat-developable photosensitive material of the present invention is preferably a so-called one-side photosensitive material having at least one photosensitive layer containing a silver halide emulsion in one side of the support and having a back layer in the other side.

In the present invention, a matting agent may be added for improving the conveyance property. The matting agent is generally a water-insoluble organic or inorganic compound fine particle. Any matting agent may be used and examples thereof include compounds well-known in the art such as organic matting agents described in U.S. Pat. Nos. 1,939,213, 2,701,245, 2,322,037, 3,262,782, 3,539,344 and 3,767,448, and inorganic matting agents described in U.S. Pat. Nos. 1,260,772, 2,192,241, 3,257,206, 3,370,951, 3,523,022 and 3,769,020. Specifically, preferred examples of the organic compound which can be used as the matting agent include water-dispersible vinyl polymers such as polymethyl acrylate, polymethyl methacrylate, polyacrylonitrile, acrylonitrile-α-methylstyrene copolymers, polystyrene, styrene-divinyl-benzene copolymers, polyvinyl acetate, polyethylene carbonate and polytetrafluoroethylene; cellulose derivatives such as methyl cellulose, cellulose acetate and cellulose acetate propionate; starch derivatives such as carboxy starch, carboxynitrophenyl starch, urea-formaldehyde-starch reaction products, gelatin hardened with a well-known hardening agent, and hardened gelatin obtained by the coacervation-hardening into a capsule hollow fine particle. Preferred examples of the inorganic compound include silicon dioxide, titanium dioxide, magnesium dioxide, aluminum oxide, barium sulfate, calcium carbonate, silver chloride desensitized by a known method, silver bromide desensitized by a well-known method, glass and diatomaceous earth. These matting agents may be used as a mixture of different substances, if desired. The shape of the matting agent is not particularly limited and a matting agent in any shape may be used. In practicing the present invention, the matting agent used preferably has an average particle size of 0.1 to 30 μm, more preferably from 3 to 10 μm. In the particle size distribution of the matting agent, the coefficient of variation is preferably 50% or less. On the other hand, the matting agent greatly affects the haze and surface gloss of the photosensitive material and therefore, the particle size, shape and particle size distribution are preferably adjusted as desired during preparation of the matting agent or by mixing a plurality of matting agents.

In the present invention, the layer to which the matting agent can be incorporated includes an outermost layer (may be the photosensitive layer or the back layer) on the photosensitive layer surface or the back surface, the protective layer and the undercoat layer. The matting is preferably contained in the outermost surface layer, a layer acting as the outermost surface layer, a layer close to the outer surface, or a layer acting as a protective layer.

In the present invention, the matting degree on the back surface is preferably, in terms of Bekk smoothness, from 10 to 250 seconds, more preferably from 50 to 180 seconds.

In the second embodiment of the present invention, this Bekk smoothness is preferably from 10 to 500 seconds, more preferably from 30 to 400 seconds.

In the present invention, the binder suitable for the back layer is transparent or translucent and generally colorless. Examples thereof include natural polymers, synthetic resins, polymers, copolymers and film-forming mediums such as gelatin, gum arabi, poly(vinyl alcohol), hydroxyethyl cellulose, cellulose acetates, cellulose acetate butyrate, poly(vinylpyrrolidone), casein, starch, poly(acrylic acid), poly(methyl methacrylate), poly(vinyl chloride), poly(methacrylic acid), styrene-maleic anhydride copolymer, styrene-acrylonitrile copolymer, styrene-butadiene copolymer, poly(vinyl acetals) (e.g., poly(vinyl formal), poly(vinyl butyral)), poly(esters), poly(urethanes), phenoxy resin, poly(vinylidene chloride), poly(epoxides), poly(carbonates), poly(vinyl acetate), cellulose esters and poly(amides). The binder may also be coated and formed from water, an organic solvent or an emulsion.

In the photosensitive heat-developable photographic image system, a backside resistive heating layer described in U.S. Pat. Nos. 4,460,681 and 4,374,921 may also be used.

In the present invention, a hardening agent may be used in each layer such as photosensitive layer, protective layer and back layer, as described above. Examples of the hardening agent include, in addition to those described above, polyisocyanates described in U.S. Pat. No. 4,281,060 and JP-A-6-208193, epoxy compounds described in U.S. Pat. No. 4,791,042, and vinylsulfone-base compounds described in JP-A-62-89048.

In the present invention, a surfactant may be used for the purpose of improving electric charging. Examples of the surfactant include nonionic surfactants, anionic surfactants, cationic surfactants and fluorine-containing surfactants, and any of these surfactants can be appropriately used. Specific examples thereof include fluorine-containing polymer surfactants described in JP-A-62-170950 and U.S. Pat. No. 5,380,644, fluorine-containing surfactants described in JP-A-60-244945 and JP-A-63-188135, polysiloxane-base surfactants described in U.S. Pat. No. 3,885,965, and polyalkylene oxide and anionic surfactants described in JP-A-6-301140. Among these surfactants, preferred are fluorine-containing anionic surfactants. In the present invention, any one of the constituent layers of the heat-developable photosensitive material preferably contains a fluorine-containing ionic surfactant, more preferably a fluorine-containing anionic surfactant.

In the present invention, the photosensitive layer may be coated on various supports. Typical examples of the support include polyester film, undercoated polyester film, poly(ethylene terephthalate) film, polyethylene naphthalate film, cellulose nitrate film, cellulose ester film, poly(vinyl acetal) film, polycarbonate film, related or resinous materials, glass, paper and metals. A flexible support, particularly, a paper support coated with partially acetylated or baryta and/or α-olefin polymer, preferably an α-olefin polymer having from 2 to 10 carbon atoms, such as polyethylene, polypropylene and ethylene-butene copolymer, is typically used. The support may be transparent or opaque but is preferably transparent.

The heat-developable photosensitive material of the present invention may have an antistatic or electrically conducting layer, for example, a layer containing a soluble salt (e.g., chloride, nitrate), a vapor deposited metal layer, a layer containing an ionic polymer described in U.S. Pat. Nos. 2,861,056 and 3,206,312, or a layer containing an insoluble organic salt described in U.S. Pat. No. 3,428,451.

As for the method for obtaining a color image using the heat-developable photosensitive material of the present invention, the method described in JP-A-7-13295 (from page 10, left column, line 43 to page 11, left column, line 40) may be used. As for the stabilizer of the color dye image, those described in British Patent 1,326,889 and U.S. Pat. Nos. 3,432,300, 3,698,909, 3,574,627, 3,573,050, 3,764,337 and 4,042,394 may be used.

As for the coating method of the heat-developable photosensitive material of the present invention, various coating operations including dip coating, air knife coating, flow coating or extrusion coating using a hopper of the type described in U.S. Pat. No. 2,681,294 may be used. If desired, two or more layers may be simultaneously coated by the method described in U.S. Pat. No. 2,761,791 and British Patent 837,095.

The heat-developable photosensitive material of the present invention may contain additional layers such as a dye-receiving layer for receiving a moving dye image, an opacifying layer in the case where reflection printing is desired, a protective topcoat layer, and a primer layer known in the light-heat photographic technology. It is preferred that the photosensitive material of the present invention can form an image only by one sheet of the photosensitive material and the functional layer necessary for forming an image, such as image-receiving layer, is not provided as a different photosensitive material.

The heat-developable photosensitive material of the present invention may be developed by any method but is usually developed by elevating the temperature of the photosensitive material after imagewise exposure. The development temperature is preferably from 80 to 250° C., more preferably from 100 to 140° C., and the development time is preferably from 1 to 180 seconds, more preferably from 10 to 90 seconds.

The heat-developable photosensitive material of the present invention may be exposed by any method but is preferably exposed by using laser light as the exposure light source and scanning a laser ray from the side having the photosensitive layer of the photosensitive material. Preferred examples of the scan laser light which can be used in the present invention include a gas laser, a dye laser and a semiconductor laser. Also, a semiconductor laser or a YAG laser and a second harmonic generation device may be used.

The dye represented by formula (1) for use in the present invention is known to have infrared absorption and is effective for preventing halation and irradiation in the infrared region. Therefore, in view of color sensitivity, the photosensitive material using the dye of the present invention is preferably exposed by an infrared laser having a wavelength of 700 to 1,400 nm.

In the present invention, the scanning layer ray is preferably in a longitudinal multiple mode. The longitudinal multiple mode means that the exposure wavelength is not single. Usually, the exposure wavelength distribution is 5 nm or more, preferably 10 nm or more. The upper limit of the exposure wavelength is not particularly limited but is usually about 60 nm. The longitudinal multiple mode is preferably obtained by wave synthesis, use of return light, or high frequency superposition. As compared with scanning laser light in a longitudinal single mode, deterioration of image quality, such as generation of interference fringe unevenness, is reduced.

The scanning laser ray incident on the exposure surface of the photosensitive material usually creates a vertical angle but in the present invention, preferably creates substantially no vertical angle. The “substantially” as used herein means that the angle closest to the vertical angle created during the laser scanning is preferably from 55 to 88°, more preferably from 60 to 86°, still more preferably from 65 to 84°, and most preferably from 70 to 82°. By performing the exposure with a laser ray incident at such an angle, the obtained image can be reduced in the deterioration of image quality ascribable to interference fringe unevenness and can have good sharpness and contrast.

The present invention is described in greater detail below by referring to Examples, however, the present invention should not be construed as being limited to these Examples.

### EXAMPLE 1

<Preparation of Iridium-Doped Core/Shell-Type Silver Bromoiodide Emulsion>

To a first solution kept at 34° C., which was prepared by dissolving 30 g of phthalated gelatin and 71.4 mg of KBr in 1,500 ml of deionized water and adjusted to a pH of 5.0 with 3 mol/liter of nitric acid, a solution obtained by dissolving 27.4 g of KBr and 3.3 g of KI in 275 ml of deionized water and a solution obtained by dissolving 42.5 g of silver nitrate in 364 ml of deionized water were simultaneously added over 9.5 minutes. Thereafter, a solution obtained by dissolving 179 g of KBr and 10 mg of dipotassium hexachloroiridate in 812 ml of deionized water and a solution obtained by dissolving 127 g of silver nitrate in 1,090 ml of deionized water were simultaneously mixed over 28.5 minutes. Here, the pAg was kept constant using a pAg feedback control loop described in Research Disclosure, No. 17643, and U.S. Pat. Nos. 3,415,650, 3,782,954 and 3,821,002.

The obtained emulsion was washed and desalted. The average grain size was 0.045 μm. The silver halide grain size was determined by a transmission electron microscope (TEM).

<Preparation of Iridium-Doped Previously Formed Silver Halide/Organic Silver Salt Dispersion Solution>

In 13 liter of water, 118 g of Humko-type fatty acid 9718 (produced by Witco, Memphis, Tenn.) and 570 g of Humko-type fatty acid 9022 (produced by Witco, Memphis, Tenn.) were dissolved at 80° C. and mixed for 15 minutes. Thereto, a solution obtained by dissolving 89.18 g of NaOH in 1.5 liter of water was added at 80° C. and mixed for 5 minutes to form a dispersion solution. To this dispersion solution, a solution obtained by diluting 19 ml of concentrated nitric acid with 50 ml of water was added at 80° C. and the dispersion solution was cooled to 55° C. and stirred for 25 minutes. Thereafter, 0.10 mol of the silver halide emulsion doped above with iridium and previously formed to 700 g/mol in 1.25 liter of water at 42° C. was added to the dispersion solution at 55° C. and mixed for 5 minutes. Furthermore, a solution obtained by dissolving 365 g of silver nitrate in 2.5 liter of water was added at 55° C. and mixed for 10 minutes. The obtained silver halide/organic silver salt dispersion solution was desalted, washed and concentrated by centrifugal filtration until the electrical conductivity of washing water became 2 es/cm and then dried with hot air at 45° C. for 72 hours.

The thus-prepared silver halide/organic silver salt dispersion solution (209 g) was mixed in 780 g of methyl ethyl ketone (MEK) and 11 g of polyvinyl butyral (Butvar B-79, produced by Monsanto) while stirring for 10 minutes. The resulting mixture was left standing at 7° C. over night and then homogenized twice under the condition of 6,000 psi (about 41 MPa) to prepare a silver soap dispersion solution.

Silver soap dispersions were also prepared by changing the polyvinyl butyral to other binders (shown in Table 1) in the same weight.

<Preparation of Coating Solution for Photosensitive Layer>

The preformed silver soap dispersion solution (507 g) was stirred at 13° C. for 15 minutes and thereto, 3.9 ml of a methanol solution containing 10 mass % of pyridinium hydrobromide perbromide (PHP) was added. After stirring for 2 hours, 5.2 ml of a methanol solution containing 11 mass % of calcium bromide was added. The stirring was continued for 30 minutes and then, 117 g of Butvar B-79 was added. After further stirring for 30 minutes, 27.3 g of 1,1-bis(2-hydroxy-3,5-dimethylphenyl)-2-methylpropane was added and the dispersion solution was further stirred for 15 minutes. Thereafter, 2.73 g of 2-(tribromomethylsulfonyl)quinoline was added and the dispersion solution was further stirred for 15 minutes. This was added to a solution obtained by dissolving 1.39 g of Desmodur N3300 (aliphatic isocyanate, produced by MOBEY) in 12.3 g of MEK and the resulting dispersion solution was further stirred for 15 minutes and then heated at 21° C. for 15 minutes.

To 100 g of the obtained dispersion solution, 1 mg of Dye C, 0.47 g of 4-chlorobenzophenone-2-carboxylic acid, 0.043 g of 5-methyl-2-mercaptobenzimidazole were added and stirred at 21° C. for 1 hour. Subsequently, 0.368 g of phthalazine, 0.123 g of tetrachlorophthalic acid and 2 g of Dyestuff C were added and furthermore, the aziridine compound, epoxy compound or carbodiimide compound of the present invention was added to have a coated amount shown in Table 1, thereby obtaining a coating solution for photosensitive layer.

<Preparation of Coating Solution for Surface Protective Layer>

In 512 g of MEK, 61 g of methanol, 48 g of cellulose acetate butyrate (CAB171-15S, produced by Eastman Chemical), 2.08 g of 4-methylphthalic acid, 3.3 g of an MEK solution containing 16 mass % of Fluorine-Containing Polymer Surfactant C, 1.9 g of polymethyl methacrylate (Acryloid A-21, produced by Rhom & Haas) and 0.5 g of 1,3-di(vinylsulfonyl)-2-propanol were mixed at room temperature to prepare a coating solution for surface protective layer.

<Coating of Back Surface>

To 786.7 g of an MEK solution containing 12.6 mass % of cellulose acetate butyrate (CAB380-20, produced by Eastman Chemical) and 0.17 mass % of polyester (Vitel TM PE-200, produced by Goodyear), 0.9 g of Dyestuff C and 78.7 g of MEK were added and subsequently, 78.7 g of a solution obtained by dispersing 0.38 mass % of a silica matting agent having an average particle size of 8 μm and a coefficient of variation of 40% in MEK was added. Furthermore, 15.7 g of Antistatic Agent C and 3.93 g of MEK were added and stirred to obtain a coating solution for back surface.

The thus-obtained coating solution for back surface was coated to a thickness of 76 μm on a 176 μm-thick blue-tinted polyethylene terephthalate support and then dried. Here, the transmission density (absorbance) was 0.39 to light at a wavelength of 800 nm.

<Preparation of Photosensitive Material>

Thereafter, the coating solution for photosensitive layer and the coating solution for surface protective layer were simultaneously coated by a dual knife coater. The coating solution for photosensitive layer was coated on the support to a wet thickness of giving a dry thickness of 18.3 μm and the coating solution for surface protective layer was coated on the photosensitive layer to a wet thickness of giving a dry thickness of 3.4 μm. The coating apparatus used was composed of two knife coating blades standing side by side. The support was cut into a length matching the volume of solution used and then the knives each with a hinge were elevated and disposed to the position on a coater floor. Subsequently, the knives were lowered and fixed to a predetermined position. The height of the knives was adjusted by using a wedge which is controlled by a screw knob and measured by an ammeter. Knife #1 was elevated to the space corresponding to the thickness as a total of the thickness of support and the desired wet thickness of photosensitive layer (Layer #1) and Knife #2 was elevated to the height equal to the desired thickness as a total of support+photosensitive layer (Layer #1) having a desired wet thickness+topcoat layer (Layer #2) having a desired thickness. The drying was performed under 4 conditions of 70° C. for 3 minutes, 80° C. for 10 minutes, 90° C. for 10 minutes, and for 50 minutes (in this order, referred to as Drying Conditions 1 to 4).

Chemical structures of compounds used in Example 1 are shown below.

Dye C:

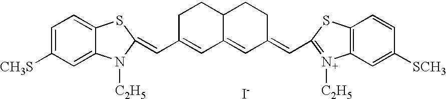

Dyestuff C:

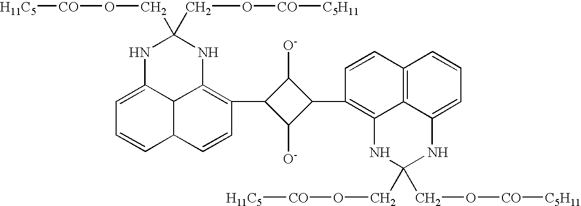

Fluorine-Containing Polymer Surfactant C:

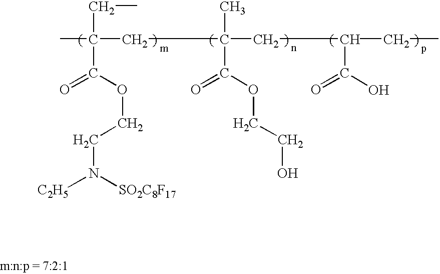

Antistatic Agent C:

C₈F₁₇—SO₃⁻H₃⁺N(CH₂—CH₂—O)₁₂ CH₂—CH₂—NH₃⁺C₈F₁₇—SO₃⁻

(Measurement of Sensitivity)

The coated and dried photosensitive material was cut into a specimen of 1.5 inch×8 inch (3.8cm×20.3 cm) and exposed by an exposure machine using, as the exposure light source, a semiconductor laser formed into a longitudinal multiple mode of a wavelength from 800 to 820 nm by means of high frequency superposition. The laser ray was irradiated at an incident angle of 75° on the exposure surface. After the exposure, the film specimen was developed under heating at 124° C. for 15 seconds using an automatic developing machine having a heat drum while contacting the protective layer of the photosensitive material with the drum surface, thereby obtaining an image. The obtained image was evaluated by a commercially available densitometer.

(Evaluation of Image Preservability)

The sample heat-developed for the purpose of sensitivity measurement was stored in an environment at 30° C. and a relative humidity of 70% under a fluorescent lamp of 1,000 Lux for 24 hours and then evaluated on the image density. The image preservability was evaluated by the increase of density in the Dmin area.

(Evaluation of Odor Intensity)

As described above, the odor in the sample bag at 120° C. was collected by an order discriminator FF-1 (manufactured by Shimadzu Corporation, a temperature rising thermal desorption concentration system by a carbon-type collector tube, oxide semiconductor sensor, 6 sensors) and the odor intensity SC1 (numerical value of SC1 axis) was measured. This value of SC1 axis is a value calibrated by the method described above.

The odor intensity was evaluated by the value of SC1 axis.

(Measurement of Amount of Solvent in Photosensitive Material)

The stock photosensitive material (25 cm²) before development was sampled and enclosed in a 10 ml-volume vial, thereby preparing a sample for measurement. This sample was measured by HP 5890 SERIES II GC. The solvent content in each sample was measured under the conditions of column DB-WAX (30 m×1.0 mmid), He gas of 20 ml/min, injection at 250° C. and detector FID. At this time, the head space conditions were such that the bath temperature was 120° C. and the heating time was 30 minutes.

The evaluation results are shown in Table 1.

TABLE 1

| | | Additives | | | Solvent Content | Odor | Photographic | | | |
|---|---|---|---|---|---|---|---|---|---|---|
| Sample | Kind of | | Amount | Drying | in Photosensitive | Intensity, | Performance | | Image Preservability, | |
| No. | Binder | Kind | (mol/m²) | Condition | Material (mg/m²) | SCl value | Dmin | Sensitivity | increase of Dmin | Remarks |
| 1 | *1 | — | — | 1 | 150 | 2 | 0.15 | 98 | 0.18 | Comparison |
| 2 | *1 | — | — | 2 | 70 | 0.7 | 0.16 | 100 | 0.07 | Invention |
| 3 | *1 | — | — | 3 | 10 | −0.5 | 0.16 | 100 | 0.06 | Invention |
| 4 | *1 | — | — | 4 | 3 | −3.5 | 0.17 | 102 | 0.14 | Comparison |
| 5 | *1 | AZ-2 | 3 × 10⁻³ | 1 | 125 | 1.8 | 0.16 | 97 | 0.17 | Comparison |
| 6 | *1 | AZ-2 | 3 × 10⁻³ | 2 | 65 | 0.9 | 0.16 | 100 | 0.04 | Invention |
| 7 | *1 | AZ-2 | 3 × 10⁻³ | 3 | 8 | −1 | 0.17 | 100 | 0.03 | Invention |
| 8 | *1 | AZ-2 | 3 × 10⁻³ | 4 | 3 | −3.3 | 0.18 | 103 | 0.12 | Comparison |
| 9 | *1 | EP-2 | 3 × 10⁻³ | 2 | 95 | 0.6 | 0.16 | 101 | 0.04 | Invention |
| 10 | *1 | CDI-1 | 3 × 10⁻³ | 2 | 85 | 0.5 | 0.16 | 100 | 0.03 | Invention |
| 11 | *2 | EP-2 | 3 × 10⁻³ | 1 | 110 | 1.8 | 0.16 | 99 | 0.15 | Comparison |
| 12 | *2 | EP-2 | 3 × 10⁻³ | 2 | 70 | 0.4 | 0.17 | 100 | 0.04 | Invention |
| 13 | *2 | EP-2 | 3 × 10⁻³ | 3 | 10 | −0.3 | 0.17 | 100 | 0.05 | Invention |
| 14 | *2 | EP-2 | 3 × 10⁻³ | 4 | 2 | −3.5 | 0.17 | 103 | 0.12 | Comparison |
| 15 | *3 | AZ-4 | 3 × 10⁻³ | 1 | 95 | 1.5 | 0.15 | 100 | 0.13 | Comparison |
| 16 | *3 | AZ-4 | 3 × 10⁻³ | 2 | 40 | 0 | 0.16 | 100 | 0.03 | Invention |
| 17 | *3 | AZ-4 | 3 × 10⁻³ | 3 | 6 | −0.8 | 0.16 | 102 | 0.04 | Invention |
| 18 | *3 | AZ-4 | 3 × 10⁻³ | 4 | 2 | −4 | 0.16 | 103 | 0.13 | Comparison |
| 19 | *3 | EP-16 | 3 × 10⁻³ | 1 | 105 | 1.9 | 0.16 | 99 | 0.11 | Comparison |
| 20 | *3 | EP-16 | 3 × 10⁻³ | 2 | 55 | 0.2 | 0.17 | 101 | 0.05 | Invention |
| 21 | *3 | EP-16 | 3 × 10⁻³ | 3 | 8 | −1 | 0.17 | 102 | 0.04 | Invention |
| 22 | *3 | EP-16 | 3 × 10⁻³ | 4 | 3 | −3.8 | 0.17 | 102 | 0.15 | Comparison |
| 23 | *4 | CDI-1 | 3 × 10⁻³ | 2 | 65 | 0.3 | 0.16 | 100 | 0.08 | Invention |
| 24 | *4 | EP-2 | 3 × 10⁻³ | 3 | 80 | 0.7 | 0.16 | 98 | 0.08 | Invention |
| 25 | *4 | AZ-2 | 3 × 10⁻³ | 3 | 53 | 0.6 | 0.15 | 101 | 0.07 | Invention |

Kind of Binder:
*1: polyvinyl butyral,
*2: polyvinyl butyral carboxyl group derivative (monomer:carboxyl group = 1:1),
*3: cellulose acetate butyrate,
*4: polystyrene
Kind of Additive:
CDI-1: N,N′-di(4-dimethylaminophenyl) carbodiimide

As is apparent from Table 1, the heat-developable photosensitive material of the present invention is excellent in the image preservability.

### EXAMPLE 2

(Preparation of Support)

Both surfaces of a 175 μm-thick PET film colored blue to a density of 0.160 were subjected to a corona discharge treatment of 8 w/m²·min.

[Preparation of Photosensitive Emulsion]

(Preparation of Photosensitive Silver Halide Emulsion)

In 900 ml of water, 7.5 g of ossein gelatin having an average molecular weight of 100,000 and 10 mg of potassium bromide were dissolved. The resulting solution was adjusted to a temperature of 35° C. and a pH of 3.0 and thereto, 370 ml of an aqueous solution containing 74 g of silver nitrate and 370 ml of an aqueous solution containing potassium bromide and potassium iodide at a molar ratio of 98/2 and containing iridium chloride in an amount of 1×10⁻⁴ mol per mol of silver were added by a controlled double jet method over 10 minutes while keeping the pAg at 7.7. Thereafter, 0.3 g of 4-hydroxy-6-methyl-1,3,3a,7-tetraza-indene was added and the pH was adjusted to 5 with NaOH to obtain a cubic silver iodobromide grain having an average grain size of 0.06 μm, a coefficient of variation in the grain size of 12% and a [100] face percentage of 87%. This emulsion was desalted by flocculating and precipitating silver halide grains using a gelatin coagulant, 0.1 g of phenoxyethanol was added thereto, and the pH and the pAg were adjusted to 5.9 and 7.5, respectively, thereby obtaining a photosensitive silver halide emulsion.

The temperature of the thus-obtained photosensitive silver halide emulsion was elevated to 55° C. and thereto, 5×10⁻⁵ mol of Compound A was added. Subsequently, 7×10⁻⁵ mol of ammonium thiocyanate and 5.3×10⁻⁵ mol of chloroauric acid were added. Furthermore, 0.3 mol % of silver iodide fine grain was added. After ripening for 100 minutes, the emulsion was cooled to 38° C. to complete the chemical sensitization and thereby obtain a silver halide grain. Here, the amount added is a value per 1 mol of AgX.

Compound A:

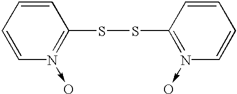

(Preparation of Powdery Organic Silver Salt)

In 4,720 ml of pure water, 111.4 g of behenic acid, 83.8 g of arachidinic acid and 54.9 g of stearic acid were dissolved at 80° C. Thereto, 540.2 ml of an aqueous 1.5M sodium hydroxide solution was added while stirring at a high speed and after 6.9 ml of concentrated nitric acid was added, the resulting solution was cooled to 55° C. to obtain an organic acid sodium solution. While keeping the organic acid sodium solution at a temperature of 55° C., the silver halide grain (containing 0.038 mol of silver) and 450 ml of pure water were added. Thereto, 760.6 ml of a 1M silver nitrate solution was added over 2 minutes and after stirring for 20 minutes, water-soluble salts were removed by filtration. Subsequently, centrifugal dehydration was performed by repeating washing with deionized water and filtration until the electrical conductivity of filtrate became 2 μS/cm. Then, drying was performed in a heated nitrogen stream until the weight loss did not occur, thereby obtaining a powdery organic silver salt.

(Preparation of Photosensitive Emulsion Dispersion Solution)

In 1,457 g of methyl ethyl ketone, 14.57 g of polyvinyl butyral powder (Butvar B-79, produced by Monsanto) was dissolved. While stirring by a dissolver-type homogenizer, 500 g of the powdery organic silver salt was gradually added and thoroughly mixed. The obtained mixture was dispersed using a media-type mill (manufactured by Gettzmann) filled in 80% with 1-mm Zr beads (produced by Toray Industries, Inc.) at a peripheral speed of 13 m and a residence time in mill of 0.5 minutes to prepare a photosensitive emulsion dispersion solution.

[Preparation of Coating Solution for Photosensitive Layer]

In 500 g of the photosensitive emulsion dispersion solution prepared above, 100 g of methyl ethyl ketone (MEK) was added while stirring in a nitrogen stream. The resulting solution was kept at 24° C. Thereto, Antifoggant 1 (a 10% methanol solution, 2.50 ml) shown below was added and stirred for 1 hour and furthermore, calcium bromide (a 10% methanol solution, 4 ml) was added and stirred for 15 minutes. Thereafter, 1.8 ml of a 1:5 mixed solution of a dye adsorption aid shown below and potassium acetate (a 20 wt % ethanol solution of the dye adsorption aid) was added and stirred for 15 minutes. Thereto, a mixed solution of the same infrared sensitizing dye (Dye C) as in Example 1, 4-chloro-2-benzoyl benzoic acid and a supersensitizer (5-methyl-2-mercaptobenzimidazole) (mixing ratio: 1:250:20, a 0.1% methanol solution of the sensitizing dye, 7 ml) was added and stirred for 1 hour. After lowering the temperature to 13° C., the solution was further stirred for 30 minutes. While keeping the solution at 13° C., 48 g of polyvinyl butyral was added and thoroughly dissolved. Thereafter, the following additives were added. (These operations all were performed in a nitrogen stream.)

| Phthalazine | 1.5 | g |
|---|---|---|
| Tetrachlorophthalic acid | 0.5 | g |
| 4-Methylphthalic acid | 0.5 | g |
| Same dyestuff as in | in an amount of giving | |
| Example 1 | an absorbance of 0.9 at | |
| | the absorption maximum | |
| | of dyestuff | |
| Developer (1,1-bis(2-hydroxy-3,5- | 15 | g |
| dimethylphenyl)-2-methylpropane) | | |
| Desmodur N3300 (aliphatic isocyanate, | 1.10 | g |
| produced by MOBEY) | | |
| Antifoggant 2 (2-(tribromomethyl- | 1.55 | g |
| sulfonyl)-quinoline) | | |
| Antifoggant 3 | 0.9 | g |

Dye Adsorption Aid:

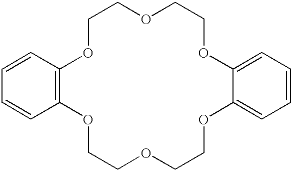

Antifoggant 1:

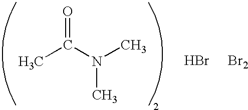

Antifoggant 3:

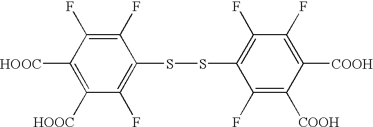

<Coating of Photosensitive Layer Side>

Photosensitive Layer:

The solution having the above-described composition was coated on the support prepared above such that the coated silver amount was 1.8 g/m², the coated amount of polyvinyl butyral as the binder was 8.5 g/m², and the coated amount of aziridine compound, epoxy compound or carbodiimide compound of the present invention was as shown in Table 2.

<Surface Protective Layer>

A solution having the following composition was coated on the photosensitive layer to have a wet thickness of 100 μm.

| Acetone | 175 | ml |
|---|---|---|
| 2-Propanol | 40 | ml |
| Methanol | 15 | ml |
| Cellulose acetate | 8 | g |
| Phthalazinone (a 4.5% DMF solution) | 8 | ml |
| Phthalazine | 1.5 | g |
| 4-Methylphthalic acid | 0.72 | g |
| Tetrachlorophthalic acid | 0.22 | g |
| Tetrachlorophthalic anhydride | 0.5 | g |
| Monodisperse silica having an average | 1 | wt % |
| particle size of 4 μm (coefficient of | based on | |
| variation: 20%) | binder | |
| Fluorine-Containing Polymer Surfactant C | 0.5 | g |
| same as in Example 1 | | |

<Coating of Back Surface Side>

The same coating solution for back surface as in Example 1 was coated in the same manner as in Example 1.

Drying after the coating was performed under 4 conditions of 70° C. for 3 minutes, 80° C. for 10 minutes, 90° C. for 10 minutes, and 50 minutes (in this order, Drying Conditions 1 to 4) in the same manner as in Example 1.

The evaluation results are shown in Table 2.

TABLE 2

| | | | | Solvent Content | | | | | |
|---|---|---|---|---|---|---|---|---|---|
| | Additives | | | in | Odor | Photographic | | Image | |
| Sample | | Amount | Drying | Photosensitive | Intensity, | Performance | | Preservability, | |
| No. | Kind | (mol/m²) | Condition | Material (mg/m²) | SCl value | Dmin | Sensitivity | increase of Dmin | Remarks |
| 1 | — | — | 1 | 150 | 2.2 | 0.19 | 95 | 0.19 | Comparison |
| 2 | — | — | 2 | 70 | 0.7 | 0.18 | 101 | 0.07 | Invention |
| 3 | — | — | 3 | 10 | −0.5 | 0.16 | 100 | 0.06 | Invention |
| 4 | — | — | 4 | 3 | −3.5 | 0.17 | 104 | 0.15 | Comparison |
| 5 | AZ-3 | 3 × 10⁻³ | 1 | 135 | 2 | 0.16 | 98 | 0.17 | Comparison |
| 6 | AZ-3 | 3 × 10⁻³ | 2 | 60 | 0.8 | 0.16 | 100 | 0.05 | Invention |
| 7 | AZ-3 | 3 × 10⁻³ | 3 | 9 | −1.1 | 0.17 | 101 | 0.05 | Invention |
| 8 | AZ-3 | 3 × 10⁻³ | 4 | 4 | −3.7 | 0.18 | 103 | 0.12 | Comparison |
| 9 | EP-8 | 3 × 10⁻³ | 1 | 125 | 1.8 | 0.16 | 98 | 0.17 | Comparison |
| 10 | EP-8 | 3 × 10⁻³ | 2 | 55 | 0.7 | 0.16 | 101 | 0.05 | Invention |
| 11 | EP-8 | 3 × 10⁻³ | 3 | 8 | −1.1 | 0.17 | 100 | 0.04 | Invention |
| 12 | EP-8 | 3 × 10⁻³ | 4 | 2 | −3.3 | 0.18 | 104 | 0.12 | Comparison |

As is apparent from Table 2, the heat-developable photosensitive material of the present invention is excellent in the image preservability.

### EXAMPLE 3

<Preparation of Iridium-Doped Core/Shell-Type Silver Bromoiodide Emulsion>

To a first solution kept at 34° C., which was prepared by dissolving 30 g of phthalated gelatin and 71.4 mg of KBr in 1,500 ml of deionized water and adjusted to a pH of 5.0 with 3 mol/liter of nitric acid, a solution obtained by dissolving 27.4 g of KBr and 3.3 g of KI in 275 ml of deionized water and a solution obtained by dissolving 42.5 g of silver nitrate in 364 ml of deionized water were simultaneously added over 9.5 minutes. Thereafter, a solution obtained by dissolving 179 g of KBr and 10 mg of dipotassium hexachloroiridate in 812 ml of deionized water and a solution obtained by dissolving 127 g of silver nitrate in 1,090 ml of deionized water were simultaneously mixed over 28.5 minutes. Here, the pAg was kept constant using a pAg feedback control loop described in Research Disclosure, No. 17643, and U.S. Pat. Nos. 3,415,650, 3,782,954 and 3,821,002.

The obtained emulsion was washed and desalted. The average grain size was 0.045 a μm. The silver halide grain size was determined by a transmission electron microscope (TEM).

<Preparation of Iridium-Doped Previously Formed Silver Halide/Organic Silver Salt Dispersion Solution>

In 13 liter of water, 118 g of Humko-type fatty acid 9718 (produced by Witco, Memphis, Tenn.) and 570 g of Humko-type fatty acid 9022 (produced by Witco, Memphis, Tenn.) were dissolved at 80° C. and mixed for 15 minutes. Thereto, a solution obtained by dissolving 89.18 g of NaOH in 1.5 liter of water was added at 80° C. and mixed for 5 minutes to form a dispersion solution. To this dispersion solution, a solution obtained by diluting 19 ml of concentrated nitric acid with 50 ml of water was added at 80° C. and the dispersion solution was cooled to 55° C. and stirred for 25 minutes. Thereafter, 0.10 mol of the silver halide emulsion doped above with iridium and previously formed to 700 g/mol in 1.25 liter of water at 42° C. was added to the dispersion solution at 55° C. and mixed for 5 minutes. Furthermore, a solution obtained by dissolving 365 g of silver nitrate in 2.5 liter of water was added at 55° C. and mixed for 10 minutes. The obtained silver halide/organic silver salt dispersion solution was desalted, washed and concentrated by centrifugal filtration until the electrical conductivity of washing water became 2 μs/cm and then dried with hot air at 45° C. for 72 hours.

The thus-prepared silver halide/organic silver salt dispersion solution (209 g) was mixed in 780 g of methyl ethyl ketone (MEK) and 11 g of polyvinyl butyral (Butvar B-79, produced by Monsanto) while stirring for 10 minutes. The resulting mixture was left standing at 7° C. over night and then homogenized twice under the condition of 6,000 psi to prepare a silver soap dispersion solution.

<Preparation of Coating Solution for Photosensitive Layer>

The preformed silver soap dispersion solution (507 g) was stirred at 13° C. for 15 minutes and thereto, 3.9 ml of a methanol solution containing 10 mass % of pyridinium hydrobromide perbromide (PHP) was added. After stirring for 2 hours, 5.2 ml of a methanol solution containing 11 mass % of calcium bromide was added. The stirring was continued for 30 minutes and then, 117 g of Butvar B-79 was added. After further stirring for 30 minutes, 27.3 g of 1,1-bis(2-hydroxy-3,5-dimethylphenyl)-2-methylpropane was added and the dispersion solution was further stirred for 15 minutes. Thereafter, 2.73 g of 2-(tribromomethylsulfonyl)quinoline was added and the dispersion solution was further stirred for 15 minutes. This was added to a solution obtained by dissolving 1.39 g of Desmodur N3300 (aliphatic isocyanate, produced by MOBEY) in 12.3 g of MEK and the resulting dispersion solution was further stirred for 15 minutes and then heated at 21° C. for 15 minutes.

To 100 g of the obtained dispersion solution, 1 mg of the sensitizing dye of the present invention (shown in Table 3), 0.47 g of 4-chlorobenzophenone-2-carboxylic acid, and 0.043 g of 5-methyl-2-mercaptobenzimidazole were added and stirred at 21° C. for 1 hour. Subsequently, 0.368 g of phthalazine, 0.123 g of tetrachlorophthalic acid and 2 g of the dyestuff of the present invention (shown in Table 3) were added to obtain a coating solution for photosensitive layer.

<Preparation of Coating Solution for Surface Protective Layer>

In 512 g of MEK, 61 g of methanol, 48 g of cellulose acetate butyrate (CAB171-15S, produced by Eastman Chemical), 2.08 g of 4-methylphthalic acid, 3.3 g of an MEK solution containing 16 mass % of Fluorine-Containing Polymer Surfactant C, 1.9 g of polymethyl methacrylate (Acryloid A-21, produced by Rhom & Haas) and 0.5 g of 1,3-di(vinylsulfonyl)-2-propanol were mixed at room temperature to prepare a coating solution for surface protective layer.

<Coating of Back Surface>

To 786.7 g of an MEK solution containing 12.6 mass % of cellulose acetate butyrate (CAB380-20, produced by Eastman Chemical) and 0.17 mass % of polyester (Vitel TM PE-200, produced by Goodyear), the same dyestuff as used in the coating solution for photosensitive layer was added in an amount of giving a maximum absorption of 0.9 in the range from 750 to 1,400 nm and subsequently, 78.7 g of a solution obtained by dispersing 0.38 mass % of a silica matting agent having an average particle size of 8 μm and a coefficient of variation of 40% in MEK was added. Furthermore, 15.7 g of Antistatic Agent C and 3.93 g of MEK were added and stirred to obtain a coating solution for back surface.

The thus-obtained coating solution for back surface was coated to a thickness of 76 μm on a 176 μm-thick blue-tinted polyethylene terephthalate support and then dried. The obtained back layer had a transmission density of 0.5 or less in the range from 400 to 700 nm and the Bekk smoothness on the back surface was 140 seconds.

<Preparation of Photosensitive Material>

Thereafter, the coating solution for photosensitive layer and the coating solution for surface protective layer were simultaneously coated by a dual knife coater. The coating solution for photosensitive layer was coated on the support to a wet thickness of giving a dry thickness of 18.3 μm and the coating solution for surface protective layer was coated on the photosensitive layer to a wet thickness of giving a dry thickness of 3.4 μm. The coating apparatus used was composed of two knife coating blades standing side by side. The support was cut into a length matching the volume of solution used and then the knives each with a hinge were elevated and disposed to the position on a coater floor. Subsequently, the knives were lowered and fixed to a predetermined position. The height of the knives was adjusted by using a wedge which is controlled by a screw knob and measured by an ammeter. Knife #1 was elevated to the space corresponding to the thickness as a total of the thickness of support and the desired wet thickness of photosensitive layer (Layer #1) and Knife #2 was elevated to the height equal to the desired thickness as a total of support+photosensitive layer (Layer #1) having a desired wet thickness+topcoat layer (Layer #2) having a desired thickness. The drying was performed under 4 conditions of 70° C. for 3 minutes, 80° C. for 10 minutes, 90° C. for 10 minutes, and for 50 minutes (in this order, referred to as Drying Conditions 1 to 4).

(Measurement of Sensitivity)

The coated and dried photosensitive material was cut into a specimen of 1.5 inch×8 inch (3.8 cm×20.3 cm) and exposed by an exposure machine using, as the exposure light source, a semiconductor laser formed into a longitudinal multiple mode of a wavelength from 800 to 820 nm by means of high frequency superposition. After the exposure, the film specimen was developed under heating at 124° C. for 15 seconds using an automatic developing machine having a heat drum while contacting the protective layer of the photosensitive material with the drum surface, thereby obtaining an image. The obtained image was evaluated by a commercially available densitometer. In Table 3, the sensitivity of Sample No. 2 was taken as 100.

(Evaluation of Image Preservability)

The sample heat-developed for the purpose of sensitivity measurement was stored in an environment at 30° C. and a relative humidity of 70% under a fluorescent lamp of 1,000 Lux for 24 hours and then evaluated on the image density. The image preservability was evaluated by the increase of density in the Dmin area.

(Evaluation of Odor Intensity)

The odor intensity was evaluated according to the method described above. The odor in the sample bag at 120° C. was collected by an order discriminator FF-1 (manufactured by Shimadzu Corporation, a temperature rising thermal desorption concentration system by a carbon-type collector tube, oxide semiconductor sensor, 6 sensors) and the odor intensity SC1 (numerical value of SC1 axis) was measured. The odor intensity was evaluated by the value of SC1 axis.

(Measurement of Amount of Solvent in Photosensitive Material)

The stock photosensitive material (25 cm²) before development was sampled and enclosed in a 10 ml-volume vial, thereby preparing a sample for measurement. This sample was measured by HP 5890 SERIES II GC. The solvent content in each sample was measured under the conditions of column DB-WAX (30 m×1.0 mmid), He gas of 20 ml/min, injection at 250° C. and detector FID. At this time, the head space conditions were such that the bath temperature was 120° C. and the heating time was 30 minutes.

The evaluation results are shown in Table 3.

As apparent from Table 3, the photosensitive material of the present invention is excellent in the image preservability.

Fluorine-Containing Polymer Surfactant C:

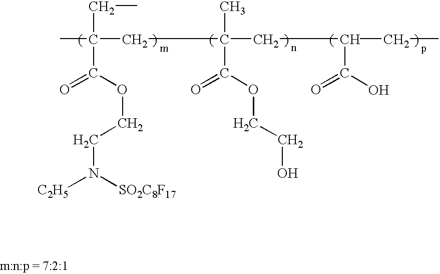

Antistatic Agent C:

C₈F₁₇—SO₃⁻H₃⁺N(CH₂—CH₂—O)₁₂CH₂—CH₂—NH₃⁺SO₃⁻—C₈F₁₇

TABLE 3

| | | | | Solvent Content | | | | Image | |
|---|---|---|---|---|---|---|---|---|---|
| | | Sensitizing Dye | | in | Odor | Photographic | | Preservability, | |
| Sample | Dye of | of Formulae | Drying | Photosensitive | Intensity, | Performance | | increase | |
| No. | Formula (1) | (2a) to (2d) | Condition | Material (mg/m²) | SCl value | Dmin | Sensitivity | of Dmin | Remarks |
| 1 | — | No. 5 | 2 | 75 | 0.9 | 0.15 | 150 | 0.12 | Comparison |
| 2 | Comparative | No. 5 | 2 | 80 | 0.8 | 0.16 | 100 | 0.14 | Comparison |
| | Dyestuff 1 | | | | | | | | |
| 3 | Comparative | No. 5 | 2 | 80 | 0.8 | 0.16 | 101 | 0.13 | Comparison |
| | Dyestuff 2 | | | | | | | | |
| 4 | Comparative | No. 5 | 2 | 65 | 0.6 | 0.17 | 102 | 0.15 | Comparison |
| | Dyestuff 3 | | | | | | | | |
| 5 | — | No. 5 | 3 | 11 | −1.1 | 0.17 | 155 | 0.11 | Comparison |
| 6 | Comparative | No. 5 | 3 | 12 | −0.9 | 0.18 | 100 | 0.12 | Comparison |
| | Dyestuff 1 | | | | | | | | |
| 7 | Comparative | No. 5 | 3 | 10 | −1.2 | 0.16 | 101 | 0.12 | Comparison |
| | Dyestuff 2 | | | | | | | | |
| 8 | Comparative | No. 5 | 3 | 10 | −1.1 | 0.17 | 102 | 0.13 | Comparison |
| | Dyestuff 3 | | | | | | | | |
| 9 | 1-1 | Comparative Dye | 1 | 135 | 2.1 | 0.16 | 97 | 0.13 | Comparison |
| 10 | 1-1 | Comparative Dye | 2 | 80 | 0.8 | 0.16 | 100 | 0.07 | Invention |
| 11 | 1-1 | Comparative Dye | 3 | 9 | −1.1 | 0.17 | 100 | 0.08 | Invention |
| 12 | 1-1 | Comparative Dye | 4 | 3 | −3.4 | 0.18 | 103 | 0.14 | Comparison |
| 13 | 1-1 | No. 5 | 1 | 110 | 1.5 | 0.15 | 99 | 0.14 | Comparison |
| 14 | 1-1 | No. 5 | 2 | 45 | 0.7 | 0.14 | 101 | 0.03 | Invention |
| 15 | 1-1 | No. 5 | 3 | 9 | −1.1 | 0.15 | 100 | 0.04 | Invention |
| 16 | 1-1 | No. 5 | 4 | 2 | −3.5 | 0.16 | 105 | 0.12 | Comparison |
| 17 | 1-3 | No. 20 | 1 | 125 | 1.7 | 0.17 | 99 | 0.14 | Comparison |
| 18 | 1-3 | No. 20 | 2 | 80 | 0.8 | 0.17 | 102 | 0.03 | Invention |
| 19 | 1-3 | No. 20 | 3 | 11 | −0.6 | 0.15 | 100 | 0.04 | Invention |
| 20 | 1-3 | No. 20 | 4 | 4 | −3.2 | 0.17 | 105 | 0.12 | Comparison |
| 21 | 1-3 | No. 41 | 1 | 130 | 1.9 | 0.16 | 100 | 0.14 | Comparison |
| 22 | 1-3 | No. 41 | 2 | 60 | 0.8 | 0.16 | 102 | 0.05 | Invention |
| 23 | 1-3 | No. 41 | 3 | 6 | −1.1 | 0.17 | 100 | 0.04 | Invention |
| 24 | 1-3 | No. 41 | 4 | 2 | −3.6 | 0.18 | 104 | 0.12 | Comparison |
| 25 | 1-4 | No. 5 | 1 | 110 | 1.8 | 0.17 | 103 | 0.13 | Comparison |
| 26 | 1-4 | No. 5 | 2 | 75 | 0.3 | 0.17 | 101 | 0.05 | Invention |
| 27 | 1-4 | No. 5 | 3 | 8 | −1.5 | 0.15 | 100 | 0.04 | Invention |
| 28 | 1-4 | No. 5 | 4 | 2 | −3.8 | 0.18 | 103 | 0.12 | Comparison |

Comparative Dye:

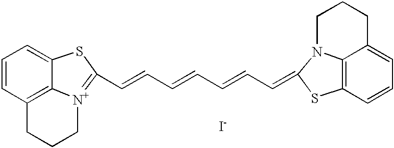

Comparative Dyestuff 1:

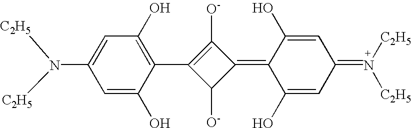

Comparative Dyestuff 2:

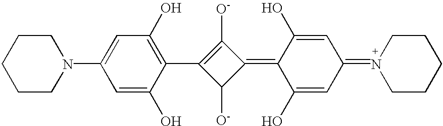

Comparative Dyestuff 3:

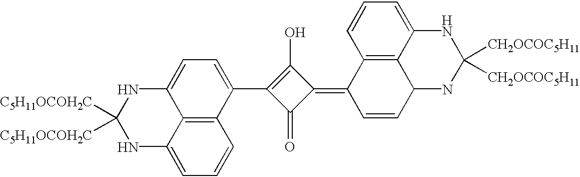

### EXAMPLE 4

(Preparation of Support)

Both surfaces of a 175 μm-thick PET film colored blue to a density of 0.160 were subjected to a corona discharge treatment of 8 w/m²·min.

[Preparation of Photosensitive Emulsion]

(Preparation of Photosensitive Silver Halide Emulsion)

In 900 ml of water, 7.5 g of ossein gelatin having an average molecular weight of 100,000 and 10 mg of potassium bromide were dissolved. The resulting solution was adjusted to a temperature of 35° C. and a pH of 3.0 and thereto, 370 ml of an aqueous solution containing 74 g of silver nitrate and 370 ml of an aqueous solution containing potassium bromide and potassium iodide at a molar ratio of 98/2 and containing iridium chloride in an amount of 1×10⁻⁴ mol per mol of silver were added by a controlled double jet method over 10 minutes while keeping the pAg at 7.7. Thereafter, 0.3 g of 4-hydroxy-6-methyl-1,3,3a,7-tetraza-indene was added and the pH was adjusted to 5 with NaOH to obtain a cubic silver iodobromide grain having an average grain size of 0.06 μm, a coefficient of variation in the grain size of 12% and a [100] face percentage of 87%. This emulsion was desalted by flocculating and precipitating silver halide grains using a gelatin coagulant, 0.1 g of phenoxyethanol was added thereto, and the pH and the pAg were adjusted to 5.9 and 7.5, respectively, thereby obtaining a photosensitive silver halide emulsion.

The temperature of the thus-obtained photosensitive silver halide emulsion was elevated to 55° C. and thereto, 5×10⁻⁵ mol of Compound A was added. Subsequently, 7×10⁻⁵ mol of ammonium thiocyanate and 5.3×10⁻⁵ mol of chloroauric acid were added. Furthermore, 0.3 mol % of silver iodide fine grain was added. After ripening for 100 minutes, the emulsion was cooled to 38° C. to complete the chemical sensitization and thereby obtain a silver halide grain. Here, the amount added is a value per 1 mol of AgX. Compound A:

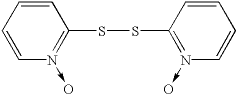

(Preparation of Powdery Organic Silver Salt)

In 4,720 ml of pure water, 111.4 g of behenic acid, 83.8 g of arachidinic acid and 54.9 g of stearic acid were dissolved at 80° C. Thereto, 540.2 ml of an aqueous 1.5M sodium hydroxide solution was added while stirring at a high speed and after 6.9 ml of concentrated nitric acid was added, the resulting solution was cooled to 55° C. to obtain an organic acid sodium solution. While keeping the organic acid sodium solution at a temperature of 55° C., the silver halide grain (containing 0.038 mol of silver) and 450 ml of pure water were added. Thereto, 760.6 ml of a iM silver nitrate solution was added over 2 minutes and after stirring for 20 minutes, water-soluble salts were removed by filtration. Subsequently, centrifugal dehydration was performed by repeating washing with deionized water and filtration until the electrical conductivity of filtrate became 2 μS/cm. Then, drying was performed in a heated nitrogen stream until the weight loss did not occur, thereby obtaining a powdery organic silver salt.

(Preparation of Photosensitive Emulsion Dispersion Solution)

In 1,457 g of methyl ethyl ketone, 14.57 g of polyvinyl butyral powder (Butvar B-79, produced by Monsanto) was dissolved. While stirring by a dissolver-type homogenizer, 500 g of the powdery organic silver salt was gradually added and thoroughly mixed. The obtained mixture was dispersed using a media-type mill (manufactured by Gettzmann) filled in 80% with 1-mm Zr beads (produced by Toray Industries, Inc.) at a peripheral speed of 13 m and a residence time in mill of 0.5 minutes to prepare a photosensitive emulsion dispersion solution.

[Preparation of Coating Solution for Photosensitive Layer]

In 500 g of the photosensitive emulsion dispersion solution prepared above, 100 g of methyl ethyl ketone (MEK) was added while stirring in a nitrogen stream. The resulting solution was kept at 24° C. Thereto, Antifoggant 1 (a 10% methanol solution, 2.50 ml) shown below was added and stirred for 1 hour and furthermore, calcium bromide (a 10% methanol solution, 4 ml) was added and stirred for 15 minutes.

Thereafter, 1.8 ml of a 1:5 mixed solution of a dye adsorption aid shown below and potassium acetate (a 20 wt % ethanol solution of the dye adsorption aid) was added and stirred for 15 minutes. Thereto, a mixed solution of an infrared sensitizing dye of the present invention (shown in Table 4), 4-chloro-2-benzoyl benzoic acid and a supersensitizer (5-methyl-2-mercaptobenzimidazole) (mixing ratio: 1:250:20, a 0.1% methanol solution of the sensitizing dye, 7 ml) was added and stirred for 1 hour. After lowering the temperature to 13° C., the solution was further stirred for 30 minutes. While keeping the solution at 13° C., 48 g of polyvinyl butyral was added and thoroughly dissolved. Thereafter, the following additives were added. (These operations all were performed in a nitrogen stream.)

| | | |
|---|---|---|
| Phthalazine | 1.5 | g |
| Tetrachlorophthalic acid | 0.5 | g |
| 4-Methylphthalic acid | 0.5 | g |
| Dyestuff of the present invention (shown | 2.0 | g |
| in Table 4) | | |
| Developer (1,1-bis(2-hydroxy-3,5- | 15 | g |
| dimethylphenyl)-2-methylpropane) | | |
| Desmodur N3300 (aliphatic isocyanate, | 1.10 | g |
| produced by MOBEY) | | |
| Antifoggant 2 (2-(tribromomethyl- | 1.55 | g |
| sulfonyl)-quinoline) | | |
| Antifoggant 3 | 0.9 | g |

Dye Adsorption Aid:

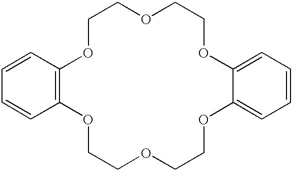

Antifoggant 1:

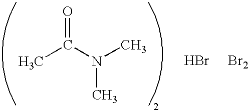

Antifoggant 3:

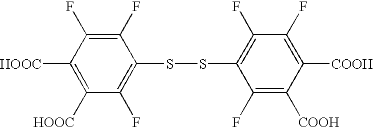

<Coating of Photosensitive Layer Side>

Photosensitive Layer:

The solution having the above-described composition was coated on the support prepared above such that the coated silver amount was 1.8 g/m² and the coated amount of polyvinyl butyral as the binder was 8.5 g/m².

<Surface Protective Layer>

A solution having the following composition was coated on the photosensitive layer to have a wet thickness of 100 μm.

| Organic solvent of the present invention | 175 | ml |
|---|---|---|
| 2-Propanol | 40 | ml |
| Methanol | 15 | ml |
| Cellulose acetate | 8 | g |
| Phthalazinone (a 4.5% DMF solution) | 8 | ml |
| Phthalazine | 1.5 | g |
| 4-Methylphthalic acid | 0.72 | g |
| Tetrachlorophthalic acid | 0.22 | g |
| Tetrachlorophthalic anhydride | 0.5 | g |
| Monodisperse silica having an average | 1 | wt % |
| particle size of 4 μm (coefficient of | based on | |
| variation: 20%) | binder | |
| Fluorine-Containing Polymer Surfactant C | 0.5 | g |
| same as in Example 3 | | |

<Coating of Back Surface Side>

The same dyestuff as used in the coating solution for photosensitive layer was used in the coating solution for back surface in the same manner as in Example 3 and the coating solution for back surface was coated in the same manner as in Example 3.

Drying after the coating was performed under 4 conditions of 70° C. for 3 minutes, 80° C. for 10 minutes, 90° C. for 10 minutes, and 50 minutes (in this order, Drying Conditions 1 to 4) in the same manner as in Example 3.

The evaluation results are shown in Table 4.

In Table 4, the sensitivity of Sample No. 3 was taken as 100.

TABLE 4

| | | Sensitizing | Organic | | Solvent | | | | | |
|---|---|---|---|---|---|---|---|---|---|---|
| | | Dye of | Solvent in | | Content in | | | | Image | |
| | | Formulae | Surface | | sensitive | Odor | Photographic | | Preservability, | |
| Sample | Dye of | (2a) to | Protective | Drying | Material | Intensity, | Performance | | increase of | |
| No. | Formula (1) | (2d) | Layer | Condition | (mg/m²) | SCl value | Dmin | Sensitivity | Dmin | Remarks |
| 1 | — | No. 5 | 3-1 | 3 | 12 | −0.5 | 0.14 | 165 | 0.11 | Comparison |
| 2 | Comparative | No. 5 | 3-1 | 3 | 8 | −1.1 | 0.15 | 103 | 0.13 | Comparison |
| | Dyestuff 4 | | | | | | | | | |
| 3 | Comparative | No. 5 | 3-1 | 3 | 9 | −0.8 | 0.16 | 100 | 0.12 | Comparison |
| | Dyestuff 5 | | | | | | | | | |
| 4 | Comparative | No. 5 | 3-1 | 3 | 10 | −0.7 | 0.16 | 105 | 0.15 | Comparison |
| | Dyestuff 6 | | | | | | | | | |
| 5 | 1-1 | No. 5 | 3-1 | 1 | 115 | 1.9 | 0.17 | 95 | 0.11 | Comparison |
| 6 | 1-1 | No. 5 | 3-1 | 2 | 55 | 0.2 | 0.17 | 100 | 0.03 | Invention |
| 7 | 1-1 | No. 5 | 3-1 | 3 | 9 | −1.2 | 0.16 | 101 | 0.04 | Invention |
| 8 | 1-1 | No. 5 | 3-1 | 4 | 3 | −3.8 | 0.17 | 105 | 0.13 | Comparison |
| 9 | 1-1 | No. 5 | acetone | 1 | 130 | 2.2 | 0.16 | 97 | 0.13 | Comparison |
| 10 | 1-1 | No. 5 | acetone | 2 | 75 | 0.5 | 0.15 | 100 | 0.07 | Invention |
| 11 | 1-1 | No. 5 | acetone | 3 | 10 | −1.1 | 0.17 | 101 | 0.08 | Invention |
| 12 | 1-1 | No. 5 | acetone | 4 | 3 | −3.5 | 0.17 | 103 | 0.14 | Comparison |
| 13 | 1-1 | No. 5 | MEK | 3 | 8 | −0.6 | 0.15 | 102 | 0.07 | Invention |
| 14 | 1-1 | No. 5 | 3-2 | 3 | 11 | −0.3 | 0.14 | 101 | 0.03 | Invention |
| 15 | 1-1 | No. 5 | 3-6 | 3 | 9 | −0.5 | 0.15 | 100 | 0.04 | Invention |
| 16 | 1-1 | No. 5 | 4-1 | 3 | 7 | −1.1 | 0.16 | 103 | 0.05 | Invention |
| 17 | 1-8 | No. 20 | 3-1 | 1 | 120 | 2.1 | 0.17 | 98 | 0.14 | Comparison |
| 18 | 1-8 | No. 20 | 3-1 | 2 | 85 | 0.8 | 0.17 | 102 | 0.04 | Invention |
| 19 | 1-8 | No. 20 | 3-1 | 3 | 11 | −0.4 | 0.15 | 100 | 0.03 | Invention |
| 20 | 1-8 | No. 20 | 3-1 | 4 | 3 | −3.5 | 0.17 | 105 | 0.12 | Comparison |
| 21 | 1-10 | No. 41 | 4-1 | 1 | 125 | 1.7 | 0.16 | 98 | 0.14 | Comparison |
| 22 | 1-10 | No. 41 | 4-1 | 2 | 55 | 0.5 | 0.16 | 102 | 0.04 | Invention |
| 23 | 1-10 | No. 41 | 4-1 | 3 | 7 | −1.1 | 0.16 | 100 | 0.05 | Invention |
| 24 | 1-10 | No. 41 | 4-1 | 4 | 2 | −3.4 | 0.17 | 105 | 0.12 | Comparison |

MEK: methyl ethyl ketone

Comparative Dyestuff 4:

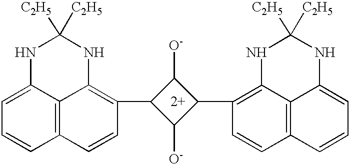

Comparative Dyestuff 5 (Compound Described in JP-A-10-158253):

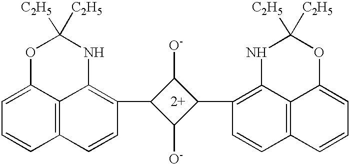

Comparative Dyestuff 6:

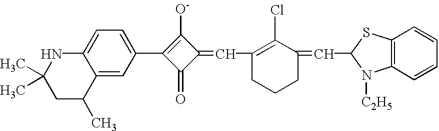

As is apparent from Table 4, the heat-developable photosensitive material of the present invention is excellent in the image preservability.

### EXAMPLE 5

<Preparation of Iridium-Doped Core/Shell-Type Silver Bromoiodide Emulsion>

To a first solution kept at 34° C., which was prepared by dissolving 30 g of phthalated gelatin and 71.4 mg of KBr in 1,500 ml of deionized water and adjusted to a pH of 5.0 with 3 mol/liter of nitric acid, a solution obtained by dissolving 27.4 g of KBr and 3.3 g of KI in 275 ml of deionized water and a solution obtained by dissolving 42.5 g of silver nitrate in 364 ml of deionized water were simultaneously added over 9.5 minutes. Thereafter, a solution obtained by dissolving 179 g of KBr and 10 mg of dipotassium hexachloroiridate in 812 ml of deionized water and a solution obtained by dissolving 127 g of silver nitrate in 1,090 ml of deionized water were simultaneously mixed over 28.5 minutes.

Here, the pAg was kept constant using a pAg feedback control loop described in Research Disclosure, No. 17643, and U.S. Pat. Nos. 3,415,650, 3,782,954 and 3,821,002.

The obtained emulsion was washed and desalted. The average grain size was 0.045 μm. The silver halide grain size was determined by a transmission electron microscope (TEM).

<Preparation of Iridium-Doped Previously Formed Silver Halide/Organic Silver Salt Dispersion Solution>

In 13 liter of water, 118 g of Humko-type fatty acid 9718 (produced by Witco, Memphis, Tenn.) and 570 g of Humko-type fatty acid 9022 (produced by Witco, Memphis, Tenn.) were dissolved at 80° C. and mixed for 15 minutes. Thereto, a solution obtained by dissolving 89.18 g of NaOH in 1.5 liter of water was added at 80° C. and mixed for 5 minutes to form a dispersion solution. To this dispersion solution, a solution obtained by diluting 19 ml of concentrated nitric acid with 50 ml of water was added at 80° C. and the dispersion solution was cooled to 55° C. and stirred for 25 minutes. Thereafter, 0.10 mol of the silver halide emulsion doped above with iridium and previously formed to 700 g/mol in 1.25 liter of water at 42° C. was added to the dispersion solution at 55° C. and mixed for 5 minutes. Furthermore, a solution obtained by dissolving 365 g of silver nitrate in 2.5 liter of water was added at 55° C. and mixed for 10 minutes. The obtained silver halide/organic silver salt dispersion solution was desalted, washed and concentrated by centrifugal filtration until the electrical conductivity of washing water became 2 μs/cm and then dried with hot air at 45° C. for 72 hours.

The thus-prepared silver halide/organic silver salt dispersion solution (209 g) was mixed in 780 g of methyl ethyl ketone (MEK) and 11 g of polyvinyl butyral (Butvar B-79, produced by Monsanto) while stirring for 10 minutes. The resulting mixture was left standing at 7° C. over night and then homogenized twice under the condition of 6,000 psi to prepare a silver soap dispersion solution.

<Preparation of Coating Solution for Photosensitive Layer>

The preformed silver soap dispersion solution (507 g) was stirred at 13° C. for 15 minutes and thereto, 3.9 ml of a methanol solution containing 10 mass % of pyridinium hydrobromide perbromide (PHP) was added. After stirring for 2 hours, 5.2 ml of a methanol solution containing 11 mass % of calcium bromide was added. The stirring was continued for 30 minutes and then, 117 g of Butvar B-79 was added. After further stirring for 30 minutes, 27.3 g of 1,1-bis(2-hydroxy-3,5-dimethylphenyl)-2-methylpropane was added and the dispersion solution was further stirred for 15 minutes. Thereafter, 2.7 g of a halide of formula (X) shown in Table 5 was added and the dispersion solution was further stirred for 15 minutes. This was added to a solution obtained by dissolving 1.39 g of Desmodur N3300 (aliphatic isocyanate, produced by MOBEY) in 12.3 g of MEK and the resulting dispersion solution was further stirred for 15 minutes and then heated at 21° C. for 15 minutes.

To 100 g of the obtained dispersion solution, 1 mg of Dye C, 0.47 g of 4-chlorobenzophenone-2-carboxylic acid and 0.043 g of 5-methyl-2-mercaptobenzimidazole were added and stirred at 21° C. for 1 hour. Subsequently, 0.368 g of phthalazine, 0.123 g of tetrachlorophthalic acid and 2 g of Dyestuff C were added and furthermore, 2.2 g of a compound of formula (1) shown in Table 5 or Comparative Compound 1, 2, 3 or 4 shown below was added. Thereto, 1 g of a sulfonium salt shown in Table 5 was added to obtain a coating solution for photosensitive layer.

<Preparation of Coating Solution for Surface Protective Layer>

In 512 g of MEK, 61 g of methanol, 48 g of cellulose acetate butyrate (CAB171-15S, produced by Eastman Chemical), 2.08 g of 4-methylphthalic acid, 3.3 g of an MEK solution containing 16 mass % of Fluorine-Containing Polymer Surfactant C, 1.9 g of polymethyl methacrylate (Acryloid A-21, produced by Rhom & Haas) and 0.5 g of 1,3-di(vinylsulfonyl)-2-propanol were mixed at room temperature to prepare a coating solution for surface protective layer.

<Coating of Back Surface>

To 786.7 g of an MEK solution containing 12.6 mass % of cellulose acetate butyrate (CAB380-20, produced by Eastman Chemical) and 0.17 mass % of polyester (Vitel TM PE-200, produced by Goodyear), 0.9 g of Dyestuff C and 78.7 g of MEK were added and subsequently, 78.7 g of a solution obtained by dispersing 0.38 mass % of a silica matting agent having an average particle size of 8 μm and a coefficient of variation of 40% in MEK was added. Furthermore, 15.7 g of Antistatic Agent C and 3.93 g of MEK were added and stirred to obtain a coating solution for back surface.

The thus-obtained coating solution for back surface was coated to a thickness of 76 μm on a 176 μm-thick blue-tinted polyethylene terephthalate support and then dried. Here, the transmission density was 0.39 at 800 nm.

Dye C:

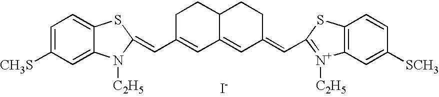

Dyestuff C:

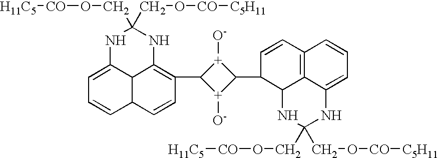

Fluorine-Containing Polymer Surfactant C:

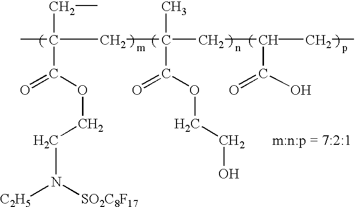

Antistatic Agent C:

C₈F₁₇—SO₃⁻H₃⁺N(CH₂—CH₂—O)₁₂CH₂—CH₂—NH₃⁺⁻₃OS—C₈F₁₇

Comparative Compound 1:

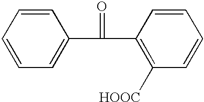

Comparative Compound 2:

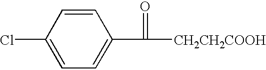

Comparative Compound 3:

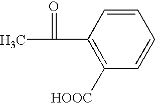

Comparative Compound 4:

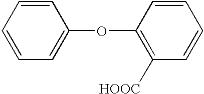

<Preparation of Photosensitive Material>

Thereafter, the coating solution for photosensitive layer and the coating solution for surface protective layer were simultaneously coated by a dual knife coater. The coating solution for photosensitive layer was coated on the support to a wet thickness of giving a dry thickness of 18.3 μm and the coating solution for surface protective layer was coated on the photosensitive layer to a wet thickness of giving a dry thickness of 3.4 μm. The coating apparatus used was composed of two knife coating blades standing side by side. The support was cut into a length matching the volume of solution used and then the knives each with a hinge were elevated and disposed to the position on a coater floor. Subsequently, the knives were lowered and fixed to a predetermined position. The height of the knives was adjusted by using a wedge which is controlled by a screw knob and measured by an ammeter.

Knife #1 was elevated to the space corresponding to the thickness as a total of the thickness of support and the desired wet thickness of photosensitive layer (Layer #1) and Knife #2 was elevated to the height equal to the desired thickness as a total of support+photosensitive layer (Layer #1) having a desired wet thickness+topcoat layer (Layer #2) having a desired thickness.

The drying was performed under 4 conditions of 70° C. for 3 minutes, 80° C. for 10 minutes, 90° C. for 10 minutes, and for 50 minutes (in this order, referred to as Drying Conditions 1 to 4).

In this way, 28 kinds of heat-developable photosensitive materials (Sample Nos. 1 to 28) were produced. These heat-developable photosensitive materials were evaluated by the following evaluation methods and the results obtained are shown in Table 5.

In Table 5, the sensitivity is shown as a relative sensitivity by taking the sensitivity of Sample No. 1 as 100. As the numeral is larger, the sensitivity is higher.

<Evaluation Methods>

(Evaluation of Sensitivity)

The coated and dried photosensitive material was cut into a specimen of 1.5 inch×8 inch (3.8 cm×20.3 cm) and exposed by an exposure machine using, as the exposure light source, a semiconductor laser formed into a longitudinal multiple mode of a wavelength from 800 to 820 nm by means of high frequency superposition. After the exposure, the film specimen was developed under heating at 124° C. for 15 seconds using an automatic developing machine having a heat drum while contacting the protective layer of the photosensitive material with the drum surface, thereby obtaining an image. The obtained image was evaluated by a commercially available densitometer.

(Evaluation of Image Preservability)

The sample heat-developed for the purpose of sensitivity measurement was stored in an environment at 30° C. and a relative humidity of 70% under a fluorescent lamp of 1,000 Lux for 24 hours and then evaluated on the image density. The image preservability was evaluated by the increase of density in the Dmin area.

(Evaluation of Odor Intensity)

The odor intensity was evaluated according to the method described above. The odor in the sample bag at 120° C. was collected by an order discriminator FF-1 (manufactured by Shimadzu Corporation, a temperature rising thermal desorption concentration system by a carbon-type collector tube, oxide semiconductor sensor, 6 sensors) and the odor intensity SC1 (numerical value of SC1 axis) was measured.

The odor intensity was evaluated by the value of SC1 axis.

(Measurement of Amount of Solvent in Photosensitive Material)

The stock photosensitive material (25 cm²) before development was sampled and enclosed in a 10 ml-volume vial, thereby preparing a sample for measurement. This sample was measured by HP 5890 SERIES II GC. The solvent content in each sample was measured under the conditions of column DB-WAX (30 m×1.0 mmid), He gas of 20 ml/min, injection at 250° C. and detector FID. At this time, the head space conditions were such that the bath temperature was 120° C. and the heating time was 30 minutes.

TABLE 5

| | | | | | Solvent Content | | | | | |
|---|---|---|---|---|---|---|---|---|---|---|
| | | | | | in | | | | Image | |
| | | | | | Photosensitive | Odor | Photographic | | Preservability, | |
| Sample | Compound of | Compound of | Sulfonium | Drying | Material | Intensity, | Performance | | Increase of | |
| No. | Formula (X) | Formula (1) | Salt | Condition | (mg/m²) | SCl Value | Dmin | Sensitivity | Dmin | Remarks |
| 1 | — | A-44 | S-1 | 1 | 135 | 2.5 | 0.15 | 100 | 0.18 | Comparison |
| 2 | — | A-44 | S-1 | 2 | 65 | 1.1 | 0.16 | 100 | 0.13 | ″ |
| 3 | — | A-44 | S-1 | 3 | 12 | −0.3 | 0.16 | 101 | 0.11 | ″ |
| 4 | — | A-44 | S-1 | 4 | 4 | −2.5 | 0.17 | 102 | 0.14 | ″ |
| 5 | X-1 | A-44 | S-1 | 1 | 120 | 2 | 0.16 | 97 | 0.15 | ″ |
| 6 | X-1 | A-44 | S-1 | 2 | 70 | 0.8 | 0.16 | 100 | 0.04 | Invention |
| 7 | X-1 | A-44 | S-1 | 3 | 7 | −1.2 | 0.17 | 100 | 0.03 | ″ |
| 8 | X-1 | A-44 | S-1 | 4 | 3 | −3.5 | 0.18 | 103 | 0.12 | Comparison |
| 9 | X-1 | A-44 | — | 1 | 115 | 1.5 | 0.16 | 97 | 0.17 | ″ |
| 10 | X-1 | A-44 | — | 2 | 60 | 0.7 | 0.16 | 100 | 0.05 | Invention |
| 11 | X-1 | A-44 | — | 3 | 7 | −1.3 | 0.16 | 100 | 0.06 | ″ |
| 12 | X-1 | A-44 | — | 4 | 2 | −3.4 | 0.17 | 103 | 0.14 | Comparison |
| 13 | X-1 | A-16 | S-7 | 1 | 125 | 1.6 | 0.17 | 99 | 0.14 | ″ |
| 14 | X-1 | A-16 | S-7 | 2 | 80 | 0.9 | 0.17 | 102 | 0.03 | Invention |
| 15 | X-1 | A-16 | S-7 | 3 | 11 | −0.8 | 0.15 | 100 | 0.04 | ″ |
| 16 | X-1 | A-16 | S-7 | 4 | 4 | −3.2 | 0.16 | 105 | 0.12 | Comparison |
| 17 | X-65 | A-44 | S-1 | 1 | 120 | 1.9 | 0.16 | 100 | 0.13 | ″ |
| 18 | X-65 | A-44 | S-1 | 2 | 65 | 0.8 | 0.16 | 102 | 0.02 | Invention |
| 19 | X-65 | A-44 | S-1 | 3 | 7 | −1.1 | 0.17 | 100 | 0.02 | ″ |
| 20 | X-65 | A-44 | S-1 | 4 | 2 | −3.6 | 0.18 | 104 | 0.11 | Comparison |
| 21 | X-65 | Comparative | S-1 | 3 | 11 | −0.3 | 0.17 | 103 | 0.06 | Invention |
| | | Compound 1 | | | | | | | | |
| 22 | X-65 | Comparative | S-1 | 3 | 9 | 0.2 | 0.17 | 100 | 0.05 | ″ |
| | | Compound 2 | | | | | | | | |
| 23 | X-65 | Comparative | S-1 | 3 | 8 | −0.9 | 0.15 | 100 | 0.04 | ″ |
| | | Compound 3 | | | | | | | | |
| 24 | X-65 | Comparative | S-1 | 3 | 10 | −0.6 | 0.16 | 99 | 0.06 | ″ |
| | | Compound 4 | | | | | | | | |
| 25 | X-65 | A-44 | — | 3 | 12 | −0.3 | 0.16 | 97 | 0.05 | ″ |
| 26 | X-65 | A-44 | S-3 | 3 | 7 | 0.1 | 0.16 | 102 | 0.03 | ″ |
| 27 | X-65 | A-44 | S-4 | 3 | 8 | −1.1 | 0.17 | 100 | 0.03 | ″ |
| 28 | X-65 | A-44 | S-6 | 3 | 10 | −0.5 | 0.18 | 103 | 0.03 | ″ |

As is apparent from the results shown in Table 5, the heat-developable photosensitive material of the present invention is excellent in the image preservability.

### EXAMPLE 6

[Preparation of Support]

Both surfaces of a 175 μm-thick PET film colored blue to a density of 0.160 were subjected to a corona discharge treatment of 8 w/m²·min.

[Preparation of Photosensitive Emulsion]

(Preparation of Photosensitive Silver Halide Emulsion)

In 900 ml of water, 7.5 g of ossein gelatin having an average molecular weight of 100,000 and 10 mg of potassium bromide were dissolved. The resulting solution was adjusted to a temperature of 35° C. and a pH of 3.0 and thereto, 370 ml of an aqueous solution containing 74 g of silver nitrate and 370 ml of an aqueous solution containing potassium bromide and potassium iodide at a molar ratio of 98/2 and containing iridium chloride in an amount of 1×10⁻⁴ mol per mol of silver were added by a controlled double jet method over 10 minutes while keeping the pAg at 7.7. Thereafter, 0.3 g of 4-hydroxy-6-methyl-1,3,3a,7-tetraza-indene was added and the pH was adjusted to 5 with NaOH to obtain a cubic silver iodobromide grain having an average grain size of 0.06 μm, a coefficient of variation in the grain size of 12% and a [100] face percentage of 87%. This emulsion was desalted by flocculating and precipitating silver halide grains using a gelatin coagulant, 0.1 g of phenoxyethanol was added thereto, and the pH and the pAg were adjusted to 5.9 and 7.5, respectively, thereby obtaining a photosensitive silver halide emulsion.

The temperature of the thus-obtained photosensitive silver halide emulsion was elevated to 55° C. and thereto, 5×10⁻⁵ mol of Compound A shown below was added. Subsequently, 7×10⁻⁵ mol of ammonium thiocyanate and 5.3×10⁻⁵ mol of chloroauric acid were added. Furthermore, 0.3 mol % of silver iodide fine grain was added. After ripening for 100 minutes, the emulsion was cooled to 38° C. to complete the chemical sensitization and thereby obtain a silver halide grain. Here, the amount added is a value per 1 mol of AgX.

Compound A:

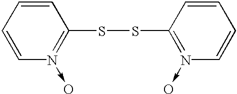

(Preparation of Powdery Organic Silver Salt)

In 4,720 ml of pure water, 111.4 g of behenic acid, 83.8 g of arachidinic acid and 54.9 g of stearic acid were dissolved at 80° C. Thereto, 540.2 ml of an aqueous 1.5M sodium hydroxide solution was added while stirring at a high speed and after 6.9 ml of concentrated nitric acid was added, the resulting solution was cooled to 55° C. to obtain an organic acid sodium solution. While keeping the organic acid sodium solution at a temperature of 55° C., the silver halide grain (containing 0.038 mol of silver) and 450 ml of pure water were added. Thereto, 760.6 ml of a 1M silver nitrate solution was added over 2 minutes and after stirring for 20 minutes, water-soluble salts were removed by filtration.

Subsequently, centrifugal dehydration was performed by repeating washing with deionized water and filtration until the electrical conductivity of filtrate became 2 μS/cm. Then, drying was performed in a heated nitrogen stream until the weight loss did not occur, thereby obtaining a powdery organic silver salt.

(Preparation of Photosensitive Emulsion Dispersion Solution)

In 1,457 g of methyl ethyl ketone, 14.57 g of polyvinyl butyral powder (Butvar B-79, produced by Monsanto) was dissolved. While stirring by a dissolver-type homogenizer, 500 g of the powdery organic silver salt was gradually added and thoroughly mixed. The obtained mixture was dispersed using a media-type mill (manufactured by Gettzmann) filled in 80% with 1-mm Zr beads (produced by Toray Industries, Inc.) at a peripheral speed of 13 m and a residence time in mill of 0.5 minutes to prepare a photosensitive emulsion dispersion solution.

[Preparation of Coating Solution for Photosensitive Layer]

In 500 g of the photosensitive emulsion dispersion solution prepared above, 100 g of methyl ethyl ketone (MEK) was added while stirring in a nitrogen stream. The resulting solution was kept at 24° C. Thereto, Antifoggant 1 (a 10% methanol solution, 2.50 ml) shown below was added and stirred for 1 hour and furthermore, calcium bromide (a 10% methanol solution, 4 ml) was added and stirred for 15 minutes. Thereafter, 1.8 ml of a 1:5 mixed solution of a dye adsorption aid shown below and potassium acetate (a 20 mass % ethanol solution of the dye adsorption aid) was added and stirred for 15 minutes. Thereto, a mixed solution of the same infrared sensitizing dye as in Example 5, a compound of formula (1) of the present invention and a supersensitizer (5-methyl-2-mercaptobenzimidazole) (mixing ratio: 1:250:20, a 0.1% methanol solution of the sensitizing dye, 7 ml) was added and stirred for 1 hour. After lowering the temperature to 13° C., the solution was further stirred for 30 minutes.

While keeping the solution at 13° C., 48 g of polyvinyl butyral was added and thoroughly dissolved. Thereafter, the following additives were added. (These operations all were performed in a nitrogen stream.)

| Phthalazine | 1.5 | g |
|---|---|---|
| Tetrachlorophthalic acid | 0.5 | g |
| 4-Methylphthalic acid | 0.5 | g |
| Same dyestuff as in | in an amount of giving | |
| Example 1 | an optical density of | |
| | 0.9 at the absorption | |
| | maximum of dyestuff | |
| Developer (1,1-bis(2-hydroxy-3,5- | 15 | g |
| dimethylphenyl)-2-methylpropane) | | |
| Desmodur N3300 (aliphatic isocyanate, | 1.10 | g |
| produced by MOBEY) | | |
| Halide of formula (X) (shown in Table 6) | 1.55 | g |
| Antifoggant 3 shown below | 0.9 | g |

Dye Adsorption Aid:

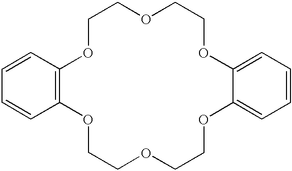

Antifoggant 1:

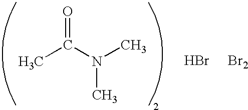

Antifoggant 3:

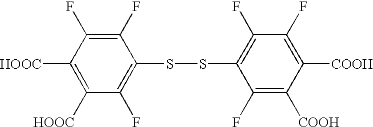

(Coating of Photosensitive Layer Side)

Photosensitive Layer:

The solution having the above-described composition was coated on the support prepared above such that the coated silver amount was 1.8 g/m², the coated amount of polyvinyl butyral as the binder was 8.5 g/m², and the coated amount of the sulfonium salt shown in Table 6 was 0.1 g/m².

(Surface Protective Layer)

A solution having the following composition was coated on the photosensitive layer to have a wet thickness of 100 μm.

| Acetone | 175 | ml |
|---|---|---|
| 2-Propanol | 40 | ml |
| Methanol | 15 | ml |
| Cellulose acetate | 8 | g |
| Phthalazinone (a 4.5% DMF solution) | 8 | ml |
| Phthalazine | 1.5 | g |
| 4-Methylphthalic acid | 0.72 | g |
| Tetrachlorophthalic acid | 0.22 | g |
| Tetrachlorophthalic anhydride | 0.5 | g |
| Monodisperse silica having an average | 1 mass % | |
| particle size of 4 μm (coefficient of | based on | |
| variation: 20%) | binder | |
| Fluorine-Containing Polymer Surfactant C | 0.5 | g |
| same as in Example 1 | | |

(Coating of Back Surface Side)

The same coating solution for back surface as in Example 5 was coated in the same manner as in Example 5.

Drying after the coating was performed under 4 conditions of 70° C. for 3 minutes, 80° C. for 10 minutes, 90° C. for 10 minutes, and 50 minutes (in this order, Drying Conditions 1 to 4) in the same manner as in Example 5.

In this way, 20 kinds of heat-developable photosensitive materials (Sample Nos. 31 to 50) were produced and evaluated in the same manner as in Example 5. The evaluation results are shown in Table 6.

In Table 6, the sensitivity is shown as relative sensitivity by taking the sensitivity of Sample No. 31 as 100. As the numeral is larger, the sensitivity is higher.

TABLE 6

| | Compound | Compound | | | Solvent Content | | | | Image | |
|---|---|---|---|---|---|---|---|---|---|---|
| | of | of | | | in | Odor | Photographic | | Preservability, | |
| Sample | Formula | Formula | Sulfonium | Drying | Photosensitive | Intensity, | Performance | | increase of | |
| No. | (X) | (1) | Salt | Condition | Material (mg/m²) | SCl value | Dmin | Sensitivity | Dmin | Remarks |
| 31 | — | A-8 | S-1 | 1 | 115 | 2.5 | 0.15 | 100 | 0.18 | Comparison |
| 32 | — | A-8 | S-1 | 2 | 70 | 1.1 | 0.16 | 100 | 0.13 | ″ |
| 33 | — | A-8 | S-1 | 3 | 12 | −0.3 | 0.16 | 101 | 0.11 | ″ |
| 34 | — | A-8 | S-1 | 4 | 4 | −2.5 | 0.17 | 102 | 0.14 | ″ |
| 35 | X-1 | A-8 | S-1 | 1 | 120 | 2 | 0.16 | 97 | 0.15 | ″ |
| 36 | X-1 | A-8 | S-1 | 2 | 65 | 0.8 | 0.16 | 100 | 0.04 | Invention |
| 37 | X-1 | A-8 | S-1 | 3 | 7 | −1.2 | 0.17 | 100 | 0.03 | ″ |
| 38 | X-1 | A-8 | S-1 | 4 | 2 | −3.5 | 0.18 | 103 | 0.12 | Comparison |
| 39 | X-1 | — | S-1 | 3 | 11 | −0.3 | 0.17 | 103 | 0.06 | Invention |
| 40 | X-1 | A-12 | S-1 | 3 | 9 | 0.2 | 0.17 | 100 | 0.04 | ″ |
| 41 | X-1 | A-20 | S-1 | 3 | 8 | −0.9 | 0.15 | 100 | 0.04 | ″ |
| 42 | X-1 | A-35 | S-1 | 3 | 10 | −0.6 | 0.16 | 99 | 0.03 | |
| 43 | X-4 | A-44 | — | 3 | 12 | −0.3 | 0.16 | 97 | 0.05 | ″ |
| 44 | X-10 | A-44 | — | 3 | 7 | 0.1 | 0.16 | 102 | 0.04 | |
| 45 | X-18 | A-44 | — | 3 | 8 | −1.1 | 0.17 | 100 | 0.04 | ″ |
| 46 | X-41 | A-44 | — | 3 | 9 | −0.5 | 0.18 | 103 | 0.04 | ″ |
| 47 | X-65 | A-44 | S-4 | 1 | 115 | 1.9 | 0.16 | 100 | 0.13 | Comparison |
| 48 | X-65 | A-44 | S-4 | 2 | 60 | 0.8 | 0.16 | 102 | 0.02 | Invention |
| 49 | X-65 | A-44 | S-4 | 3 | 7 | −1.1 | 0.17 | 100 | 0.02 | ″ |
| 50 | X-65 | A-44 | S-4 | 4 | 2 | −3.6 | 0.18 | 104 | 0.11 | Comparison |

As is apparent from the results shown in Table 6, the heat-developable photosensitive material of the present invention is excellent in the image preservability.

### EXAMPLE 7

<Preparation of Iridium-Doped Core/Shell-Type Silver Bromoiodide Emulsion>

To a first solution kept at 34° C., which was prepared by dissolving 30 g of phthalated gelatin and 71.4 mg of KBr in 1,500 ml of deionized water and adjusted to a pH of 5.0 with 3 mol/liter of nitric acid, a solution obtained by dissolving 27.4 g of KBr and 3.3 g of KI in 275 ml of deionized water and a solution obtained by dissolving 42.5 g of silver nitrate in 364 ml of deionized water were simultaneously added over 9.5 minutes. Thereafter, a solution obtained by dissolving 179 g of KBr and 10 mg of dipotassium hexachloroiridate in 812 ml of deionized water and a solution obtained by dissolving 127 g of silver nitrate in 1,090 ml of deionized water were simultaneously mixed over 28.5 minutes. Here, the pAg was kept constant using a pAg feedback control loop described in Research Disclosure, No. 17643, and U.S. Pat. Nos. 3,415,650, 3,782,954 and 3,821,002.

The obtained emulsion was washed and desalted. The average grain size was 0.045 μm. The silver halide grain size was determined by a transmission electron microscope (TEM).

<Preparation of Iridium-Doped Previously Formed Silver Halide/Organic Silver Salt Dispersion Solution>

In 13 liter of water, 118 g of Humko-type fatty acid 9718 (produced by Witco, Memphis, Tenn.) and 570 g of Humko-type fatty acid 9022 (produced by Witco, Memphis, Tenn.) were dissolved at 80° C. and mixed for 15 minutes. Thereto, a solution obtained by dissolving 89.18 g of NaOH in 1.5 liter of water was added at 80° C. and mixed for 5 minutes to form a dispersion solution. To this dispersion solution, a solution obtained by diluting 19 ml of concentrated nitric acid with 50 ml of water was added at 80° C. and the dispersion solution was cooled to 55° C. and stirred for 25 minutes. Thereafter, 0.10 mol of the silver halide emulsion doped above with iridium and previously formed to 700 g/mol in 1.25 liter of water at 42° C. was added to the dispersion solution at 55° C. and mixed for 5 minutes. Furthermore, a solution obtained by dissolving 365 g of silver nitrate in 2.5 liter of water was added at 55° C. and mixed for 10 minutes. The obtained silver halide/organic silver salt dispersion solution was desalted, washed and concentrated by centrifugal filtration until the electrical conductivity of washing water became 2 μs/cm and then dried with hot air at 45° C. for 72 hours.

The thus-prepared silver halide/organic silver salt dispersion solution (209 g) was mixed in 780 g of methyl ethyl ketone (MEK) and 11 g of polyvinyl butyral (Butvar B-79, produced by Monsanto) while stirring for 10 minutes. The resulting mixture was left standing at 7° C. over night and then homogenized twice under the condition of 6,000 psi (about 41 MPa) to prepare a silver soap dispersion solution.

<Preparation of Coating Solution for Photosensitive Layer>

The preformed silver soap dispersion solution (507 g) was stirred at 13° C. for 15 minutes and thereto, 3.9 ml of a methanol solution containing 10 mass % of pyridinium hydrobromide perbromide (PHP) was added. After stirring for 2 hours, 5.2 ml of a methanol solution containing 11 mass % of calcium bromide was added. The stirring was continued for 30 minutes and then, 117 g of polyvinyl butyral (Butvar B-79, produced by Monsanto) was added. After further stirring for 30 minutes, 27.3 g of 1,1-bis(2-hydroxy-3,5-dimethylphenyl)-2-methylpropane was added and the dispersion solution was further stirred for 15 minutes. Thereafter, 2.73 g of 2-(tribromomethylsulfonyl)quinoline was added and the dispersion solution was further stirred for 15 minutes. This was added to a solution obtained by dissolving 1.39 g of Desmodur N3300 (aliphatic isocyanate, produced by MOBEY) in 12.3 g of MEK and the resulting dispersion solution was further stirred for 15 minutes and then heated at 21° C. for 15 minutes.

To 100 g of the obtained dispersion solution, 1 mg of Dye C, 0.47 g of 4-chlorobenzophenone-2-carboxylic acid, and 0.043 g of 5-methyl-2-mercaptobenzimidazole were added and stirred at 21° C. for 1 hour. Subsequently, 0.123 g of tetrachlorophthalic acid and 2 g of Dyestuff C were added and furthermore, 0.8 g of a phthalazine-base compound shown in Table 7, 0.6 g of a hydrazine compound shown in Table 7, 0.1 g of a compound of formulae (1) to (3) shown in Table 7, and 0.5 g of a compound of formula (II) shown in Table 7 were added, thereby obtaining a coating solution for photosensitive layer.

<Preparation of Coating Solution for Surface Protective Layer>

In 512 g of MEK, 61 g of methanol, 48 g of cellulose acetate butyrate (CAB171-15S, produced by Eastman Chemical), 2.08 g of 4-methylphthalic acid, 3.3 g of an MEK solution containing 16 mass % of Fluorine-Containing Polymer Surfactant C, 1.9 g of polymethyl methacrylate (Acryloid A-21, produced by Rhom & Haas) and 0.5 g of 1,3-di(vinylsulfonyl)-2-propanol were mixed at room temperature to prepare a coating solution for surface protective layer.

<Coating of Back Surface>

To 786.7 g of an MEK solution containing 12.6 mass % of cellulose acetate butyrate (CAB380-20, produced by Eastman Chemical) and 0.17 mass % of polyester (Vitel TM PE-200, produced by Goodyear), 0.9 g of Dyestuff C and 78.7 g of MEK were added and subsequently, 78.7 g of a solution obtained by dispersing 0.38 mass % of a silica matting agent having an average particle size of 8 μm and a coefficient of variation of 40% in MEK was added. Furthermore, 15.7 g of Antistatic Agent C and 3.93 g of MEK were added and stirred to obtain a coating solution for back surface.

The thus-obtained coating solution for back surface was coated to a thickness of 76 μm on a 176 μm-thick blue-tinted polyethylene terephthalate support and then dried. Here, the transmission density was 0.39 at 800 nm.

<Preparation of Photosensitive Material>

Thereafter, the coating solution for photosensitive layer and the coating solution for surface protective layer were simultaneously coated by a dual knife coater. The coating solution for photosensitive layer was coated on the support to a wet thickness of giving a dry thickness of 18.3 μm and the coating solution for surface protective layer was coated on the photosensitive layer to a wet thickness of giving a dry thickness of 3.4 μm. The coating apparatus used was composed of two knife coating blades standing side by side. The support was cut into a length matching the volume of solution used and then the knives each with a hinge were elevated and disposed to the position on a coater floor. Subsequently, the knives were lowered and fixed to a predetermined position. The height of the knives was adjusted by using a wedge which is controlled by a screw knob and measured by an ammeter. Knife #1 was elevated to the space corresponding to the thickness as a total of the thickness of support and the desired wet thickness of photosensitive layer (Layer #1) and Knife #2 was elevated to the height equal to the desired thickness as a total of support+photosensitive layer (Layer #1) having a desired wet thickness+topcoat layer (Layer #2) having a desired thickness. The drying was performed under 4 conditions of 70° C. for 3 minutes, 80° C. for 10 minutes, 90° C. for 10 minutes, and for 50 minutes (in this order, referred to as Drying Conditions 1 to 4).

Chemical structures of compounds used in Example 7 are shown below.

Dye C:

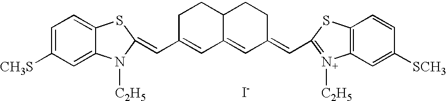

Dyestuff C:

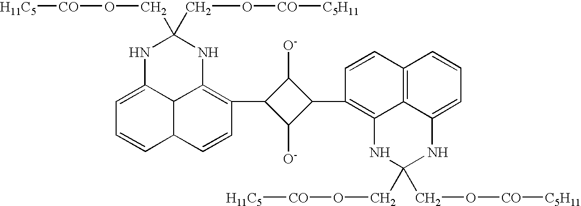

Fluorine-Containing Polymer Surfactant C:

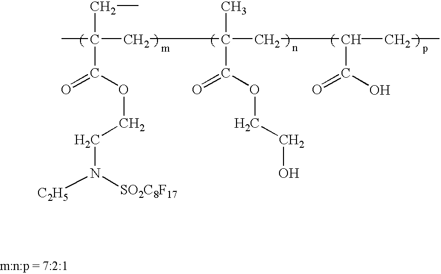

Antistatic Agent C:

C₈F₁₇—SO₃⁻H₃⁺N(CH₂—CH₂—O)₁₂ CH₂—CH₂—NH₃⁺C₈F₁₇—SO₃⁻

(Measurement of Sensitivity)

The coated and dried photosensitive material was cut into a specimen of 1.5 inch×8 inch (3.8 cm×20.3 cm) and exposed by an exposure machine using, as the exposure light source, a semiconductor laser formed into a longitudinal multiple mode of a wavelength from 800 to 820 nm by means of high frequency superposition. The laser ray was irradiated at an incident angle of 75° on the exposure surface. After the exposure, the film specimen was developed under heating at 124° C. for 15 seconds using an automatic developing machine having a heat drum while contacting the protective layer of the photosensitive material with the drum surface, thereby obtaining an image. The obtained image was evaluated by a commercially available densitometer.

(Evaluation of Image Preservability)

The sample heat-developed for the purpose of sensitivity measurement was stored in an environment at 30° C. and a relative humidity of 70% under a fluorescent lamp of 1,000 Lux for 24 hours and then evaluated on the image density. The image preservability was evaluated by the increase of density in the Dmin area.

(Evaluation of Odor Intensity)

The odor intensity was evaluated according to the method described above in the specification. The odor in the sample bag at 120° C. was collected by an order discriminator FF-1 (manufactured by Shimadzu Corporation, a temperature rising thermal desorption concentration system by a carbon-type collector tube, oxide semiconductor sensor, 6 sensors) and the odor intensity (numerical value of SC1 axis) was measured. This value of SC1 axis is a value calibrated by the method described above. The odor intensity was evaluated by the value of SC1 axis.

(Measurement of Amount of Solvent in Photosensitive Material)

The stock photosensitive material (25 cm²) before development was sampled and enclosed in a 10 ml-volume vial, thereby preparing a sample for measurement. This sample was measured by HP 5890 SERIES II GC. The solvent content in each sample was measured under the conditions of column DB-WAX (30 m×1.0 mmid), He gas of 20 ml/min, injection at 250° C. and detector FID. At this time, the head space conditions were such that the bath temperature was 120° C. and the heating time was 30 minutes.

The evaluation results are shown in Table 7.

TABLE 7

| | | | | | | Solvent | | | | Image | |
|---|---|---|---|---|---|---|---|---|---|---|---|
| | | | | | | Content in | | | | | |
| | | | Compound | Compound | | Photo- | | | | | |
| | Phthalazine- | | of | of | | sensitive | Odor | Photographic | | Preservability, | |
| Sample | Base | Hydrazine | Formulae | Formula | Drying | Material | Intensity, | Performance | | increase of | |
| No. | Compound | Derivative | (1) to (3) | (II) | Condition | (mg/m²) | SCl value | Dmin | Sensitivity | Dmin | Remarks |
| 1 | — | H-1-11 | II-4 | 2-35 | 2 | 50 | 0.3 | 0.13 | 10 | 0.22 | Comparison |
| 2 | — | H-1-11 | II-4 | 2-35 | 3 | 12 | −1.1 | 0.14 | 18 | 0.24 | Comparison |
| 3 | — | H-2-1 | III-3 | 2-35 | 2 | 55 | 0.2 | 0.14 | 8 | 0.23 | Comparison |
| 4 | — | H-2-1 | III-3 | 2-35 | 3 | 13 | −1.5 | 0.15 | 12 | 0.25 | Comparison |
| 5 | — | H-4-2 | I-12 | 2-3 | 2 | 48 | 0.4 | 0.14 | 15 | 0.21 | Comparison |
| 6 | — | H-4-2 | I-12 | 2-3 | 3 | 11 | −0.9 | 0.13 | 12 | 0.22 | Comparison |
| 7 | — | A-37 | I-12 | 2-3 | 2 | 52 | 0.1 | 0.14 | 15 | 0.22 | Comparison |
| 8 | — | A-37 | I-12 | 2-3 | 3 | 10 | −1.6 | 0.15 | 10 | 0.23 | Comparison |
| 9 | phthalazine | — | II-4 | 2-35 | 3 | 9 | −0.3 | 0.16 | 90 | 0.07 | Invention |
| 10 | phthalazine | H-1-11 | II-4 | 2-35 | 3 | 8 | −0.2 | 0.16 | 102 | 0.05 | Invention |
| 11 | phthalazine | H-2-1 | — | 2-35 | 3 | 9 | −0.5 | 0.17 | 100 | 0.08 | Invention |
| 12 | phthalazine | H-2-1 | III-3 | 2-35 | 3 | 11 | −0.7 | 0.16 | 105 | 0.06 | Invention |
| 13 | phthalazine | H-4-2 | I-12 | — | 3 | 10 | −0.2 | 0.15 | 99 | 0.06 | Invention |
| 14 | phthalazine | H-4-2 | I-12 | 2-3 | 3 | 11 | −0.4 | 0.14 | 103 | 0.07 | Invention |
| 15 | phthalazine | A-37 | I-12 | — | 3 | 8 | −0.5 | 0.15 | 100 | 0.07 | Invention |
| 16 | phthalazine | A-37 | I-12 | 2-3 | 3 | 9 | −0.9 | 0.16 | 107 | 0.05 | Invention |
| 17 | phthalazine | H-3-4 | I-12 | 2-3 | 1 | 120 | 2.2 | 0.17 | 99 | 0.13 | Comparison |
| 18 | phthalazine | H-3-4 | I-12 | 2-3 | 2 | 77 | 0.9 | 0.16 | 103 | 0.03 | Invention |
| 19 | phthalazine | H-3-4 | I-12 | 2-3 | 3 | 11 | −0.6 | 0.15 | 100 | 0.04 | Invention |
| 20 | phthalazine | H-3-4 | I-12 | 2-3 | 4 | 4 | −3.2 | 0.17 | 105 | 0.12 | Comparison |
| 21 | 1 | A-37 | II-4 | 2-3 | 1 | 125 | 2.1 | 0.16 | 100 | 0.15 | Comparison |
| 22 | 1 | A-37 | II-4 | 2-3 | 2 | 58 | 0.7 | 0.16 | 102 | 0.05 | Invention |
| 23 | 1 | A-37 | II-4 | 2-3 | 3 | 6 | −1.1 | 0.17 | 100 | 0.04 | Invention |
| 24 | 1 | A-37 | II-4 | 2-3 | 4 | 2 | −3.4 | 0.15 | 104 | 0.12 | Comparison |
| 25 | 1 | H-5-1 | II-4 | 2-35 | 1 | 115 | 1.7 | 0.17 | 103 | 0.13 | Comparison |
| 26 | 1 | H-5-1 | II-4 | 2-35 | 2 | 70 | 0.3 | 0.17 | 101 | 0.05 | Invention |
| 27 | 1 | H-5-1 | II-4 | 2-35 | 3 | 8 | −1.5 | 0.15 | 100 | 0.04 | Invention |
| 28 | 1 | H-5-1 | II-4 | 2-35 | 4 | 2 | −3.4 | 0.15 | 103 | 0.14 | Comparison |

Phthalazine-base Compound 1 is the same as Compound 1 in the specification.

As is apparent from Table 7, the heat-developable photosensitive material of the present invention is excellent in the image preservability. It is seen that by the phthalazine-base compound, the obtained photosensitive material is particularly elevated in the sensitivity, improved in the photographic performance and at the same time, excellent in the image preservability.

### EXAMPLE 8

(Preparation of Support)

Both surfaces of a 175 μm-thick PET film colored blue to a density of 0.160 were subjected to a corona discharge treatment of 8 w/m²·min.

[Preparation of Photosensitive Emulsion]

(Preparation of Photosensitive Silver Halide Emulsion)

In 900 ml of water, 7.5 g of ossein gelatin having an average molecular weight of 100,000 and 10 mg of potassium bromide were dissolved. The resulting solution was adjusted to a temperature of 35° C. and a pH of 3.0 and thereto, 370 ml of an aqueous solution containing 74 g of silver nitrate and 370 ml of an aqueous solution containing potassium bromide and potassium iodide at a molar ratio of 98/2 and containing iridium chloride in an amount of 1×10⁻⁴ mol per mol of silver were added by a controlled double jet method over 10 minutes while keeping the pAg at 7.7. Thereafter, 0.3 g of 4-hydroxy-6-methyl-1,3,3a,7-tetraza-indene was added and the pH was adjusted to 5 with NaOH to obtain a cubic silver iodobromide grain having an average grain size of 0.06 μm, a coefficient of variation in the grain size of 12% and a [100] face percentage of 87%. This emulsion was desalted by flocculating and precipitating silver halide grains using a gelatin coagulant, 0.1 g of phenoxyethanol was added thereto, and the pH and the pAg were adjusted to 5.9 and 7.5, respectively, thereby obtaining a photosensitive silver halide emulsion.

The temperature of the thus-obtained photosensitive silver halide emulsion was elevated to 55° C. and thereto, 5×10⁻⁵ mol of Compound A was added. Subsequently, 7×10⁻⁵ mol of ammonium thiocyanate and 5.3×10⁻⁵ mol of chloroauric acid were added. Furthermore, 0.3 mol % of silver iodide fine grain was added. After ripening for 100 minutes, the emulsion was cooled to 38° C. to complete the chemical sensitization and thereby obtain a silver halide grain. Here, the amount added is a value per 1 mol of AgX. Compound A:

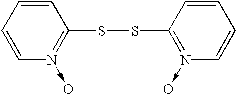

(Preparation of Powdery Organic Silver Salt)

In 4,720 ml of pure water, 111.4 g of behenic acid, 83.8 g of arachidinic acid and 54.9 g of stearic acid were dissolved at 80° C. Thereto, 540.2 ml of an aqueous 1.5M sodium hydroxide solution was added while stirring at a high speed and after 6.9 ml of concentrated nitric acid was added, the resulting solution was cooled to 55° C. to obtain an organic acid sodium solution. While keeping the organic acid sodium solution at a temperature of 55° C., the silver halide grain (containing 0.038 mol of silver) and 450 ml of pure water were added. Thereto, 760.6 ml of a 1M silver nitrate solution was added over 2 minutes and after stirring for 20 minutes, water-soluble salts were removed by filtration. Subsequently, centrifugal dehydration was performed by repeating washing with deionized water and filtration until the electrical conductivity of filtrate became 2 μS/cm. Then, drying was performed in a heated nitrogen stream until the weight loss did not occur, thereby obtaining a powdery organic silver salt.

(Preparation of Photosensitive Emulsion Dispersion Solution)

In 1,457 g of methyl ethyl ketone, 14.57 g of polyvinyl butyral powder (Butvar B-79, produced by Monsanto) was dissolved. While stirring by a dissolver-type homogenizer, 500 g of the powdery organic silver salt was gradually added and thoroughly mixed. The obtained mixture was dispersed using a media-type mill (manufactured by Gettzmann) filled in 80% with 1-mm Zr beads (produced by Toray Industries, Inc.) at a peripheral speed of 13 m and a residence time in mill of 0.5 minutes to prepare a photosensitive emulsion dispersion solution.

[Preparation of Coating Solution for Photosensitive Layer]

In 500 g of the photosensitive emulsion dispersion solution prepared above, 100 g of methyl ethyl ketone (MEK) was added while stirring in a nitrogen stream. The resulting solution was kept at 24° C. Thereto, Antifoggant 1 (a 10% methanol solution, 2.50 ml) shown below was added and stirred for 1 hour and furthermore, calcium bromide (a 10% methanol solution, 4 ml) was added and stirred for 15 minutes. Thereafter, 1.8 ml of a 1:5 mixed solution of a dye adsorption aid shown below and potassium acetate (a 20 wt % ethanol solution of the dye adsorption aid) was added and stirred for 15 minutes. Thereto, a mixed solution of Infrared Sensitizing Dye A shown below, 4-chloro-2-benzoyl benzoic acid and a supersensitizer (5-methyl-2-mercaptobenzimidazole) (mixing ratio: 1:250:20, a 0.1% methanol solution of the sensitizing dye, 7 ml) was added and stirred for 1 hour. After lowering the temperature to 13° C., the solution was further stirred for 30 minutes. While keeping the solution at 13° C., 48 g of polyvinyl butyral was added and thoroughly dissolved. Thereafter, the following additives were added. (These operations all were performed in a nitrogen stream.)

| Phthalazine-base compound shown in Table 8 | 1.5 | g |
|---|---|---|
| Tetrachlorophthalic acid | 0.5 | g |
| 4-Methylphthalic acid | 0.5 | g |
| Dyestuff A shown below | in an amount of giving | |
| | an optical density of | |
| | 0.9 at the absorption | |
| | maximum of dyestuff | |
| Developer (1,1-bis(2-hydroxy-3,5- | 15 | g |
| dimethylphenyl)-2-methylpropane) | | |
| Desmodur N3300 (aliphatic isocyanate, | 1.10 | g |
| produced by MOBEY) | | |
| Antifoggant 2 (2-(tribromomethyl- | 1.55 | g |
| sulfonyl)-quinoline) | | |
| Hydrazine derivative shown in Table 8 | 0.5 | g |
| Compound of formulae (1) to (3) shown in | 0.1 | g |
| Table 8 | | |
| Compound of formula (II) shown in Table 8 | 0.3 | g |

Dye Adsorption Aid:

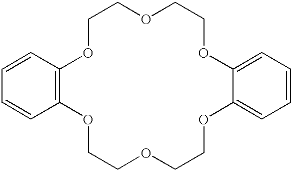

Antifoggant 1:

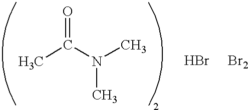

Sensitizing Dye A:

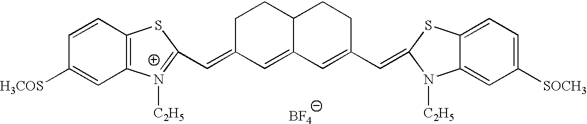

Dyestuff A:

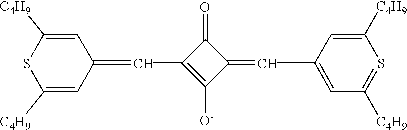

<Coating of Photosensitive Layer Side>

Photosensitive Layer:

The solution having the above-described composition was coated on the support prepared above such that the coated silver amount was 1.8 g/m² and the coated amount of polyvinyl butyral as the binder was 8.5 g/m².

<Surface Protective Layer>

A solution having the following composition was coated on the photosensitive layer to have a wet thickness of 100 μm.

| Acetone | 175 | ml |
|---|---|---|
| 2-Propanol | 40 | ml |
| Methanol | 15 | ml |
| Cellulose acetate | 8 | g |
| Phthalazinone (a 4.5% DMF solution) | 8 | ml |
| Phthalazine | 1.5 | g |
| 4-Methylphthalic acid | 0.72 | g |
| Tetrachlorophthalic acid | 0.22 | g |
| Tetrachlorophthalic anhydride | 0.5 | g |
| Monodisperse silica having an average | 1 | wt % |
| particle size of 4 μm (coefficient of | based on | |
| variation: 20%) | binder | |
| Fluorine-Containing Polymer Surfactant C | 0.5 | g |
| same as in Example 7 | | |

<Coating of Back Surface Side>

The same coating solution for back surface as in Example 7 was coated in the same manner as in Example 7.

Drying after the coating was performed under 4 conditions of 70° C. for 3 minutes, 80° C. for 10 minutes, 90° C. for 10 minutes, and 50 minutes (in this order, Drying Conditions 1 to 4) in the same manner as in Example 7.

The evaluation results are shown in Table 8.

TABLE 8

| | | | | | | Solvent | | | | | |
|---|---|---|---|---|---|---|---|---|---|---|---|
| | | | | | | Content | | | | | |
| | | | | | | in | | | | | |
| | | | | | | Photo- | | | | | |
| | | | Compound | Compound | | sensi- | Odor | | | Image | |
| | Phthalazine- | | of | of | | tive | Intensity, | Photographic | | Preservability, | |
| Sample | Base | Hydrazine | Formulae | Formula | Drying | Material | SCl | Performance | | increase of | |
| No. | Compound | Derivative | (1) to (3) | (II) | Condition | (mg/m²) | value | Dmin | Sensitivity | Dmin | Remarks |
| 1 | — | H-2-2 | III-3 | 2-3 | 2 | 55 | 0.2 | 0.13 | 15 | 0.23 | Comparison |
| 2 | — | H-2-2 | III-3 | 2-3 | 3 | 11 | −1 | 0.14 | 16 | 0.27 | Comparison |
| 3 | — | A-42 | III-3 | 2-3 | 2 | 58 | 0.4 | 0.14 | 20 | 0.23 | Comparison |
| 4 | — | A-42 | III-3 | 2-3 | 3 | 10 | −1.4 | 0.15 | 10 | 0.25 | Comparison |
| 5 | — | A-37 | I-12 | 2-35 | 2 | 45 | 0.4 | 0.14 | 15 | 0.26 | Comparison |
| 6 | — | A-37 | I-12 | 2-35 | 3 | 10 | −0.9 | 0.13 | 18 | 0.24 | Comparison |
| 7 | — | H-1-11 | II-4 | 2-35 | 2 | 52 | 0.3 | 0.14 | 15 | 0.22 | Comparison |
| 8 | — | H-1-11 | II-4 | 2-35 | 3 | 11 | −1.2 | 0.15 | 20 | 0.27 | Comparison |
| 9 | phthalazine | — | II-4 | 2-35 | 3 | 9 | −0.3 | 0.16 | 100 | 0.07 | Invention |
| 10 | phthalazine | H-1-11 | II-4 | 2-35 | 3 | 8 | −0.2 | 0.16 | 90 | 0.05 | Invention |
| 11 | phthalazine | H-2-1 | — | 2-35 | 3 | 9 | −0.5 | 0.17 | 100 | 0.08 | Invention |
| 12 | phthalazine | H-2-1 | III-3 | 2-35 | 3 | 11 | −0.7 | 0.16 | 103 | 0.08 | Invention |
| 13 | phthalazine | H-4-2 | I-12 | — | 3 | 10 | −0.2 | 0.15 | 100 | 0.07 | Invention |
| 14 | phthalazine | H-4-2 | I-12 | 2-3 | 3 | 11 | −0.4 | 0.14 | 103 | 0.05 | Invention |
| 15 | phthalazine | H-2-2 | III-3 | 2-3 | 1 | 125 | 1.7 | 0.16 | 100 | 0.13 | Comparison |
| 16 | phthalazine | H-2-2 | III-3 | 2-3 | 2 | 75 | 0.1 | 0.16 | 102 | 0.05 | Invention |
| 17 | phthalazine | H-2-2 | III-3 | 2-3 | 3 | 11 | −1.4 | 0.17 | 100 | 0.04 | Invention |
| 18 | phthalazine | H-2-2 | III-3 | 2-3 | 4 | 4 | −3.6 | 0.16 | 105 | 0.13 | Comparison |
| 19 | phthalazinone | A-42 | III-3 | 2-3 | 1 | 130 | 2.1 | 0.15 | 99 | 0.15 | Comparison |
| 20 | phthalazinone | A-42 | III-3 | 2-3 | 2 | 63 | 0.7 | 0.14 | 103 | 0.05 | Invention |
| 21 | phthalazinone | A-42 | III-3 | 2-3 | 3 | 4 | −1.4 | 0.15 | 100 | 0.04 | Invention |
| 22 | phthalazinone | A-42 | III-3 | 2-3 | 4 | 2 | −3.5 | 0.16 | 107 | 0.12 | Comparison |
| 23 | 2 | A-37 | I-12 | 2-35 | 1 | 123 | 2.2 | 0.17 | 99 | 0.13 | Comparison |
| 24 | 2 | A-37 | I-12 | 2-35 | 2 | 77 | 0.9 | 0.16 | 103 | 0.03 | Invention |
| 25 | 2 | A-37 | I-12 | 2-35 | 3 | 11 | −0.6 | 0.15 | 100 | 0.04 | Invention |
| 26 | 2 | A-37 | I-12 | 2-35 | 4 | 4 | −3.3 | 0.17 | 105 | 0.12 | Comparison |
| 27 | 8 | H-1-11 | II-4 | 2-35 | 1 | 125 | 2.1 | 0.16 | 100 | 0.15 | Comparison |
| 28 | 8 | H-1-11 | II-4 | 2-35 | 2 | 55 | 0.7 | 0.16 | 102 | 0.05 | Invention |
| 29 | 8 | H-1-11 | II-4 | 2-35 | 3 | 6 | −1 | 0.17 | 100 | 0.04 | Invention |
| 30 | 8 | H-1-11 | II-4 | 2-35 | 4 | 2 | −3.4 | 0.15 | 104 | 0.12 | Comparison |

Phthalazine-Base Compounds 2 and 8 are the same as Compounds 2 and 8 in the specification.

As is apparent from Table 8, similarly to Example 7, the heat-developable photosensitive material of the present invention is excellent in the image preservability. It is seen that by the phthalazine-base compound, the obtained photosensitive material is particularly elevated in the sensitivity, improved in the photographic performance and at the same time, excellent in the image preservability.

According to the present invention, a photosensitive material excellent in the photographic performance and image preservability can be provided. Also, a heat-developable photosensitive material reduced in the generation of an odor adversely affecting the working environment can be provided.

While the invention has been described in detail and with reference to specific embodiments thereof, it will be apparent to one skilled in the art that various changes and modifications can be made therein without departing from the spirit and scope thereof.

What is claimed is:

1. A photothermographic material comprising:
a support;
a binder;
an organic silver salt;
a reducing agent for silver ion; and
a photosensitive silver halide grain,
wherein said photothermographic material contains a solvent in an amount of from 5 to 1,000 mg/m ² and the intensity of an odor generated from said photothermographic material is from −3 to 1 at 120° C.

2. The photothermographic material as claimed in claim 1, which comprises a photosensitive layer containing the photosensitive silver halide grain, wherein at least one of the constituent layers on the support surface having the photosensitive layer contains at least one polymer binder selected from the group consisting of polyvinyl butyral, cellulose acetate, cellulose butyrate and derivatives thereof.

3. The photothermographic material as claimed in claim 1, wherein at least one of the constituent layers of the photothermographic material contains at least one compound selected from the group consisting of an aziridine compound, an epoxy compound and a carbodiimide compound.

4. The photothermographic material as claimed in claim 1, wherein at least one of constituent layers of the photothermographic material contains a matting agent having an average particle size of 3 to 10 μm and a coefficient of variation of 50% or less.

5. The photothermographic material as claimed in claim 1, wherein at least one of the constituent layers of the photothermographic material contains a fluorine-containing ionic surfactant.

6. An image forming method comprising exposing the photothermographic material claimed in claim 1 by a scanning laser beam to form an image, wherein the scanning laser beam creates substantially no vertical angle with the exposure surface of said photothermographic material.

7. An image forming method comprising exposing the photothermographic material claimed in claim 1 by a scanning laser beam to form an image, wherein said scanning laser beam is in a longitudinal multiple mode.

8. A photothermographic material comprising:
a support;
a binder;
an organic silver salt;
a reducing agent for silver ion; and
a photosensitive silver halide grain,
wherein said photothermographic material contains a solvent in an amount of 5 to 1,000 mg/m², and at least one of a constituent layer and the support in said photothermographic material contains at least one dye represented by the following formula (1), and the intensity of an odor generated from said photothermographic material is from −3 to 1 at 120° C.: 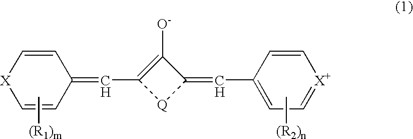
wherein Q represents 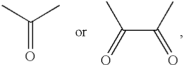
X represents a sulfur atom or an oxygen atom, R₁ and R₂ each represents a monovalent substituent, and m and n each represents 0, 1, 2, 3 or 4.

9. The photothermographic material as claimed in claim 8, wherein said photosensitive silver halide is sensitized by at least one selected from spectral sensitizing dyes represented by the following formulae (2a) to (2d): 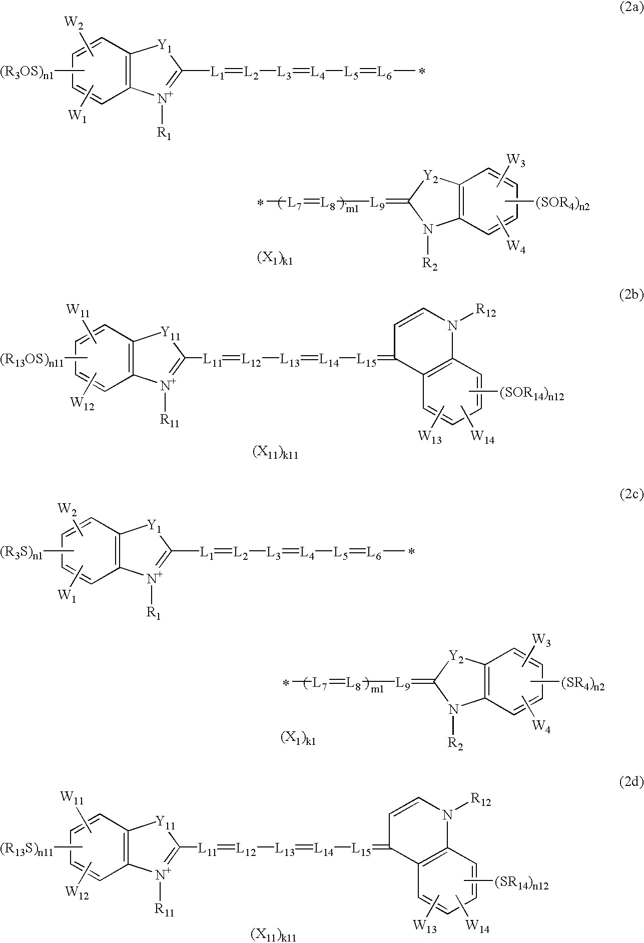
wherein Y₁, Y₂ and Y₁₁ each represents an oxygen atom, a sulfur atom, a selenium atom or a —CH═CH— group, L₁ to L₉ and L₁₁ to L₁₅ each represents a methine group, R₁, R₂, R₁₁ and R₁₂ each represents an aliphatic group, R₃, R₄, R₁₃ and R₁₄ each represents a lower alkyl group, a cycloalkyl group, an alkenyl group, an aralkyl group, an aryl group or a heterocyclic group, W₁, W₂, W₃, W₄, W₁₁, W₁₂, W₁₃ and W₁₄ each represents a hydrogen atom, a substituent, a nonmetallic atom group necessary for forming a condensed ring when W₁ and W₂, W₃ and W₄, W₁₁, and W₁₂, or W₁₃ and W₁₄ are combined, R₃, R₄, R₁₃, R₁₄ W₁, W₂, W₃, W₄, W₁₁, W₁₂, W₁₃ and W₁₄ represent a nonmetallic atom group necessary for forming a 5- or 6-membered condensed ring when R₃ and W₁, R₃ and W₂, R₁₃ and W₁₁, R₁₃ and W₁₂, R₄ and W₃, R₄ and W₄, R₁₄ and W₁₃, or R₁₄ and W₁₄ are combined, X₁ and X₁₁ each represents an ion necessary for canceling the electric charge within the molecule, k₁ and k₁₁ each represents a number of ions necessary for canceling the electric charge within the molecule, m₁ represents 0 or 1, and n₁, n₂, n₁₁ and n₁₂ each represents 0, 1 or 2, provided that each of the pairs n₁ and n₂, and n₁₁ and n₁₂ are not 0 at the same time.

10. The photothermographic material as claimed in claim 8, which comprises an antihalation layer on the surface having no photosensitivity of said photothermographic material, wherein the antihalation layer has a maximum absorption of 0.3 to 2.0 in the range from 750 to 1,400 nm and an optical density of 0.001 to 0.5 in the range from 400 to 700 nm.

11. The photothermographic material as claimed in claim 8, wherein the organic solvent used in a coating solution for forming a layer constituting said photothermographic material contains at least one compound selected from the group consisting of a hydrofluoroether compound and a dialkyl carbonate compound.

12. The photothermographic material as claimed in claim 8, wherein a surface having no photosensitivity of said photothermographic material has a Bekk smoothness of 10 to 500 seconds.

13. An image forming method comprising exposing the photothermographic material claimed in claim 8 by an infrared laser having a wavelength of 700 to 1,400 nm.

14. An image forming method comprising exposing the photothermographic material claimed in claim 8 by a laser exposure machine of emitting a scanning laser beam to record an image, in which the scanning laser beam creates substantially no vertical angle with the exposure surface of the photothermographic material.

15. An image forming method comprising exposing the photothermographic material claimed in claim 8 by a laser scanning exposure machine of emitting a scanning laser beam in a longitudinal multiple mode to record an image.

16. A photothermographic material comprising a photosensitive material and a support, wherein the photosensitive material includes:
a binder;
an organic silver salt;
a reducing agent for silver ion;
a photosensitive silver halide; and
a halide represented by the following formula (X),
wherein
(i) the photothermopraphic material contains a solvent in an amount of 5 to 1,000 mg/m², and
(ii) the intensity of an odor generated from the photothermographic material is from −3 to 1 at 120° C.: 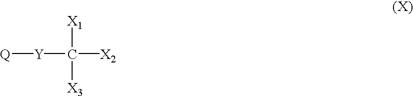
wherein Q represents an aryl group or a heterocyclic group, X₁, X₂ and X₃ each independently represents a hydrogen atom, a halogen atom, a haloalkyl group, an acyl group, an alkoxycarbonyl group, an aryloxycarbonyl group, a carbamoyl group, a sulfamoyl group, a sulfonyl group, a heterocyclic group or an aryl group, provided that at least one of X₁, X₂ and X₃ is a halogen atom, and Y represents —C(═O)—, —SO— or —SO₂—.

17. The photothermographic material as claimed in claim 16, wherein the photosensitive layer further contains at least one compound represented by the following formula (I): 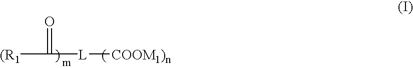
wherein
R₁ represents a hydrogen atom; a group represented by —OM₂; an alkyl group substituted by a group containing at least one heteroatom; an aryl group substituted by at least one group selected from the group consisting of an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, an alkoxycarbonyloxy group, an aryloxycarbonyloxy group, a sulfonylamino group, a sulfamoyl group, a carbamoyl group, an alkylthio group, an arylthio group, an amino group, a sulfonyl group, a sulfinyl group, a sulfonyloxy group, a ureido group, a silyl group, a mercapto group, a hydroxy group, a nitroso group, a sulfo group, a carboxyl group, a phosphoric acid ester group, a heterocyclic group and a halogenoalkyl group; or a heterocyclic group,
L represents a linking group,
M₁ represents a hydrogen atom or a cation,
M₂ represents a hydrogen atom or a cation
m represents an integer of 0 to 5, and n represents an integer of 1 to 3,
provided that when m is 0 or when m is 1 and R₁ is —OH, L represents a linking group substituted by from one to three groups selected from the group consisting of a halogen atom, an acyloxy group, an alkoxycarbonyl group, an aryloxycarbonyl group, a formyl group, an aryloxycarbonylamino group, an alkoxycarbonyloxy group, an aryloxycarbonyloxy group, an amino group, a sulfonyl group, a sulfinyl group, a sulfonyloxy group, a silyl group, a mercapto group, a hydroxy group, a nitroso group, a sulfo group, a phosphoric acid ester group and a heterocyclic group.

18. The photothermographic material as claimed in claim 17, wherein in formula (I), m is 0, n is 1 and L is a phenyl group substituted by one to three groups selected from the group consisting of an acyloxy group, an aryloxycarbonylamino group, an aryloxycarbonyloxy group and a sulfonyloxy group.

19. The photothermographic material as claimed in claim 16, wherein the photosensitive layer contains a sulfonium salt.

20. An image forming method comprising exposing the photothermographic material claimed in claim 16 by a laser exposure machine of emitting a scanning laser beam to record an image, in which the scanning laser beam creates substantially no vertical angle with the exposure surface.

21. An image forming method comprising exposing the photothermographic material claimed in claim 16 by a laser scanning exposure machine of emitting a scanning laser beam in a longitudinal multiple mode to record an image.

22. A photothermographic material comprising:
a support;
a binder;
an organic silver salt;
a reducing agent for silver ion; and
a photosensitive silver halide grain,
wherein said photothermographic material contains a solvent in an amount of from 5 to 1,000 mg/m², and the intensity of an odor generated from said photothermographic material is from −3 to 1 at 120° C., and said photothermographic material contains at least one of a phthalazine, a phthalazinone and a derivative thereof on the support surface in the side having a photosensitive layer containing the photosensitive silver halide.

23. The photothermographic material as claimed in claim 22, which comprises at least one hydrazine derivative represented by the following formulae (H-1) to (H-5) and (A) on the support surface in the side having said photosensitive layer: 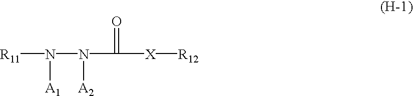
wherein R₁₁ represents an alkyl group, an aryl group or a heterocyclic group, R₁₂ represents a heterocyclic group, an alkenyl group or an amino group, X represents an oxygen atom or a sulfur atom, and A₁ and A₂ both represents a hydrogen atom, or one of A₁ and A₂ represents a hydrogen atom and the other represents an alkylsulfonyl group, an oxalyl group or an acyl group; 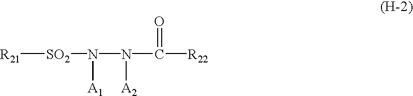
wherein R₂₁ represents alkyl, aryl or heteroaryl group which are substituted or unsubstituted, R₂₂ represents a hydrogen atom, an alkylamino group, an arylamino group or a heterocyclic amino group, and A₁ and A₂ both represents a hydrogen atom, or one of A₁ and A₂ represents a hydrogen atom and the other represents an alkylsulfonyl group, an oxalyl group or an acyl group; 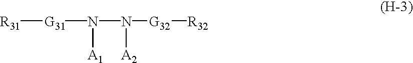
wherein G₃₁ and G₃₂ represents a —(CO)ₚ— group, a —C(═S)— group, a sulfonyl group, a sulfoxy group, a —P(═O)R₃₃— group or an iminomethylene group, p represents an integer of 1 or 2, R₃₃ represents an alkyl group, an alkenyl group, an alkynyl group, an aryl group, an alkoxy group, an alkenyloxy group, an alkynyloxy group, an aryloxy group or an amino group, R₃₁ and R₃₂ each represents an alkyl group, an alkenyl group, an aryl group, a heteroaryl group, an alkoxy group, an alkenyloxy group, an aryloxy group, a heterocyclic oxy group, an alkylthio group, an alkenylthio group, an arylthio group or a heterocyclic thio group, provided that when G₃₁ is a sulfonyl group, G₃₂ is not a carbonyl group, and A₁ and A₂ both represents a hydrogen atom, or one of A₁ and A₂ represents a hydrogen atom and the other represents an alkylsulfonyl group, an oxalyl group or an acyl group; 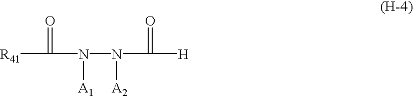
wherein R₄₁ represents a hydrogen atom or a monovalent substituent, and A₁ and A₂ both represents a hydrogen atom, or one of A₁ and A₂ represents a hydrogen atom and the other represents an alkylsulfonyl group, an oxalyl group or an acyl group; 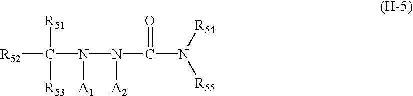
wherein R₅₁, R₅₂ and R₅₃ each independently represents a substituted or unsubstituted aryl or heteroaryl group, R₅₄ and R₅₅ each represents a substituted or unsubstituted alkyl group, and A₁ and A₂ both represents a hydrogen atom, or one of A₁ and A₂ represents a hydrogen atom and the other represents an alkylsulfonyl group, an oxalyl group or an acyl group;
Q¹—NHNHCONH—R¹ (A)
wherein Q¹ represents an aryl group or a heterocyclic group, and R¹ represents an alkyl group, an alkenyl group, a cycloalkyl group, an aryl group or a heterocyclic group.

24. The photothermographic material as claimed in claim 22, which comprises at least one compound represented by the following formulae (1) to (3) on the support surface in the side having said photosensitive layer: 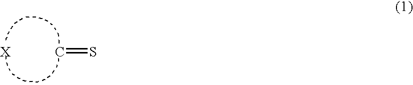
wherein X represents an atomic group capable of forming a heterocyclic ring containing at least one of —SO₃M, —COOM and —OM, and M represents a hydrogen atom, a metal atom, a quaternary ammonium group or a phosphonium group; 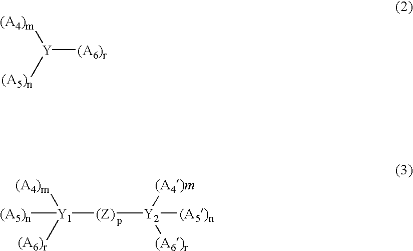
wherein A₄ and A₄′, which may be the same or different, each represents —SO₃M, —COOM or —OM, M represents a hydrogen atom, a metal atom, a quaternary ammonium group or a phosphonium group, m represents an integer of 1 to 10, A₅ and A₅′, which may be the same or different, each represents an electron-withdrawing group, n represents an integer of 1 to 10, A₆ and A₆′, which may be the same or different, each represents a functional group containing a sulfur, selenium or tellurium atom capable of combining with silver ion, r represents 0 or 1, Y, Y₁ and Y₂ each represents an aliphatic group, an aromatic group or a heterocyclic group, Z represents a sulfur atom, a selenium atom or a tellurium atom, and p represents 1 or 2.

25. The photothermographic material as claimed in claim 22, which comprises at least one hindered phenol compound represented by the following formula (II) on the support surface in the side having said photosensitive layer: 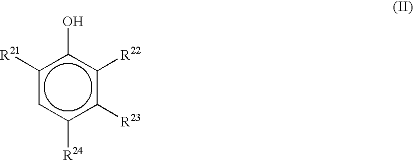
wherein R²¹ and R²² each independently represents a hydrogen atom, an alkyl group or an acylamino group, provided that R²¹ and R²² each is not a 2-hydroxyphenylmethyl group and that R²¹ and R²² are not a hydrogen atom at the same time, R²³ represents a hydrogen atom or an alkyl group, and R²⁴ represents a substituent capable of substituting to the benzene ring.

26. An image forming method comprising exposing the photothermographic material claimed in claim 22 by a scanning laser beam to form an image, wherein said scanning laser beam creates substantially no vertical angle with the scanning surface of said photothermographic material.

27. An image forming method comprising exposing the photothermographic material claimed in claim 22 by a scanning laser beam to form an image, wherein said scanning laser beam is in a longitudinal multiple mode.
